(19) United States
(12) Patent Application Publication
(10) Pub. No.: US 2024/0284220 A1
(43) Pub. Date: Aug. 22, 2024

(54) CSI REPORTING FOR MULTI-TRP COHERENT JOINT-TRANSMISSION

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/410,904

(22) Filed: Jan. 11, 2024

Related U.S. Application Data
(60) Provisional application No. 63/440,294, filed on Jan. 20, 2023.
(60) Provisional application No. 63/444,844, filed on Feb. 10, 2023.
(60) Provisional application No. 63/456,346, filed on Mar. 31, 2023.
(60) Provisional application No. 63/456,754, filed on Apr. 3, 2023.
(60) Provisional application No. 63/458,029, filed on Apr. 7, 2023.
(60) Provisional application No. 63/472,161, filed on Jun. 9, 2023.

(51) Int. Cl. H04W 24/10; H04L 5/00

(52) U.S. Cl. CPC H04W 24/10; H04L 5/0057

(57) ABSTRACT

Methods and apparatuses for channel state information (CSI) reporting for multi-transmit receive point (TRP) coherent joint transmission (CJT). A method includes receiving a configuration about a CSI report. The configuration includes information about (i) N_{TRP} CSI reference signal (CSI-RS) resources. The method further includes, based on the configuration, determining information for the CSI report based on N CSI-RS resources; partitioning the CSI report into two parts, a CSI Part 1 and a CSI part 2; and partitioning the CSI Part 2 into three groups, G0, G1, and G2. The method further includes transmitting the CSI Part 1 and at least a portion of the CSI Part 2. The group G1 includes an indicator indicating, for each of N−1 CSI-RS resources of the N CSI-RS resources, a frequency-domain (FD) offset dᵣ∈{0, 1, . . . , N₃O₃−1} relative to a reference CSI-RS resource.

### CROSS-REFERENCE TO RELATED APPLICATIONS AND CLAIM OF PRIORITY

The present application claims priority to: U.S. Provisional Patent Application No. 63/440,294, filed on Jan. 20, 2023; U.S. Provisional Patent Application No. 63/444,844, filed on Feb. 10, 2023; U.S. Provisional Patent Application No. 63/456,346, filed on Mar. 31, 2023; U.S. Provisional Patent Application No. 63/456,754, filed on Apr. 3, 2023; U.S. Provisional Patent Application No. 63/458,029, filed on Apr. 7, 2023; and U.S. Provisional Patent Application No. 63/472,161, filed on Jun. 9, 2023. The contents of the above-identified patent documents are incorporated herein by reference.

### TECHNICAL FIELD

The present disclosure relates generally to wireless communication systems and, more specifically, the present disclosure relates to channel state information (CSI) reporting for multi-transmit receive point (TRP) coherent joint transmission (CJT) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to CSI reporting for multi-TRP CJT in a wireless communication system.

In one embodiment, a user equipment (UE) is provided. The UE includes a transceiver configured to receive a configuration about a CSI report. The configuration includes information about (i) N_{TRP} CSI reference signal (CSI-RS) resources, where N_{TRP}>1, (ii) a parameter codebookType set to type-II-CJT-r18 or type-II-PortSelection-CJT-r18, and (iii) a parameter codebookMode set to model. The UE further includes a processor operably coupled to the transceiver. The processor, based on the configuration, is configured to determine information for the CSI report based on N CSI-RS resources, where N≤N_{TRP}, partition the CSI report into two parts, a CSI Part 1 and a CSI part 2, and partition the CSI Part 2 into three groups, G0, G1, and G2. The transceiver is further configured to transmit the CSI Part 1 and at least a portion of the CSI Part 2. The group G1 includes an indicator indicating, for each of N−1 CSI-RS resources of the N CSI-RS resources, a frequency-domain (FD) offset dᵣ∈{0, 1, . . . , N₃O₃−1} relative to a reference CSI-RS resource. Here, r∈{1, . . . , N_{TRP}}, r≠r*, and r* is an index of the reference CSI-RS resource such that dᵣ*=0; N₃ is a length of each of FD basis vectors; and O₃ is an oversampling value.

In another embodiment, a base station (BS) is provided. The BS includes a processor and a transceiver operably coupled to the processor. The transceiver is configured to transmit a configuration about a CSI report. The configuration includes information about (i) N_{TRP} CSI-RS resources, where N_{TRP}>1, (ii) a parameter codebookType set to type-II-CJT-r18 or type-II-PortSelection-CJT-r18, and (iii) a parameter codebookMode set to model. The CSI report is based on N CSI-RS resources, where N≤N_{TRP}. The CSI report includes two parts, a CSI Part 1 and a CSI part 2. The CSI Part 2 includes three groups, G0, G1, and G2. The transceiver is configured to receive the CSI Part 1 and at least a portion of the CSI Part 2. The group G1 includes an indicator indicating, for each of N−1 CSI-RS resources of the N CSI-RS resources, a FD offset dᵣ∈{0, 1, . . . , N₃O₃−1} relative to a reference CSI-RS resource. Here, r∈{1, . . . , N_{TRP}}, r≠r*, and r* is an index of the reference CSI-RS resource such that dᵣ*=0; N₃ is a length of each of FD basis vectors; and O₃ is an oversampling value.

In yet another embodiment, a method performed by a UE is provided. The method includes receiving a configuration about a CSI report. The configuration includes information about (i) N_{TRP} CSI-RS resources, where N_{TRP}>1, (ii) a parameter codebookType set to type-II-CJT-r18 or type-II-PortSelection-CJT-r18, and (iii) a parameter codebookMode set to model. The method further includes, based on the configuration, determining information for the CSI report based on N CSI-RS resources, where N≤N_{TRP}; partitioning the CSI report into two parts, a CSI Part 1 and a CSI part 2; and partitioning the CSI Part 2 into three groups, G0, G1, and G2. The method further includes transmitting the CSI Part 1 and at least a portion of the CSI Part 2. The group G1 includes an indicator indicating, for each of N−1 CSI-RS resources of the N CSI-RS resources, a frequency-domain (FD) offset dᵣ∈{0, 1, . . . , N₃O₃− 1} relative to a reference CSI-RS resource. Here, r∈{1, . . . , N_{TRP}}, r≠r*, and r* is an index of the reference CSI-RS resource such that dᵣ*=0; N₃ is a length of each of FD basis vectors; and O₃ is an oversampling value.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of antenna structure according to embodiments of the present disclosure;

FIGS. 7 and 8 illustrate examples of distributed MIMO according to embodiments of the present disclosure;

FIG. 9 illustrates an example of antenna port layout according to embodiments of the present disclosure;

FIG. 10 illustrates an example of 3D grid of DFT vectors according to embodiments of the present disclosure;

FIG. 11 illustrates an example of codebook according to embodiments of the present disclosure;

FIG. 12 illustrates an example of two-part UCI used to multiplex and report CSI according to embodiments of the present disclosure;

FIG. 13 illustrates an example of D-MIMO structure according to embodiments of the present disclosure;

FIG. 14 illustrates an example of channel measurement according to embodiments of the present disclosure;

FIG. 15 illustrates an example of UE moving on a linear trajectory in a DMIMO system according to embodiments of the present disclosure;

FIG. 16 illustrates an example of window-based FD basis vector selection according to embodiments of the present disclosure; and

FIG. 17 illustrates an example method performed by a UE in a wireless communication system according to embodiments of the present disclosure.

### DETAILED DESCRIPTION

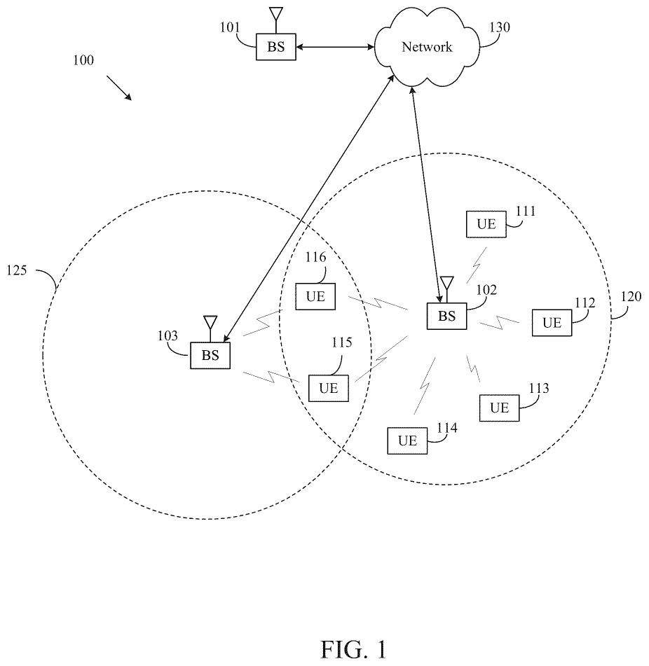

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 36.211 v17.2.0, “E-UTRA, Physical channels and modulation”; 3GPP TS 36.212 v17.2.0, “E-UTRA, Multiplexing and Channel coding”; 3GPP TS 36.213 v17.2.0, “E-UTRA, Physical Layer Procedures”; 3GPP TS 36.321 v17.1.0, “E-UTRA, Medium Access Control (MAC) protocol specification”; 3GPP TS 36.331 v17.1.0, “E-UTRA, Radio Resource Control (RRC) Protocol Specification”; 3GPP TS 38.211 v17.2.0, “NR, Physical channels and modulation”; 3GPP TS 38.212 v17.2.0, “NR, Multiplexing and Channel coding”; 3GPP TS 38.213 v17.2.0, “NR, Physical Layer Procedures for Control”; 3GPP TS 38.214 v17.2.0, “NR, Physical Layer Procedures for Data”; 3GPP TS 38.215 v17.1.0, “NR, Physical Layer Measurements”; 3GPP TS 38.321 v17.1.0, “NR, Medium Access Control (MAC) protocol specification”; and 3GPP TS 38.331 v17.1.0, “NR, Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for CSI reporting for multi-TRP CJT. In certain embodiments, and one or more of the gNBs 101-103 includes circuitry, programing, or a combination thereof, to support UCI parameters for CSI reporting for multi-TRP CJT.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

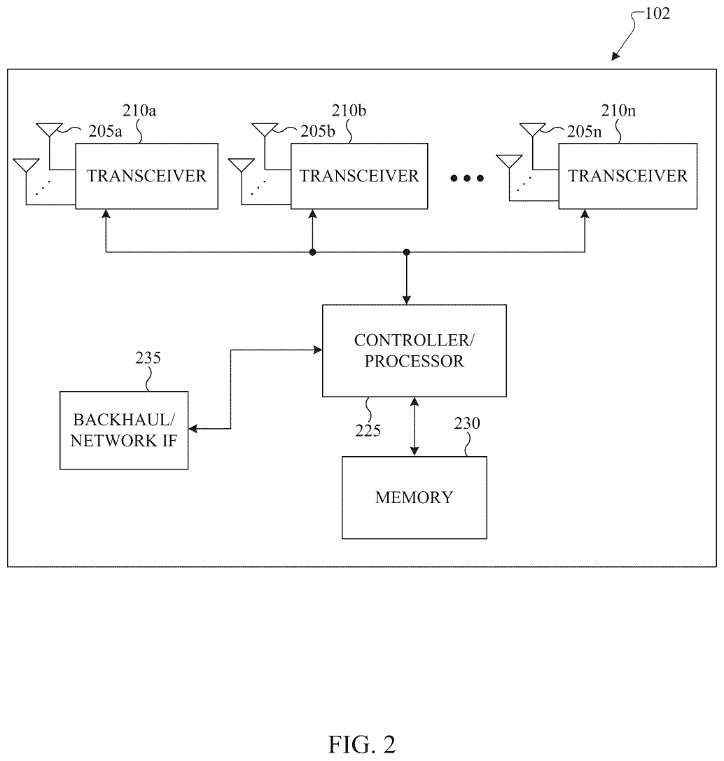

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support CSI reporting for multi-TRP CJT. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

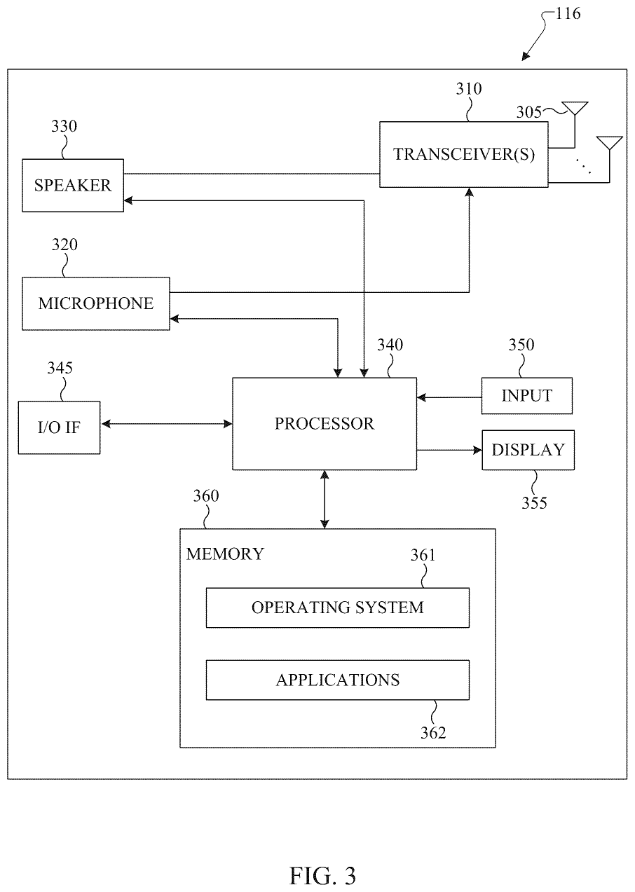

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for CSI reporting for multi-TRP CJT.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

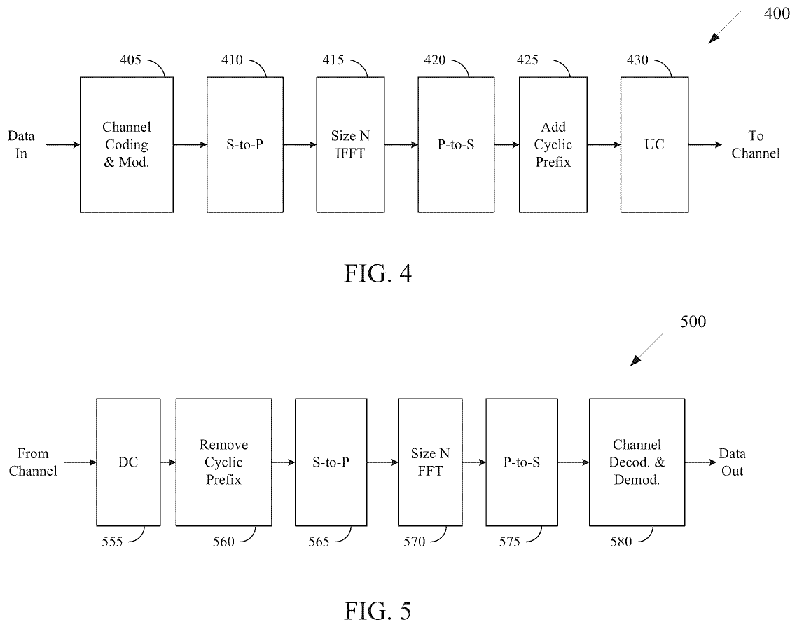

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the transmit path 400 is configured to support CSI reporting for multi-TRP CJT.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a downconverter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

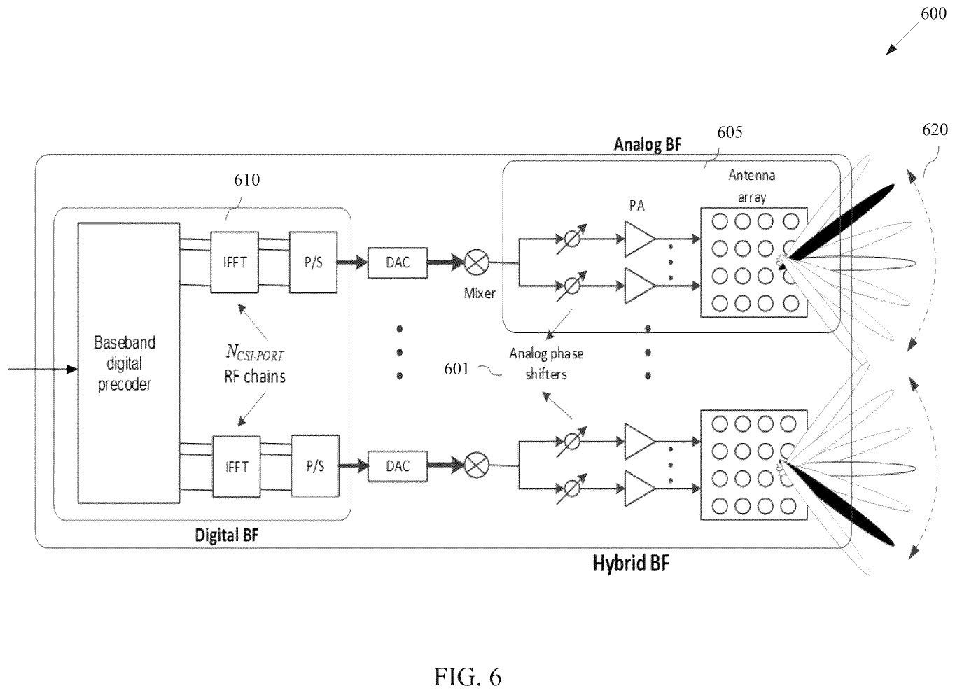

Rel.14 LTE and Rel.15 NR support up to 32 CSI-RS antenna ports which enable an eNB to be equipped with a large number of antenna elements (such as 64 or128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

For a cellular system operation in a sub-1 GHz frequency range (e.g., less than 1 GHz), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) cannot be achieved.

One way to operate a sub-1 GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

This disclosure considers two-part CSI or UCI framework for multi-TRP C-JT scenarios and provides method and apparatus for UCI parameters for CSI Part 1 and CSI Part 2 CSI in multi-TRP C-JT scenarios.

The present disclosure relates to electronic devices and methods on CSI reporting for MIMO operations, more particularly, to electronic devices and methods on two-part UCI (or CSI) for distributed MIMO or multi-TRP operations in wireless networks.

CSI enhancement described in Rel-18 MIMO considers Rel-16/17 Type-II CSI codebook refinements to support mTRP coherent joint transmission (C-JT) operations by considering performance-and-overhead trade-off. The Rel-16/17 Type-II CSI codebook has three components W₁, W₂, and W_{f}, and the Rel-18 Type-II CSI codebook for CJT has been developing based on the Rel-16/17 Type-II CSI codebooks, which is associated with multiple CSI-RS resources (multiple TRPs). Therefore, CSI includes elements associated with multiple TRPs (or CSI-RS resources), and thus the legacy framework of two-part CSI or two-part UCI needs to be enhanced for further efficient CSI reporting to be tailored for Rel-18 Type-II CSI framework.

In this disclosure, a component for UCI or CSI parameters in two-part CSI or two-part UCI is provided for multi-TRP C-JT scenarios.

Although the focus of the present disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

Rel.14 LTE and Rel.15 NR support up to 32 CSI-RS antenna ports which enable an eNB to be equipped with a large number of antenna elements (such as 64 or128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

At lower frequency bands such as <1 GHz, on the other hand, the number of antenna elements may not be large in a given form factor due to the large wavelength. As an example, for the case of the wavelength size (7) of the center frequency 600 MHz (which is 50 cm), it desires 4 m for uniform-linear-array (ULA) antenna panel of 16 antenna elements with the half-wavelength distance between two adjacent antenna elements. Considering a plurality of antenna elements is mapped to one digital port in practical cases, the desirable size for antenna panel(s) at gNB to support a large number of antenna ports such as 32 CSI-RS ports becomes very large in such low frequency bands, and it leads the difficulty of deploying 2-D antenna element arrays within the size of a conventional form factor. This results in a limited number of CSI-RS ports that can be supported at a single site and limits the spectral efficiency of such systems.

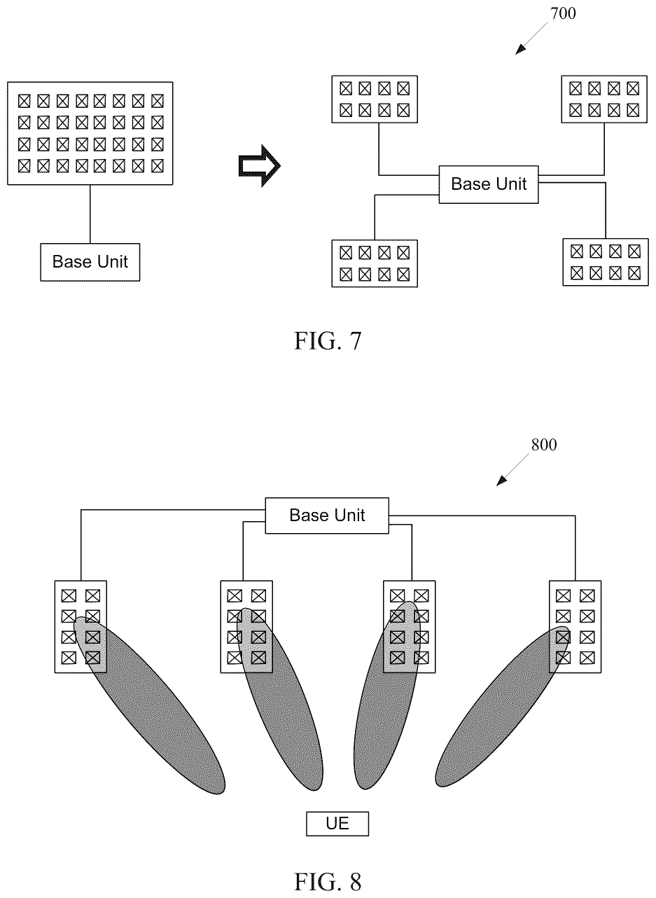

One possible approach to resolving the issue is to form multiple TRPs (multi-TRP) or RRHs with a small number of antenna ports instead of integrating all of the antenna ports in a single panel (or at a single site) and to distribute the multiple panels in multiple locations/sites (or TRPs, RRHs). This approach, concept of distributed MIMO (D-MIMO), is shown in FIG. 7.

FIGS. 7 and 8 illustrate examples of distributed MIMO 700 and 800 according to embodiments of the present disclosure. An embodiment of the distributed MIMO 700 and 800 shown in FIG. 8 are for illustration only.

The multiple TRPs at multiple locations can still be connected to a single base unit, and thus the signal transmitted/received via multiple distributed TRPs can be processed in a centralized manner through the single base unit, as illustrated in FIG. 8.

Note that although low frequency band systems (sub-1 GHz band) are provided as a motivation for distributed MIMO (or mTRP), the distributed MIMO technology is frequency-band-agnostic and can be useful in mid-(sub-6 GHz) and high-band (above-6 GHz) systems in addition to low-band (sub-1 GHz) systems.

The terminology “distributed MIMO” is used as an illustrative purpose, it can be considered under another terminology such as multi-TRP, mTRP, cell-free network, and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

A “CSI reporting band” is defined as a set/collection of subbands, either contiguous or non-contiguous, wherein CSI reporting is performed. For example, CSI reporting band can include all the subbands within the DL system bandwidth. This can also be termed “full-band.” Alternatively, CSI reporting band can include only a collection of subbands within the DL system bandwidth. This can also be termed “partial band.”

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n<N CSI reporting bands. For instance, >6 GHz, large system bandwidth may desire multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, a CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

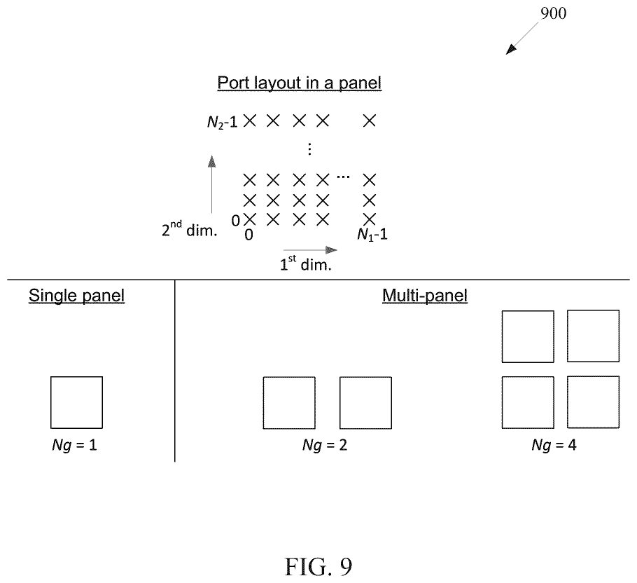

FIG. 9 illustrates an example of antenna port layout 900 according to embodiments of the present disclosure. An embodiment of the antenna port layout 900 shown in FIG. 9 is for illustration only.

In the following, it may assume that N₁ and N₂ are the number of antenna ports with the same polarization in the first and second dimensions, respectively. For2D antenna port layouts, there may be N₁>1, N₂>1, and for1D antenna port layouts N₁>1 and N₂=1. So, for a dual-polarized antenna port layout, the total number of antenna ports is 2N₁N₂ when each antenna maps to an antenna port. An illustration is shown in FIG. 9 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB. When there are multiple antenna panels (N_{g}>1), it may assume that each panel is dual-polarized antenna ports with N₁ and N₂ ports in two dimensions. This is illustrated in FIG. 9 Note that the antenna port layouts may or may not be the same in different antenna panels.

In one example, the antenna architecture of a D-MIMO or CJT (coherent joint-transmission) system is structured. For example, the antenna structure at each RRH (or TRP) is dual-polarized (single or multi-panel as shown in FIG. 9. The antenna structure at each RRH/TRP can be the same. Or the antenna structure at an RRH/TRP can be different from another RRH/TRP. Likewise, the number of ports at each RRH/TRP can be the same. Or the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

It may assume a structured antenna architecture in the rest of the disclosure. For simplicity, it may assume each RRH/TRP is equivalent to a panel (cf. FIG. 9), although, an RRH/TRP can have multiple panels in practice. The disclosure however is not restrictive to a single panel assumption at each RRH/TRP and can easily be extended (covers) the case when an RRH/TRP has multiple antenna panels.

In one embodiment, an RRH constitutes (or corresponds to or is equivalent to or is associated with) at least one of the following examples.

In one example, an RRH corresponds to a TRP.

In one example, an RRH or TRP corresponds to a CSI-RS resource. A UE is configured with K=N_{RRH}=(N_{TRP})>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.

In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{RRH} resource groups. The information about the resource grouping can be provided together with the CSI-RS resource setting/configuration, or with the CSI reporting setting/configuration, or with the CSI-RS resource configuration.

In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.

In one example, an RRH or TRP corresponds to examples disclosed in the present disclosure depending on a configuration. For example, this configuration can be explicit via a parameter (e.g., an RRC parameter). Or the configuration can be implicit.

In one example, when implicit, it could be based on the value of K. For example, when K>1 CSI-RS resources, an RRH corresponds to example provided in the present disclosure, and when K=1 CSI-RS resource, an RRH corresponds to example provided in the present disclosure.

In another example, the configuration could be based on the configured codebook. For example, an RRH corresponds to a CSI-RS resource (e.g., example provided in the present disclosure) or resource group (e.g., examples as provided in the present disclosure) when the codebook corresponds to a decoupled codebook (modular or separate codebook for each RRH), and an RRH corresponds to a subset (or a group) of CSI-RS ports (e.g., example as provided in the present disclosure) when codebook corresponds to a coupled (joint or coherent) codebook (one joint codebook across TRPs/RRHs).

In one example, when RRH or TRP maps (or corresponds to) a CSI-RS resource or resource group (e.g., example as provided in the present disclosure), and a UE can select a subset of TRPs/RRHs (resources or resource groups) and report the CSI for the selected TRPs/RRHs (resources or resource groups), the selected TRPs/RRHs can be reported via an indicator. For example, the indicator can be a CRI or a PMI (component) or a new indicator.

In one example, when RRH or TRP maps (or corresponds to) a CSI-RS port group (e.g., example as provided in the present disclosure), and a UE can select a subset of TRPs/RRHs (port groups) and report the CSI for the selected TRPs/RRHs (port groups), the selected TRPs/RRHs can be reported via an indicator. For example, the indicator can be a CRI or a PMI (component) or a new indicator.

In one example, when multiple (K>1) CSI-RS resources are configured for N_{RRH} TRPs/RRHs (e.g., examples as provided in the present disclosure), a decoupled (modular) codebook is used/configured, and when a single (K=1) CSI-RS resource for N_{RRH} TRPs/RRHs (e.g., examples as provided in the present disclosure), a joint codebook is used/configured.

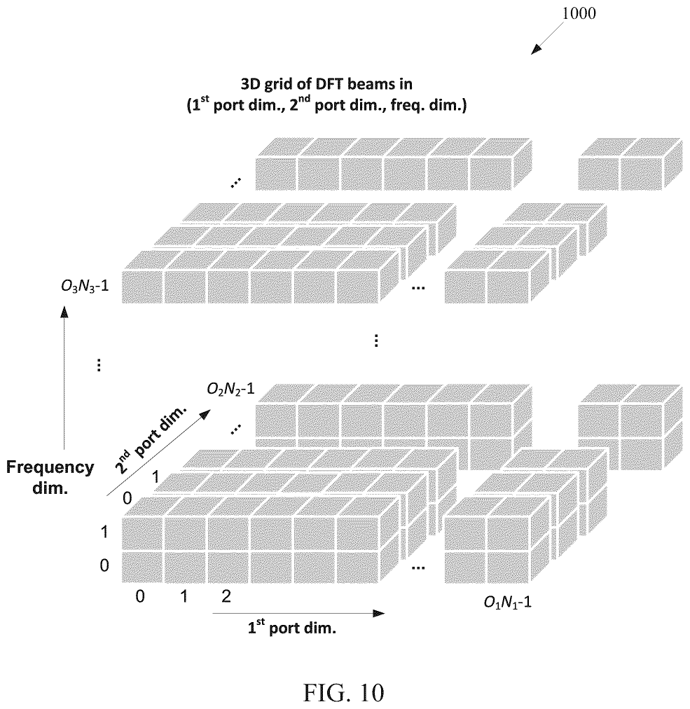

As described in U.S. Pat. No. 10,659,118, which is incorporated herein by reference in its entirety, a UE is configured with high-resolution (e.g., Type II) CSI reporting in which the linear combination based Type II CSI reporting framework is extended to include frequency dimension in addition to the 1st and 2nd antenna port dimensions. An illustration of the 3D grid of the oversampled DFT vectors (1st port dim., 2nd port dim., freq. dim.) is shown in FIG. 10 in which: (1) 1st dimension is associated with the 1st port dimension, (2) 2nd dimension is associated with the 2nd port dimension, and (3) 3rd dimension is associated with the frequency dimension.

FIG. 10 illustrates an example of 3D grid of DFT vectors 1000 according to embodiments of the present disclosure. An embodiment of the 3D grid of DFT vectors 1000 shown in FIG. 10 is for illustration only.

The basis sets for1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and 03=1. In another example, the oversampling factors O₁ belongs to {2, 4, 8}. In yet another example, at least one of O₁, O₂, and O₃ is higher layer configured (via RRC signaling).

As explained in 3GPP standard specification TS38.213, a UE is configured with higher layer parameter codebookType set to “typeII-PortSelection-r16” for an enhanced Type II CSI reporting in which the pre-coders for all SBs and for a given layer l=1, . . . , v, where v is the associated RI value, is given by either:

$${W}^{l} = {AC}_{l} {B}^{H} = [ \begin{matrix}{a}_{0} & {a}_{1} & … & {a}_{L - 1}\end{matrix} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] {[ \begin{matrix}{b}_{0} & {b}_{1} & … & {b}_{M - 1}\end{matrix} ]}^{H} \text{} = {Σ}_{f = 0}^{M - 1} {Σ}_{i = 0}^{L - 1} {c}_{l , i , f} ( {a}_{i} {b}_{f}^{H} ) = {Σ}_{i = 0}^{L - 1} {Σ}_{f = 0}^{M - 1} {c}_{l , i , f} ( {a}_{i} {b}_{f}^{H} ) \qquad ( Eq . 1 )$$

$$or$$

$${W}^{l} = [ \begin{matrix}A & 0 \\ 0 & A\end{matrix} ] {C}_{l} {B}^{H} = [ \text{} \begin{matrix}\begin{matrix}{a}_{0} & {a}_{1} & … & {a}_{L - 1}\end{matrix} & 0 \\ 0 & \begin{matrix}{a}_{0} & {a}_{1} & … & {a}_{L - 1}\end{matrix}\end{matrix} ] {[ \text{} \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] \text{} [ \begin{matrix}{b}_{0} & {b}_{1} & … & {b}_{M - 1}\end{matrix} ]}^{H} = [ \text{} \begin{matrix}{Σ}_{f = 0}^{M - 1} {Σ}_{i = 0}^{L - 1} {c}_{l , i , f} ( {a}_{i} {b}_{f}^{H} ) \\ {Σ}_{f = 0}^{M - 1} {Σ}_{i = 0}^{L - 1} {c}_{l , i + L , f} ( {a}_{i} {b}_{f}^{H} )\end{matrix} ] \qquad ( Eq . 2 )$$

In such equations: (1) N₁ is a number of antenna ports in a first antenna port dimension (having the same antenna polarization), (2) N₂ is a number of antenna ports in a second antenna port dimension (having the same antenna polarization, (3) P_{CSI-RS} is a number of CSI-RS ports configured to the UE, (4) N₃ is a number of SBs for PMI reporting or number of FD units or number of FD components (that comprise the CSI reporting band) or a total number of precoding matrices indicated by the PMI (one for each FD unit/component), (5) aᵢ is a 2N₁N₂×1 (Eq. 1) or N₁N₂×1 (Eq. 2) column vector, or aᵢ is a P_{CSIRS}×1 (Eq. 1) or

$$\frac{{P}_{CSIRS}}{2} \times 1$$

port selection column vector, where a port selection vector is a defined as a vector which contains a value of 1 in one element and zeros elsewhere, (6) b_{f} is a N₃×1 column vector, and (7) c_{l,i,f} is a complex coefficient.

In a variation, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where: (1) x_{l,i,f}=1 if the coefficient c_{l,i,f} is reported by the UE according to some embodiments of the present disclosure, and (2) x_{l,i,f}=0 otherwise (i.e., c_{l,i,f} is not reported by the UE).

The indication whether x_{l,i,f}=1 or0 is according to some embodiments of the present disclosure. For example, the indication can be via a bitmap.

In a variation, the precoder equations Eq. 1 or Eq. 2 are respectively generalized to

$${W}^{l} = {Σ}_{i = 0}^{L - 1} {Σ}_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{Σ}_{i = 0}^{L - 1} {Σ}_{f = 0}^{{M}_{i} - 1} {c}_{l , i , f} ( {a}_{i} {b}_{i , f}^{H} ) \\ {Σ}_{i = 0}^{L - 1} {Σ}_{= 0}^{{M}_{i} - 1} {c}_{l , i + L , f} ( {a}_{i} {b}_{i , f}^{H} )\end{matrix} ] \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (v=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3, and Eq. 4.

Here

$$L \leq \frac{{P}_{CSI - RS}}{2}$$

$$and$$

$$M \leq {N}_{3} .$$

$$If$$

$$L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by

$${W}_{f} = {[ \begin{matrix}1 & {e}^{j \frac{2 π {n}_{3 , l}^{( f )}}{{O}_{3} {N}_{3}}} {e}^{j \frac{2 π \cdot 2 {n}_{3 , l}^{( f )}}{{O}_{3} {N}_{3}}} & … & {e}^{j \frac{2 π \cdot ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , v} (where v is the RI or rank value) is given by w_{f}=[y_{0,l}^{(f)}, y_{1,l}^{(f)} . . . y_{N}_{₃}_{-1,l}^{(f)}]^{T}, where

$${y}_{t , l}^{( f )} = {e}^{j \frac{2 π {tn}_{3 , l}^{( f )}}{{N}_{3}}}$$

and n_{3,l}=[n_{3,l}⁽⁰⁾, . . . , n_{3,l}^{(M-1)}] where n_{3,l}^{(f)}∈{0, 1, . . . , N₃−1}.

In another example, discrete cosine transform DCT basis is used to construct/report basis B for the 3^{rd} dimension. The m-th column of the DCT compression matrix is simply given by

$${[ {W}_{f} ]}_{n m} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} , and K = {N}_{3} , and m = 0 , … , {N}_{3} - 1.$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows:

$$W = {A}_{l} {C}_{l} {B}_{l}^{H} = {W}_{1} {\tilde{W}}_{2} {W}_{f}^{H} , \qquad ( Eq . 5 )$$

where A=W₁ corresponds to the Rel. 15 W₁ in Type II CSI codebook as shown in 3GPP standard specification, and B=W_{f}.

The Cₗ=\tilde{W}₂ matrix consists of all the required linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling.

In another example, the amplitude coefficient (p_{l,i,f}) is reported as p_{l,i,f}=p_{l,i,f}⁽¹⁾, p_{l,i,f}⁽²⁾) where: (1) p_{l,i,f}⁽¹⁾ is a reference or first amplitude which is reported using a A1-bit amplitude codebook where A1 belongs to {2, 3, 4}, and (2) pf is a differential or second amplitude which is reported using a A2-bit amplitude codebook where A2<A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE are assumed to be zero.

The following quantization scheme is used to quantize/report the K_{NZ} NZ coefficients.

In one example, a UE reports the following for the quantization of the NZ coefficients in \tilde{W}₂: (1) a X-bit indicator for the strongest coefficient index (i*,f*), where X=┌log₂ K_{NZ}┐ or ┌log₂ 2L┐: (i) strongest coefficient c_{l,i*,f*}=1 (hence its amplitude/phase are not reported); (2) two antenna polarization-specific reference amplitudes are used: (i) for the polarization associated with the strongest coefficient c_{l,i*,f}*=1, since the reference amplitude p_{l,i,f}⁽¹⁾=1, it is not reported; and (ii) for the other polarization, reference amplitude p_{l,i,f}⁽¹⁾ is quantized to 4 bits. In such instance, the 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} ;$$

(3) for {c_{l,i,f}, (i, f)≠(i*, f*)}: (i) for each polarization, differential amplitudes p_{l,i,f}⁽²⁾ of the coefficients calculated relative to the associated polarization-specific reference amplitude and quantized to 3 bits, in such instance, the 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

Note the final quantized amplitude p_{l,i,f} is given by p_{l,i,f}⁽¹⁾×p_{l,i,f}⁽²⁾; and (ii) each phase is quantized to either8PSK (Nₚₕ=8) or16PSK (Nₚₕ=16) (which is configurable).

For the polarization r*∈{0, 1} associated with the strongest coefficient c_{l,i*f*}, there may be

$${r}^{*} = ⌊ \frac{{i}^{*}}{L} ⌋$$

and the reference amplitude p_{l,i,f}⁽¹⁾=p_{l,r*}⁽¹⁾=1. For the other polarization r∈{0, 1} and r≠r*, there may be

$$r = ( ⌊ \frac{{i}^{*}}{L} ⌋ + 1 ) mod 2$$

and the reference amplitude p_{l,i,f}⁽¹⁾=p_{l,r}⁽¹⁾ quantized (reported) using the 4-bit amplitude codebook mentioned above.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1, 2} and p is higher-layer configured from {¼, ½}. In one example, the p value is higher-layer configured for rank 1-2 CSI reporting. For rank>2 (e.g., rank 3-4), the p value (denoted by v₀) can be different. In one example, for rank 1-4, (p, v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} ,$$

i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In one example, M is replaced with Mᵥ to show its dependence on the rank valuev, hence p is replaced with pᵥ, v∈{1, 2} and v₀ is replaced with pᵥ, v∈{3, 4}.

A UE can be configured to report Mᵥ FD basis vectors in one-step from N₃ basis vectors freely (independently) for each layer l∈{1, . . . , v} of a rank v CSI reporting. Alternatively, a UE can be configured to report Mᵥ FD basis vectors in two-step as follows: (1) in step 1, an intermediate set (InS) comprising N₃′<N₃ basis vectors is selected/reported, wherein the InS is common for all layers; and (2) in step 2, for each layer l∈{1, . . . , v} of a rank v CSI reporting, Mᵥ FD basis vectors are selected/reported freely (independently) from N₃′ basis vectors in the InS.

In one example, one-step method is used when N₃≤19 and two-step method is used when N₃>19. In one example, N₃′=┌αMᵥ┐ where α>1 is either fixed (to 2 for example) or configurable.

The codebook parameters used in the DFT based frequency domain compression (eq. 5) are (L,pᵥ for v∈{1, 2},pᵥ for v∈{3, 4}, β, α, Nₚₕ). The set of values for these codebook parameters are as follows: (1) L: the set of values is {2, 4} in general, except L∈{2, 4, 6} for rank 1-2, 32 CSI-RS antenna ports, and R=1; (2) (pᵥ for v∈{1, 2}1, p for v∈{3, 4})∈

$$\begin{matrix}\{ ( \frac{1}{2} , \frac{1}{4} ) , ( \frac{1}{4} , \frac{1}{4} ) , ( \frac{1}{4} , \frac{1}{8} ) \} ; & \\ β ∈ \{ \frac{1}{4} , \frac{1}{2} , \frac{3}{4} \} ; & ( 3 ) \\ α = 2 ; & ( 4 )\end{matrix}$$

### and (5) Nₚₕ=16.

The set of values for these codebook parameters are as in TABLE 1.

TABLE 1
Values for the codebook parameters

| | | p_{ν} | | |
|---|---|---|---|---|
| paramCombination-r16 | L | ν ∈ {1, 2} | ν ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

In Rel. 17 (further enhanced Type II port selecting codebook),

$$M ∈ \{ 1 , 2 \} , L = \frac{{K}_{1}}{2}$$

where K₁=α×P_{CSIRS}, and codebook parameters (M, α, β) are configured from TABLE 2.

TABLE 2
Values for the codebook parameters

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The above-mentioned framework (e.g., Eq. 5) represents the precoding-matrices for multiple (N₃) FD units using a linear combination (double sum) over2L (or K₁) SD beams/ports and Mᵥ FD beams. This framework can also be used to represent the precoding-matrices in time domain (TD) by replacing the FD basis matrix W_{f} with a TD basis matrix Wₜ, wherein the columns of Wₜ comprises Mᵥ TD beams that represent some form of delays or channel tap locations. Hence, a precoder W^{l} can be described as follows:

$$W = {A}_{l} {C}_{l} {B}_{l}^{H} = {W}_{1} {\tilde{W}}_{2} {W}_{t}^{H} , \qquad ( 5 A )$$

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

In one example, the codebook for the CSI report is according to at least one of the following examples.

In one example, the codebook can be a Rel. 15 Type I single-panel codebook (e.g., as illustrated in TS 38.214).

In one example, the codebook can be a Rel. 15 Type I multi-panel codebook (e.g., as illustrated in TS 38.214).

In one example, the codebook can be a Rel. 15 Type II codebook (e.g., as illustrated in TS 38.214).

In one example, the codebook can be a Rel. 15 port selection Type II codebook (e.g., as illustrated in TS 38.214).

In one example, the codebook can be a Rel. 16 enhanced Type II codebook (e.g., as illustrated in TS 38.214).

In one example, the codebook can be a Rel. 16 enhanced port selection Type II codebook (e.g., as illustrated in TS 38.214).

In one example, the codebook can be a Rel. 17 further enhanced port selection Type II codebook (e.g., as illustrated in TS 38.214).

In one example, the codebook is a new codebook for C-JT CSI reporting.

In one example, the new codebook is a decoupled codebook comprising the following components: (called “CB1” hereafter): (1) intra-TRP: per TRP Rel. 16/17 Type II codebook components, i.e., SD basis vectors (W1), FD basis vectors (W_{f}), W2 components (e.g., SCI, indices of NZ coefficients, and amplitude/phase of NZ coefficients) and (2) inter-TRP: co-amplitude and co-phase for each TRP.

In one example, the new codebook is a joint codebook (called “CB2” hereafter) comprising following components: (1) per TRP SD basis vectors (W1); (2) single joint FD basis vectors (W_{f}); and (3) single joint W2 components (e.g., SCI, indices of NZ coefficients, and amplitude/phase of NZ coefficients).

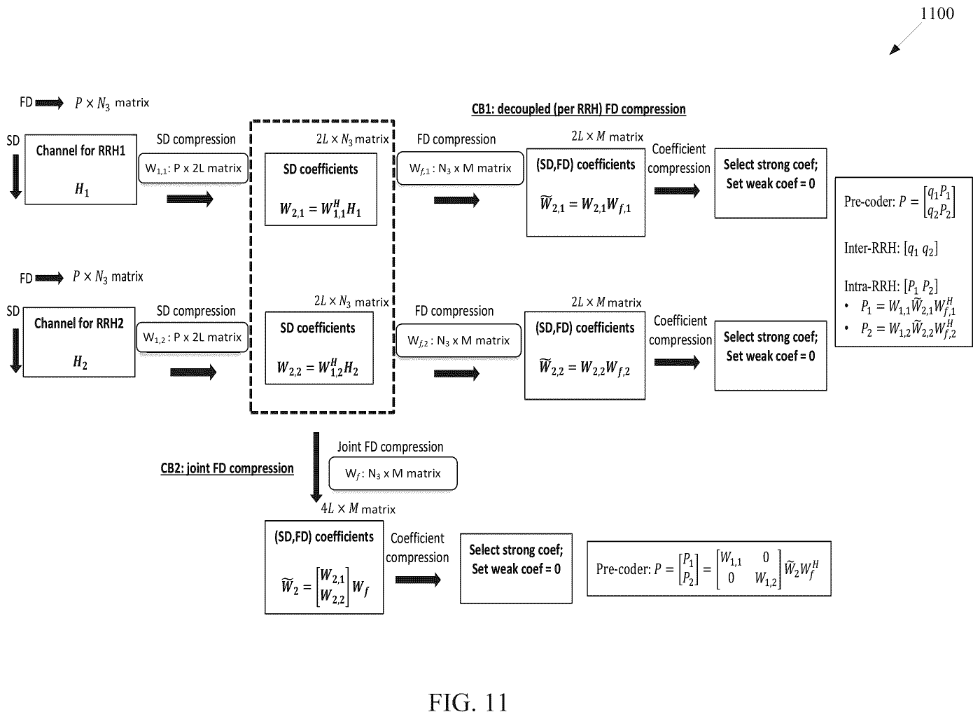

Two new codebooks are illustrated in FIG. 11.

FIG. 11 illustrates an example of codebook 1100 according to embodiments of the present disclosure. An embodiment of the codebook 1100 shown in FIG. 11 is for illustration only.

In one example, when the codebook is a legacy codebook (e.g., one of Rel. 15/16/17 NR codebooks, according to one of the examples above), then the CSI reporting is based on a CSI resource set comprising one or multiple NZP CSI-RS resource(s), where each NZP CSI-RS resource comprises CSI-RS antenna ports for all TRPs/RRHs, i.e., P=Σᵣ₌₁^{N}Pᵣ, where P is the total number of antenna ports, and Pᵣ is the number of antenna ports associated with r-th TRP. In this case, a TRP corresponds to (or maps to or is associated with) a group of antenna ports.

In one example, when the codebook is a new codebook (e.g., one of the two new codebooks above), then the CSIreporting is based on a CSI resource set comprising one or multiple NZP CSI-RS resource(s).

In one example, each NZP CSI-RS resource comprises CSI-RS antenna ports for all TRPs/RRHs. i.e., P=Σᵣ₌₁^{N}Pᵣ, where P is the total number of antenna ports, and Pᵣ is the number of antenna ports associated with r-th TRP. In this case, a TRP corresponds to (or maps to or is associated with) a group of antenna ports.

In one example, each NZP CSI-RS resource corresponds to (or maps to or is associated with) a TRP/RRH (a TRP-group).

In the present disclosure, it may use N, N_{TRP}, N_{RRH} interchangeably for a number of TRPs/RRHs.

In one embodiment, a UE is configured with a CSI reporting based on an mTRP (or D-MIMO or C-JT) codebook, via e.g., higher layer parameter codebookType set to “typeII-r18-cjt” or “typeII-PortSelection-r18-cjt,” where the codebook is one of the following two modes: In one example, one of the two modes is configured, e.g., via higher layer (e.g., via parameter codebookMode).

In one example of Mode 1, per-TRP/TRP-group (or per-CSI-RS resource) SD/FD basis selection. Example formulation (N_{TRP}=number of TRPs or TRP groups): The UE reports (i) SD basis vectors for each TRP, (ii) FD basis vectors for each TRP, and (iii) either a joint W2 across all TRPs or one W2 for each TRP:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] .$$

In one example of Mode 2, per-TRP/TRP group (port-group or resource) SD basis selection and joint (across N_{TRP} TRPs) FD basis selection. Example formulation (N_{TRP}=number of TRPs or TRP groups): The UE reports (i) SD basis vectors for each TRP, (ii) one common/joint FD basis vectors across all TRPs, and (iii) either a joint W2 across all TRPs or one W2 for each TRP:

$$[ \begin{matrix}\begin{matrix}{W}_{1 , 1} & 0 \\ 0 & ⋱\end{matrix} & \begin{matrix}0 & 0 \\ 0 & 0\end{matrix} \\ \begin{matrix}0 & 0 \\ 0 & 0\end{matrix} & {W}_{1 , N}\end{matrix} ] {\tilde{W}}_{2} {W}_{f}^{H} or [ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

where it may use N and N_{TRP} interchangeably.

In one example, Mode 1 and Mode 2 can be the codebooks described in U.S. patent application Ser. No. 18/310,396, as incorporated herein by reference in its entirety.

In one example, the two modes can share similar detailed designs such as parameter combinations, basis selection, TRP (group) selection, reference amplitude, \tilde{W}₂ quantization schemes.

In one example, parameter combinations can be a tuple of parameters such as L, pᵥ, β for regular Type-II CJT codebook or a tuple of parameters such as M, α, β for portselection Type-II CJT codebook.

In one example, basis selection scheme can be SD basis selection and/or FD basis selection schemes described in embodiments as described in U.S. patent application Ser. No. 18/310,396.

In one example, a TRP selection can be one component/example described in U.S. as described in U.S. patent application Ser. No. 18/295,219, as incorporated herein by reference in its entirety.

In one example, a reference amplitude scheme can be one component/example described in as described in U.S. patent application Ser. No. 18/305,241, as incorporated herein by reference in its entirety.

In one example, a W₂ quantization scheme can include strongest coefficient indicator, upper bound of non-zero coefficients, reference amplitudes, a scheme that each coefficient is decomposed into phase and amplitude and they are selected respective codebooks, and a codebook subset restriction.

The bitwidth for PMI of codebookType=typeII-r16 is provided in TABLE 3, where the values of (N₁, N₂), (O₁, O₂), L, K^{NZ}, N₃, and {Mₗ}_{l=1, . . . , v} are shown in 3GPP standard specification TS 38.214.

TABLE 3
PMI of codebookType= typeII-r16

| | Information fields X₁ | | | | | |
|---|---|---|---|---|---|---|
| | i_{1,1} | i_{1,2} | i_{1,8,1} | i_{1,8,2} | i_{1,8,3} | i_{1,8,4} |
| Rank = 1 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂K^{NZ}┐ | N/A | N/A | N/A |
| Rank = 2 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | N/A | N/A |
| Rank = 3 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | N/A |
| Rank = 4 N₃ ≤ 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | ┌log₂(2L)┐ |
| Rank = 1 N₃ > 19 | ┌log₂(O₁O₂)┐ | $⌈ {log}_{2} ( \begin{matrix}{N}_{1} {N}_{2} \\ L\end{matrix} ) ⌉$ | ┌log₂K^{NZ}┐ | N/A | N/A | N/A |
| Rank = 2 N₃ > 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂┐ | N/A | N/A |
| Rank = 3 N₃ > 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | N/A |
| Rank = 4 N₃ > 19 | ┌log₂(O₁O₂)┐ | $⌈ {log}_{2} ( \begin{matrix}{N}_{1} {N}_{2} \\ L\end{matrix} ) ⌉$ | ┌log₂(2L)┐ | ┌log₂(2L)┐ | ┌log₂(2L)┐ | ┌log2(2L)┐ |
| | Information fields X₂ | | | | | |
| | i_{2,3,1} | i_{2,3,2} | i_{2,3,3} | i_{2,3,4} | i_{1,5} | i_{1,6,1} |
| Rank = 1 N₃ ≤ 19 | 4 | N/A | N/A | N/A | N/A | $⌈ {log}_{2} ( \begin{matrix}{N}_{3} - 1 \\ {M}_{1} - 1\end{matrix} ) ⌉$ |
| Rank = 2 N₃ ≤ 19 | 4 | 4 | N/A | N/A | N/A | $⌈ {log}_{2} ( \begin{matrix}{N}_{3} - 1 \\ {M}_{2} - 1\end{matrix} ) ⌉$ |
| Rank = 3 N₃ ≤ 19 | 4 | 4 | 4 | N/A | N/A | $⌈ {log}_{2} ( \begin{matrix}{N}_{3} - 1 \\ {M}_{3} - 1\end{matrix} ) ⌉$ |
| Rank = 4 N₃ ≤19 | 4 | 4 | 4 | 4 | N/A | $⌈ {log}_{2} ( \begin{matrix}{N}_{3} - 1 \\ {M}_{4} - 1\end{matrix} ) ⌉$ |
| Rank = 1 N₃ > 19 | 4 | N/A | N/A | N/A | ┌log₂(2M₁)┐ | $⌈ {log}_{2} ( \begin{matrix}2 {M}_{1} - 1 \\ {M}_{1} - 1\end{matrix} ) ⌉$ |
| Rank = 2 N3 > 19 | 4 | 4 | N/A | N/A | ┌log₂(2M₂)┐ | $⌈ {log}_{2} ( \begin{matrix}2 {M}_{2} - 1 \\ {M}_{2} - 1\end{matrix} ) ⌉$ |
| Rank = 3 N3 > 19 | 4 | 4 | 4 | N/A | ┌log₂(2M₃)┐ | $⌈ {log}_{2} ( \begin{matrix}2 {M}_{3} - 1 \\ {M}_{3} - 1\end{matrix} ) ⌉$ |
| Rank = 4 N3 >19 | 4 | 4 | 4 | 4 | ┌log₂(2M₄)┐ | $⌈ {log}_{2} ( \begin{matrix}2 {M}_{4} - 1 \\ {M}_{4} - 1\end{matrix} ) ⌉$ |

| | Information fields X₂ | | | | | |
|---|---|---|---|---|---|---|
| | i_{1,6,2} | i_{1,6,3} | i_{1,6,4} | {i_{2,4,l}}_{l=1,...υ} | {i_{2,5,l}}_{l=1,...υ} | {i_{1,7,l}}_{l=1,...υ} |
| Rank = 1 N₃ ≤ 19 | N/A | N/A | N/A | 3(K^{NZ} − 1) | 4(K^{NZ} − 1) | 2LM₁ |
| Rank = 2 N₃ ≤ 19 | $⌈ {log}_{2} ( \begin{matrix}{N}_{3} - 1 \\ {M}_{2} - 1\end{matrix} ) ⌉$ | N/A | N/A | 3(K^{NZ} − 2) | 4(K^{NZ} − 2) | 4LM₂ |
| Rank = 3 N₃ ≤ 19 | $⌈ {log}_{2} ( \begin{matrix}{N}_{3} - 1 \\ {M}_{3} - 1\end{matrix} ) ⌉$ | $⌈ {log}_{2} ( \begin{matrix}{N}_{3} - 1 \\ {M}_{3} - 1\end{matrix} ) ⌉$ | N/A | 3(K^{NZ} − 3) | 4(K^{NZ} − 3) | 6LM₃ |
| Rank = 4 N₃ ≤19 | $⌈ {log}_{2} ( \begin{matrix}{N}_{3} - 1 \\ {M}_{4} - 1\end{matrix} ) ⌉$ | $⌈ {log}_{2} ( \begin{matrix}{N}_{3} - 1 \\ {M}_{4} - 1\end{matrix} ) ⌉$ | $⌈ {log}_{2} ( \begin{matrix}{N}_{3} - 1 \\ {M}_{4} - 1\end{matrix} ) ⌉$ | 3(K^{NZ} − 4) | 4(K^{NZ} − 4) | 8LM₄ |
| Rank = 1 N₃ > 19 | N/A | N/A | N/A | 3(K^{NZ} − 1) | 4(K^{NZ} − 1) | 2LM₁ |
| Rank = 2 N3 > 19 | $⌈ {log}_{2} ( \begin{matrix}2 {M}_{2} - 1 \\ {M}_{2} - 1\end{matrix} ) ⌉$ | N/A | N/A | 3(K^{NZ} − 2) | 4(K^{NZ} − 2) | 4LM₂ |
| Rank = 3 N3 > 19 | $⌈ {log}_{2} ( \begin{matrix}2 {M}_{3} - 1 \\ {M}_{3} - 1\end{matrix} ) ⌉$ | $⌈ {log}_{2} ( \begin{matrix}2 {M}_{3} - 1 \\ {M}_{3} - 1\end{matrix} ) ⌉$ | N/A | 3(K^{NZ} − 3) | 4(K^{NZ} − 3) | 6LM₃ |
| Rank = 4 N3 >19 | $⌈ {log}_{2} ( \begin{matrix}2 {M}_{4} - 1 \\ {M}_{4} - 1\end{matrix} ) ⌉$ | $⌈ {log}_{2} ( \begin{matrix}2 {M}_{4} - 1 \\ {M}_{4} - 1\end{matrix} ) ⌉$ | $⌈ {log}_{2} ( \begin{matrix}2 {M}_{4} - 1 \\ {M}_{4} - 1\end{matrix} ) ⌉$ | 3(K^{NZ} − 4) | 4(K^{NZ} − 4) | 8LM₄ |

Note: the bitwidth for {i_{1,7,l}}_{l=1, . . . , v} and {i_{2,5,l}}_{l=1, . . . , v} shown in 3 is the total bitwidth of {i_{1,7,l}}, {i_{2,4,l}} and {i_{2,5,l}} up to Rank=v, respectively, and the corresponding per layer bitwidths are 2LMᵥ, 3(Kₗ^{NZ}−1), and 4(Kₗ^{NZ}−1), (i.e., 1, 3, and 4 bits for each respective indicator elements k_{l,i,f}⁽³⁾, k_{l,i,f}⁽²⁾, and c_{l,i,f}, respectively), where Kₗ^{NZ} as defined in 3GPP standard specification TS 38.214 is the number of nonzero coefficients for layer l such that K^{NZ}=Σₗ₌₁^{v} Kₗ^{NZ}.

The bitwidth for PMI of codebookType=typeII-PortSelection-r17 is provided in TABLE 4, where the values of P_{CSI-RS}, K₁, K^{NZ}, N₃, N and M are given by 3GPP standard specification TS 38.214.

TABLE 4
PMI of codebookType= typeII-PortSelection-r17

| | Information fields X₁ | | | | | | |
|---|---|---|---|---|---|---|---|
| | i_{1,2} | | i_{1,6} | i_{1,8,1} | i_{1,8,2} | i_{1,8,3} | i_{1,8,4} |
| Rank = 1 | $⌈ {log}_{2} ( \begin{matrix}{P}_{CSI - RS} / 2 \\ {K}_{1} / 2\end{matrix} )$ | | ┌log 2 (N − 1)┐ if N > | ┌log₂(K₁M)┐ | N/A | N/A | N/A |
| | | | M = 2, N/A | | | | |
| | | | otherwise | | | | |
| Rank = 2 | $⌈ {log}_{2} ( \begin{matrix}{P}_{CSI ‐ RS} / 2 \\ {K}_{1} / 2\end{matrix} ) ⌉$ | | ┌log 2 (N − 1)┐ if N > | ┌log₂(K₁M)┐ | ┌log₂(K₁M)┐ | N/A | N/A |
| | | | M = 2, N/A | | | | |
| | | | otherwise | | | | |
| Rank = 3 | $⌈ {log}_{2} ( \begin{matrix}{P}_{CSI ‐ RS} / 2 \\ {K}_{1} / 2\end{matrix} ) ⌉$ | | ┌log 2 (N − 1)┐ if N > | ┌log₂(K₁M)┐ | ┌log₂(K₁M)┐ | ┌log₂(K₁M)┐ | N/A |
| | | | M = 2, N/A | | | | |
| | | | otherwise | | | | |
| Rank = 4 | $⌈ {log}_{2} ( \begin{matrix}{P}_{CSI ‐ RS} / 2 \\ {K}_{1} / 2\end{matrix} ) ⌉$ | | ┌log2 (N − 1)┐ if N > | ┌log₂(K₁M)┐ | ┌log₂(K₁M)┐ | ┌log₂(K₁M)┐ | ┌log₂(K₁M)┐ |
| | | | M = 2, N/A | | | | |
| | | | otherwise | | | | |
| | Information fields X₂ | | | | | | |
| | i_{2,3,1} | i_{2,3,2} | i_{2,3,3} | i_{2,3,4} | {i_{2,4,l}}_{l=1,} _{... ,υ} | {i_{2,5,l}}_{l=1,...,υ} | {i_{1,7,l}}_{l=1,...,υ} |
| Rank = 1 | 4 | N/A | N/A | N/A | 3(K^{NZ} − 1) | 4(K^{NZ} − 1) | N/A if K^{NZ} = |
| | | | | | | | K₁M; |
| | | | | | | | K₁M otherwise |
| Rank = 2 | 4 | 4 | N/A | N/A | 3(K^{NZ} − 2) | 4(K^{NZ} − 2) | N/A if K^{NZ} = |
| | | | | | | | 2K₁M; |
| | | | | | | | 2K₁M otherwise |
| Rank = 3 | 4 | 4 | 4 | N/A | 3(K^{NZ} − 3) | 4(K^{NZ} − 3) | 3K₁M |
| Rank = 4 | 4 | 4 | 4 | 4 | 3(K^{NZ} − 4) | 4(K^{NZ} − 4) | 4K₁M |

Note: the bitwidth for {i_{1,7,l}}_{l=1, . . . , v}, {i_{2,4,l}}_{l=1, . . . , v} and {i_{2,5,l}}_{l=1, . . . , v} shown in TABLE 5 is the total bitwidth of {i_{1,7,l}}, {i_{2,4,l}} and {i_{2,5,l}} up to Rank v, respectively, and the corresponding per layer bitwidths are K₁M, 3(Kₗ^{NZ}−1), and 4(Kₗ^{NZ}−1), (i.e., 1, 3, and 4 bits for each respective indicator elements k_{l,i,f}⁽³⁾, k_{l,i,f}⁽²⁾ and c_{l,i,f}, respectively), where Kₗ^{NZ} as defined in 3GPP standard specification TS 38.214 is the number of nonzero coefficients for layer l such that Kₗ^{NZ}=Σₗ₌₁^{v} Kₗ^{NZ}.

In Rel-16/17 Type-Id CSI reporting, the mapping order of CSI fields of one CSI report, CSI part 1, is shown in 3GPP TS 38.212, which is as follows.

TABLE 5
Mapping order of CSI fields of one CSI report, CSI part 1

| CSI report | |
|---|---|
| number | CSI fields |
| CSI report #n | CRI as in Tables 6.3.1.1.2-3/4/6 of 3GPP TS 38.212, if reported |
| CSI part 1 | Rank Indicator as in Tables 6.3.1.1.2-3/4/5 or 6.3.2.1.2-8/9 of 3GPP TS |
| | 38.212, if reported |
| | Wideband CQI for the first TB as in Tables 6.3.1.1.2-3/4/5 or 6.3.2.1.2- |
| | 8/9 of 3GPP TS 38.212, if reported |
| | Subband differential CQI for the first TB with increasing order of |
| | subband number as in Tables 6.3.1.1.2-3/4/5 or 6.3.2.1.2-8/9 of 3GPP |
| | TS 38.212, if reported |
| | Indicator of the number of non-zero wideband amplitude coefficients M₀ |
| | for layer 0 as in Table 6.3.1.1.2-5 of 3GPP TS 38.212, if reported |
| | Indicator of the number of non-zero wideband amplitude coefficients M₁ |
| | for layer 1 as in Table 6.3.1.1.2-5 of 3GPP TS 38.212 (if the rank |
| | according to the reported RI is equal to one, this field is set to all zeros), |
| | if 2-layer PMI reporting is allowed according to the rank restriction in |
| | Clauses 5.2.2.2.3 and 5.2.2.2.4 of 3GPP TS 38.214 and if reported |
| | Indicator of the total number of non-zero coefficients summed across all |
| | layers K^{NZ} as in Table 6.3.2.1.2-8/9 of 3GPP TS 38.212, if reported |

Note:
Subbands for given CSI report n indicated by the higher layer parameter csi-ReportingBand are numbered continuously in the increasing order with the lowest subband of csi-ReportingBand as subband 0.

In Rel-16 Type-II CSI reporting, the mapping order of CSI fields of one CSI report, CSI part 2, is shown in 3GPP TS38.212, which is as follows:

TABLE 6
Mapping order of CSI fields of one CSI report, CSI part 2 of codebookType=typeII-
r16 or typeII-PortSelection-r16

| CSI report | |
|---|---|
| number | CSI fields |
| CSI report #n | PMI fields X₁, from left to right as in Tables 6.3.2.1.2-1A/2A, if |
| CSI part 2, | reported |
| group 0 | |
| CSI report #n | The following PMI fields X₂, from left to right, as in Tables 6.3.2.1.2- |
| CSI part 2, group 1 | $1 A / 2 A : \{ {i}_{2 , 3 , l} : l = 1 , … , υ \} , {i}_{1 , 5} , \{ {i}_{1 , 6 , l} : l = 1 , … , υ \} and max ( 0 , ⌈ \frac{{K}^{N Z}}{2} ⌉ - υ ) \times 3$ |
| | highest priority bits of |
| | $\{ {i}_{2 , 4 , l} : l = 1 , … , υ \} , max ( 0 , ⌈ \frac{{K}^{N Z}}{2} ⌉ - υ ) \times 4 highest priority bits of$ |
| | {i_{2,5,l}: l = 1, ... , υ} and v * 2LM_{υ} − └K^{NZ}/2┘ highest priority bits |
| | of{i_{1,7,l}: l = 1, ... , υ}, in decreasing order of priority based on the |
| | corresponding function Pri(l, i, f) defined in clause 5.2.3 of TS38.214, |
| | if reported |
| CSI report #n | The following PMI fields X₂, from left to right, as in Tables 6.3.2.1.2- |
| CSI part 2, group 2 | $1 A / 2 A : min ( {K}^{N Z} - v , ⌊ \frac{{K}^{N Z}}{2} ⌋ ) \times 3 lowest priority bits of \{ {i}_{2 , 4 , l} : l =$ |
| | $1 , … , υ \} , min ( {K}^{N Z} - υ , ⌊ \frac{{K}^{N Z}}{2} ⌋ ) \times 4 lowest priority bits of \{ {i}_{2 , 5 , l} : l =$ |
| | 1, ... , υ}and └K^{NZ}/2┘ lowest priority bits of {i_{1,7,l}: l = 1, ... , υ}, in |
| | decreasing order of priority based on the corresponding function |
| | Pri(l, i, f) defined in clause 5.2.3 of TS38.214, if reported |

In Rel-16 Type-II CSI reporting, the mapping order of CSI fields of one CSI report, CSI part 2, is given by 3GPP TS 38.212, which is as follows:

TABLE 7
Mapping order of CSI fields of one CSI report, CSI part 2 of codebookType=typeII-
PortSelection-r17

| CSI report | |
|---|---|
| number | CSI fields |
| CSI report #n | PMI fields X₁, from left to right as in Tables 6.3.2.1.2-2B, if reported |
| CSI part 2, group 0 | |
| CSI report #n | The following PMI fields X₂, from left to right, as in Tables |
| CSI part 2, group 1 | $6.3 \text{.2} \text{.1} \text{.2} - 2 B : \{ {i}_{2 , 3 , l} : l = 1 , … , υ \} max ( 0 , ⌈ \frac{{K}^{N Z}}{2} ⌉ - υ ) ) \times 3 highest$ |
| | priority bits of |
| | $\{ {i}_{2 , 4 , l} : l = 1 , … , υ \} , ( max ( 0 , ⌈ \frac{{K}^{N Z}}{2} ⌉ - υ ) ) \times 4 highest priority bits of$ |
| | {i_{2,5,l}: l = 1, ... , υ} and v * K₁M − └K^{NZ}/2┘ highest priority bits |
| | of{i_{1,7,l}: l = 1, ... , υ}, in decreasing order of priority based on the |
| | corresponding function Pri(l, i, f) defined in clause 5.2.3 of |
| | TS38.214, if reported |
| CSI report #n | The following PMI fields X₂, from left to right, as in Tables |
| CSI part 2, group 2 | $6.3 \text{.2} \text{.1} \text{.2} - 2 B : ( min ( {K}^{N Z} - υ , ⌊ \frac{{K}^{N Z}}{2} ⌋ ) ) \times 3 lowest priority bits of$ |
| | $\{ {i}_{2 , 4 , l} : l = 1 , … , υ \} , ( min ( {K}^{N Z} - υ , ⌊ \frac{{K}^{N Z}}{2} ⌋ ) ) \times 4 lowest priority bits of$ |
| | {i_{2,5,l}: l = 1, ... , υ} and └K^{NZ}/2┘ lowest priority bits of |
| | {i_{1,7,l}: l = 1, ... , υ}, in decreasing order of priority based on the |
| | corresponding function Pri(l, i, f) defined in clause 5.2.3 of |
| | TS38.214, if reported |

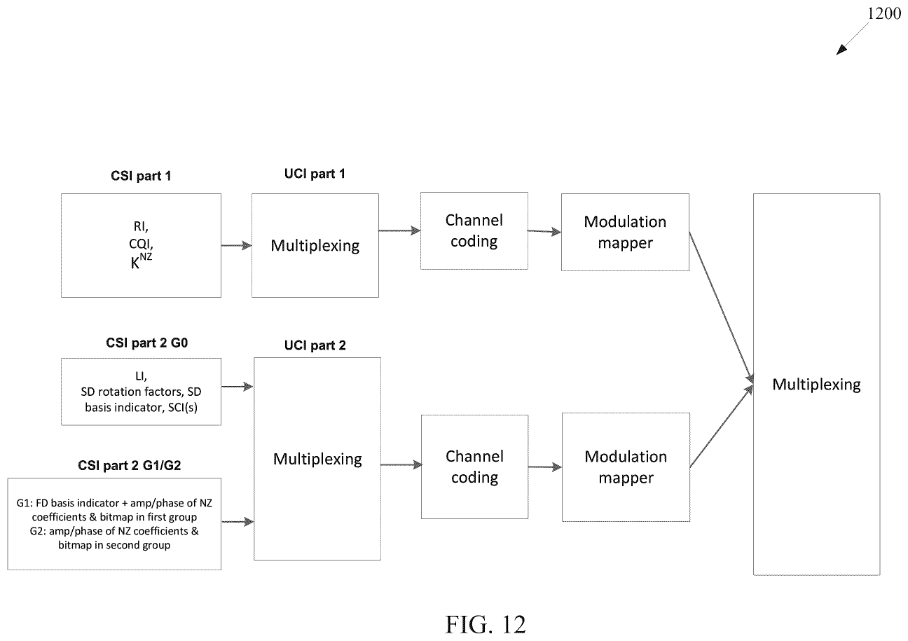

FIG. 12 illustrates an example of two-part UCI used to multiplex and report CSI 1200 according to embodiments of the present disclosure. An embodiment of the UCI used to multiplex and report CSI 1200 shown in FIG. 12 is for illustration only.

In one embodiment, the two-part UCI (or two-part CSI) (FIG. 12) is used to multiplex and report CSI comprising CSI part 1 and CSI part 2 according to the above-mentioned framework, e.g., Mode1/Mode 2 codebooks for Rel-18 (or beyond) CJT Type-II CSI.

In one embodiment, on Rel-16-Type-II-CSI-based refinement for Rel-18 Type-II CSI.

In one embodiment, when either Mode 1 or Mode 2 is configured by higher-layer signaling (i.e., RRC), CSI part 1 includes at least one of the following parameters: (1) (I1) N_{TRP}-bit bitmap indicator to indicate a set of selected TRPs (CSI-RS resources); (2) (I2) An indicator of ┌log₂ N_{L}┐-bit to indicate one combination of values for (L₁, ⋅ ⋅ ⋅ L_{N}_{_{TRP}}), where N_{L}≥1; (3) (I3) A reference TRP (CSI-RS) indicator (for FD basis reporting); and (4) Legacy parameters: RI, CQI(s) (subband differential CQIs), an indicator of the number of non-zero coefficients, K^{NZ} (total number of NZC across all layers).

In one example, the N_{TRP}-bit bitmap indicator can be absent (not reported) if a restriction where the number of selected (cooperating) TRPs N is the same as N_{TRP} (e.g., N=N_{TRP}, all TRP selection) is configured by higher-layer signaling, i.e., the N_{TRP}-bit bitmap is reported if N≤N_{TRP} is allowed (e.g., by configuration). In one example, the CRI can be reused as the N_{TRP}-bit bitmap indicator.

In one example, the indicator of ┌log₂ N_{L}┐-bit can be absent (not reported) if N_{L}=1 (i.e., one combination of values for (L₁, ⋅ ⋅ ⋅ , L_{N}_{_{TRP}})) is configured by higher-layer signaling, i.e., the indicator of ┌log₂ N_{L}┐-bit is reported if N_{L}>1.

In one example, the reference TRP (CSI-RS) indicator has ┌log₂ N_{TRP}┐-bit length.

In one example, the CRI can be reused for the reference TRP (CSI-RS) indicator for Rel-18 Type-II CSI. In this case, no new reference TRP (CSI-RS) indicator is specified. In one example, the reference TRP (CSI-RS) indicator can be included in CSI part 2 (not in CSI part 1).

In one embodiment, when either Mode 1 or Mode 2 is configured by higher-layer signaling (i.e., RRC), CSI part 2 includes at least one of the following parameters.

In one example, CSI part 2 includes an indicator of ┌log₂ O₁O₂┐-bit to indicate SD basis oversampling group for each CSI-RS (TRP) resource, i_{1,1,r}, where r is a CSI-RS (TRP) index.

In one example, CSI part 2 includes an indicator of

$$⌈ {log}_{2} ( \begin{matrix}{N}_{1} {N}_{2} \\ {L}_{r}\end{matrix} ) ⌉$$

bit to indicate Lᵣ SD basis vector selection for each CSI-RS (TRP) resource, i_{1,2,r}, where r is a CSI-RS (TRP) index.

In one example, CSI part 2 includes an indicator i_{1,8,l} to indicate a strongest coefficient across all CSI-RS resources for each layer1.

In one example, CSI part 2 includes an indicator i_{2,3,l} to indicate either (ex 1) a reference amplitude or (ex 2) 2N−1 reference amplitudes: (1) in one example, i_{2,3,l} for each layer l, where each i_{2,3,l} has n-bit length. In one example, n=4; and (2) in one example, i_{2,3,l} for each layer l, where each i_{2,3,l} has n×(2N−1)-bit length, and N is the number of selected (cooperating) TRPs (which can be inferred from N_{TRP}-bit bitmap indicator in CSI part 1). In one example, n=4.

In one example, CSI part 2 includes an indicator i_{1.5} to indicate for Mᵢₙᵢₜᵢₐₗ (i.e., window offset) when N₃>19: (1) in one example, i_{1.5} is common across all CSI-RS (TRP) resources, i.e., one for all CSI-RS resources, where the size of i_{1.5} is ┌log₂ 2Mᵥ ┐ bit and v is rank (i.e., the number of layers); (2) in one example, i_{1.5} is independent for each CSI-RS (TRP) resource, i.e., one for each CSI-RS resource: (i) in one instance, it can be denoted by i_{1.5r*}, where r is a CSI-RS (TRP) index and the size of i_{1.5,r} is ┌log₂ 2Mᵥ ┐ bit and v is rank (i.e., the number of layers); and (ii) in one instance, for one CSI-RS resource, the size of i_{1.5,r*} is ┌log₂ 2Mᵥ┐ bits and for other N−1 CSI-RS resources, the size of i_{1.5,r} is ┌log₂ N₃┐ bits for r≠r*. For example, r* is the CSI-RS resource index associated with (or including) the SCI.

In one example, CSI part 2 includes (I4) an indicator to indicate FD basis selection offset relative to a reference CSI-RS (TRP) resource for each CSI-RS resource, either N₃>19 or/and N₃≤19 L: (1) in one example, the indicator for each of N−1 CSI-RS resources (excluding the reference CSI-RS resource) has ┌log₂ N₃┐ (or ┌log₂(N₃−1)┐) bits across all layers 1=1, ⋅ ⋅ ⋅ , v; (2) in one example, the indicator for each of N−1 CSI-RS resources (excluding the reference CSI-RS resource) has ┌log₂ N₃┐ (or ┌log₂(N₃−1)┐) bits for each layer l; (3) in one example, the indicator for each of N CSI-RS resources has ┌log₂ N₃┐ (or ┌log₂(N₃−1)┐) bits across all layers 1=1, ⋅ ⋅ ⋅ , v; and (4) in one example, the indicator for each of N CSI-RS resources has ┌log₂ N₃┐ (or ┌log₂(N₃−1)┐) bits for each layer l.

In one example, CSI part 2 includes an indicator i_{1,6,l} to indicate FD basis vector selection for each layer l: (1) in one example, the indicator is common for all CSI-RS (TRP) resources, i.e., one for all CSI-RS resources, where the size of i_{1,6,l} is

$$⌈ {log}_{2} ( \begin{matrix}2 {M}_{v} - 1 \\ {M}_{v} - 1\end{matrix} ) ⌉$$

bits for N₃>19 or

$$⌈ {log}_{2} ( \begin{matrix}{N}_{3} - 1 \\ {M}_{υ} - 1\end{matrix} ) ⌉$$

bits for N₃≤19; (2) in one example, the indicator is independent for each CSI-RS resource, i.e., one for each CSI-RS resource: (i) in one instance, it can be denoted by i_{1,6,l,r}, where r is a CSI-RS (TRP) index and where the size of i_{1,6,l,r} is

$$⌈ {log}_{2} ( \begin{matrix}2 {M}_{υ} - 1 \\ {M}_{υ} - 1\end{matrix} ) ⌉$$

bits for N₃≥19 or

$$⌈ {log}_{2} ( \begin{matrix}{N}_{3} - 1 \\ {M}_{υ} - 1\end{matrix} ) ⌉$$

bits for N₃≤19; and (ii) in one instance, for one CSI-RS resource, the size of i_{1,6,l,r*} is

$$⌈ {log}_{2} ( \begin{matrix}2 {M}_{υ} - 1 \\ {M}_{υ} - 1\end{matrix} ) ⌉$$

bits for N₃>19 and for other N−1 CSI-RS resources, the size of i_{1,6,l,r*} is

$$⌈ {log}_{2} ( \begin{matrix}2 {M}_{υ} \\ {M}_{υ}\end{matrix} ) ⌉$$

bits for N>19 for r≠r*. Or, for one CSI-RS resource, the size of i_{1,6,l,r*} is

$$⌈ {log}_{2} ( \begin{matrix}{N}_{3} - 1 \\ {M}_{υ} - 1\end{matrix} ) ⌉$$

bits for N₃<19 and for other N−1 CSI-RS resources, the size of i_{1,6,l,r*} is

$$⌈ {log}_{2} ( \begin{matrix}{N}_{3} \\ {M}_{υ}\end{matrix} ) ⌉$$

bits for N₃≤19 for r≠r*. For example, r* is the CSI-RS resource index associated with (or including) the SCI.

In one example, CSI part 2 includes an indicator {i_{2,4,l}}_{l=1, . . . , v} to indicate amplitude coefficients across all CSI-RS (TRP) resources, where the size of the indicator is n_{α}(K^{NZ}−v) bits, n_{α} is the number of bits for amplitude coefficient, and K^{NZ} is the total number of non-zero coefficients across all CSI-RS (TRP) resources. In one example, n_{α}=3.

In one example, CSI part 2 includes an indicator {i_{2,5,l}}_{l=1, . . . v} to indicate phase coefficients across all CSI-RS (TRP) resources, where the size of the indicator is nₚ(K^{NZ}−v) bits, nₚ is the number of bits for phase coefficient, and K^{NZ} is the total number of non-zero coefficients across all CSI-RS (TRP) resources. In one example, nₚ=4.

In one example, CSI part 2 includes an indicator {i_{7,1,l}}_{l=1, ⋅ ⋅ ⋅ v} to indicate locations of non-zero coefficients across all CSI-RS (TRP) resources, where the size of the indicator is v2Mᵥ Σᵣ Lᵣ and r is a CSI-RS (TRP) index.

In one example, CSI part 2 includes (I3) An indicator to indicate a reference CSI-RS (TRP) resource, where the size of the indicator is ┌log₂ N┐ bits and N is the number of selected (cooperating) TRPs (which can be inferred from N_{TRP}-bit bitmap indicator in CSI part 1).

In this disclosure, legacy parameters/indicators refer to the indicators excluding (I1), (I2), (I3), and (I4) described in the mentioned embodiments.

In one embodiment, CSI part 1 and CSI part 2 include (whole or a subset of) legacy parameters/indicators described in embodiments disclosed in the present disclosure (similar to Rel-16 CSI) and new indicators (I1), (I2), (I3), and (I4) for CJT according to at least one of the following examples.

In one example: (1) CSI part 1 includes (I1) a N_{TRP}-bit bitmap indicator, (I2) an indicator of ┌log₂ N_{L}┐-bit, and (I3) a reference CSI-RS (TRP) indicator (for FD basis reporting); and (2) group 0 of CSI part 2 includes (I4) an (new) indicator to indicate FD basis selection offset relative to a reference CSI-RS (TRP) resource.

In one example: (1) CSI part 1 includes (I1) a N_{TRP}-bit bitmap indicator, (I2) an indicator of ┌log₂ N_{L}┐-bit, and (I3) a reference CSI-RS (TRP) indicator (for FD basis reporting); and (2) group 1 of CSI part 2 includes (I4) an (new) indicator to indicate FD basis selection offset relative to a reference CSI-RS (TRP) resource.

In one example: (1) CSI part 1 includes (I1) a N_{TRP}-bit bitmap indicator, (I2) an indicator of ┌log₂ N_{L}┐-bit, and (I3) a reference CSI-RS (TRP) indicator (for FD basis reporting); and (2) group 2 of CSI part 2 includes (I4) an (new) indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; and (2) group 0 of CSI part 2 includes (I3) a reference CSI-RS (TRP) indicator (for FD basis reporting), and (I4) an indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; (2) group 0 of CSI part 2 includes (I3) a reference CSI-RS (TRP) indicator (for FD basis reporting); and (3) group 1 of CSI part 2 includes (I4) an indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; (2) group 0 of CSI part 2 includes (I3) a reference CSI-RS (TRP) indicator (for FD basis reporting); and (3) group 2 of CSI part 2 includes (I4) an indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; (2) group 0 of CSI part 2 includes (I4) an indicator to indicate FD basis selection offset relative to a reference CSI-RS (TRP) resource; and (3) group 1 of CSI Part 2 includes (I3) a reference CSI-RS (TRP) indicator (for FD basis reporting).

In one example: (1) CSI part 1 includes (I1) a N_{TRP}-bit bitmap indicator, and (I2) an indicator of ┌log₂ N_{L}┐-bit; and (2) group 1 of CSI part 2 includes (I3) a reference CSI-RS (TRP) indicator (for FD basis reporting), and (I4) an indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; (2) group 1 of CSI Part 2 includes (I3) a reference CSI-RS (TRP) indicator (for FD basis reporting); and (3) group 2 of CSI part 2 includes (I4) an indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; (2) group 0 of CSI part 2 includes (I4) an indicator to indicate FD basis selection offset relative to a reference CSI-RS (TRP) resource; and (3) group 2 of CSI Part 2 includes (I3) a reference CSI-RS (TRP) indicator (for FD basis reporting).

In one example: (1) CSI part 1 includes (I1) a N_{TRP}-bit bitmap indicator, and (I2) an indicator of ┌log₂ N_{L}┐-bit; (2) group 1 of CSI part 2 includes (I4) an indicator to indicate FD basis selection offset relative to a reference CSI-RS (TRP) resource; and (3) group 2 of CSI Part 2 includes (I3) a reference CSI-RS (TRP) indicator (for FD basis reporting).

In one example: (1) CSI part 1 includes (I1) a N_{TRP}-bit bitmap indicator, and (I2) an indicator of ┌log₂ N_{L}┐-bit; and (2) group 2 of CSI part 2 includes (I3) a reference CSI-RS (TRP) indicator (for FD basis reporting), and (I4) an indicator to indicate FD basis selection offset relative to a reference CSI-RS (TRP) resource.

In one embodiment, CSI part 1 and CSI part 2 include legacy parameters/indicators (similar to Rel-16 CSI) and new indicators (I1), (I2), and (I3) for CJT according to at least one of the following examples.

In one example, CSI part 1 includes (I1) a N_{TRP}-bit bitmap indicator, (I2) an indicator of ┌log₂ N_{L}┐-bit, and (I3) a reference CSI-RS (TRP) indicator (for FD basis reporting).

In one example: (1) CSI part 1 includes (I1) a N_{TRP}-bit bitmap indicator, (I2) an indicator of ┌log₂ N_{L}┐-bit; and (2) group 0 of CSI part 2 includes (I3) a reference CSI-RS (TRP) indicator (for FD basis reporting).

In one example: (1) CSI part 1 includes (I1) a N_{TRP}-bit bitmap indicator, (I2) an indicator of ┌log₂ N_{L}┐-bit; and (2) group 1 of CSI part 2 includes (I3) a reference CSI-RS (TRP) indicator (for FD basis reporting).

In one example: (1) CSI part 1 includes (I1) a N_{TRP}-bit bitmap indicator, (I2) an indicator of ┌log₂ N_{L}┐-bit; and (2) group 2 of CSI part 2 includes (I3) a reference CSI-RS (TRP) indicator (for FD basis reporting).

In embodiment, CSI part 1 and CSI part 2 include legacy parameters/indicators (similar to Rel-16 CSI) and new indicators (I1), (I2), and (I4) for CJT according to at least one of the following examples.

In one example: (1) CSI part 1 includes (I1) a N_{TRP}-bit bitmap indicator, and (I2) an indicator of ┌log₂ N_{L}┐-bit; and (2) group 0 of CSI part 2 includes (I4) an (new) indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; and (2) group 1 of CSI part 2 includes (I4) an (new) indicator to indicate FD basis selection offset relative to a reference CSI-RS (TRP) resource.

In one example: (1) CSI part 1 includes (I1) a N_{TRP}-bit bitmap indicator, and (I2) an indicator of ┌log₂ N_{L}┐-bit; and (2) group 2 of CSI part 2 includes (I4) an (new) indicator to indicate FD basis selection offset relative to a reference CSI-RS (TRP) resource.

In embodiment, CSI part 1 and CSI part 2 include legacy parameters/indicators (similar to Rel-16 CSI) and new indicators (I1) and (I2) for CJT according to at least one of the following examples.

In one example, CSI part 1 includes (I1) a N_{TRP}-bit bitmap indicator, and (I2) an indicator of ┌log₂ N_{L}┐-bit.

In one embodiment, a reference CSI-RS can be implicitly derived, hence there can be no reference CSI-RS indicator (i.e., (I3)) in CSI part 1 or/and CSI part 2. For example, a CSI-RS resource associated with SCI can be regarded as a reference CSI-RS resource.

In one embodiment/example, any embodiment/example described under embodiment as disclosed in the present disclosure excluding one example can be another embodiment/example.

In one embodiment/example, any embodiment/example described under embodiment as disclosed in the present disclosure excluding one example and including a reference CSI-RS resource=CSI-RS resource associated with SCI can be another embodiment/example.

In one embodiment, Rel-17-Type-II-CSI-based refinement for Rel-18 Type-II CSI is provided.

In one embodiment, when either Mode 1 or Mode 2 is configured by higher-layer signaling (i.e., RRC), CSI part 1 includes at least one of the following parameters: (1) (I1) N_{TRP}-bit bitmap indicator to indicate a set of selected TRPs (CSI-RS resources); (2) (I2) An indicator of ┌log₂ N_{L}┐-bit to indicate one combination of values for (L₁, ⋅ ⋅ ⋅ , L_{N}_{_{TRP}}), where N_{L}≥1; (3) (I3) A reference TRP (CSI-RS) indicator (for FD basis reporting); and (4) legacy parameters: RI, CQI(s) (subband differential CQIs), an indicator of the number of non-zero coefficients, K^{NZ} (total number of NZC across all layers).

In one example, the N_{TRP}-bit bitmap indicator can be absent (not reported) if a restriction where the number of selected (cooperating) TRPs N is the same as N_{TRP} (e.g., N=N_{TRP}, all TRP selection) is configured by higher-layer signaling, i.e., the N_{TRP}-bit bitmap is reported if N≤N_{TRP} is allowed (e.g., by configuration). In one example, the CRI can be reused as the N_{TRP}-bit bitmap indicator.

In one example, the indicator of ┌log₂ N_{L}┐-bit can be absent (not reported) if N_{L}=1 (i.e., one combination of values for (L₁, ⋅ ⋅ ⋅ , L_{N}_{_{TRP}})) is configured by higher-layer signaling, i.e., the indicator of ┌log₂ N_{L}┐-bit is reported if N_{L}>1.

In one example, the reference TRP (CSI-RS) indicator has ┌log₂ N_{TRP}┐-bit length.

In one example, the CRI can be reused for the reference TRP (CSI-RS) indicator for Rel-18 Type-II CSI. In this case, no new reference TRP (CSI-RS) indicator is specified.

In one example, the reference TRP (CSI-RS) indicator can be included in CSI part 2 (not in CSI part 1).

In one embodiment, when either Mode 1 or Mode 2 is configured by higher-layer signaling (i.e., RRC), CSI part 2 includes at least one of the following parameters.

In one example, CSI part 2 includes an indicator of

$$⌈ {log}_{2} ( \begin{matrix}{P}_{CSI ‐ RS} / 2 \\ {L}_{r}\end{matrix} ) ⌉$$

-bit to indicate Lᵣ SD basis vector selection for each CSI-RS (TRP) resource, i_{1,2,r}, where r is a CSI-RS (TRP) index, P_{CSI-RS}=2N₁N₂, and Lᵣ=αᵣP_{CSI-RS}/2, and K_{1,r}=αᵣP_{CSI-RS}.

In one example, CSI part 2 includes an indicator i_{1,8,l} to indicate a strongest coefficient across all CSI-RS resources for each layer l.

In one example, CSI part 2 includes an indicator i_{2,3,l} to indicate either (ex 1) a reference amplitude or (ex 2) 2N−1 reference amplitudes: (1) in one example, i_{2,3,l} for each layer l, where each i_{2,3,l} has n-bit length. In one example, n=4; and (2) in one example, i_{2,3,l} for each layer l, where each i_{2,3,l} has n×(2N−1)-bit length, and N is the number of selected (cooperating) TRPs (which can be inferred from N_{TRP}-bit bitmap indicator in CSI part 1). In one example, n=4.

In one example, CSI part 2 includes an indicator i_{1,6} to indicate FD basis vector selection: (1) in one example, the indicator is common for all CSI-RS (TRP) resources, i.e., one for all CSI-RS resources, where the size of i_{1,6} is ┌log₂(N_{R17}−1)┐ if N_{R17}>M=2, N/A otherwise, where N_{R17} is a value configured by higher-layer parameter (e.g., valueOfN); and (2) in one example, the indicator is independent for each CSI-RS resource, i.e., one for each CSI-RS resource. For example, it can be denoted by i_{1,6,r}, where r is a CSI-RS (TRP) index and where the size of i_{1,6,r} is ┌log₂(N_{R17}−1)┐ if N_{R17}>M=2, N/A otherwise, where N_{R17} is a value configured by higher-layer parameter (e.g., valueOfN).

In one example, CSI part 2 includes an indicator {i_{2,4,l}}_{l=1, . . . v}, to indicate amplitude coefficients across all CSI-RS (TRP) resources, where the size of the indicator is n_{α}(K^{NZ}−v) bits, n_{α} is the number of bits for amplitude coefficient, and K^{NZ} is the total number of non-zero coefficients across all CSI-RS (TRP) resources. In one example, n_{α}=3.

In one example, CSI part 2 includes an indicator {i_{2,5,l}}_{l=1, . . . , v} to indicate phase coefficients across all CSI-RS (TRP) resources, where the size of the indicator is nₚ(K^{NZ}−v) bits, nₚ is the number of bits for phase coefficient, and K^{NZ} is the total number of non-zero coefficients across all CSI-RS (TRP) resources. In one example, nₚ=4.

In one example, CSI part 2 includes an indicator {i_{1,7,l}}_{l=1, . . . , v} to indicate locations of non-zero coefficients across all CSI-RS (TRP) resources, where the size of the indicator is vM Σᵣ K_{1,r} and r is a CSI-RS (TRP) index.

In one example, CSI part 2 includes (I3) an indicator to indicate a reference CSI-RS (TRP) resource, where the size of the indicator is ┌log₂ N┐ bits and N is the number of selected (cooperating) TRPs (which can be inferred from N_{TRP}-bit bitmap indicator in CSI part 1).

In the present disclosure, legacy parameters/indicators refer to the indicators excluding (I1), (I2), and (I3) described in the mentioned embodiments.

In one embodiment, CSI part 1 and CSI part 2 include legacy parameters/indicators (similar to Rel-17 CSI) and new indicators (I1), (I2), and (I3) for CJT according to at least one of the following examples.

In one example, CSI part 1 includes (I1) a N_{TRP}-bit bitmap indicator, (I2) an indicator of ┌log₂ N_{L}┐-bit, and (I3) a reference CSI-RS (TRP) indicator (for FD basis reporting).

In one example: (1) CSI part 1 includes (I1) a N_{TRP}-bit bitmap indicator, (I2) an indicator of ┌log₂ N_{L}┐-bit; and (2) group 0 of CSI part 2 includes (I3) a reference CSI-RS (TRP) indicator (for FD basis reporting).

In one example: (1) CSI part 1 includes (I1) a N_{TRP}-bit bitmap indicator, (I2) an indicator of ┌log₂ N_{L}┐-bit; and (2) group 1 of CSI part 2 includes (I3) a reference CSI-RS (TRP) indicator (for FD basis reporting).

In one example: (1) CSI part 1 includes (I1) a N_{TRP}-bit bitmap indicator, (I2) an indicator of ┌log₂ N_{L}┐-bit; and (2) group 2 of CSI part 2 includes (I3) a reference CSI-RS (TRP) indicator (for FD basis reporting).

In one embodiment, CSI part 1 and CSI part 2 include legacy parameters/indicators (similar to Rel-17 CSI) and new indicators (I1) and (I2) for CJT according to at least one of the following examples.

In one example, CSI part 1 includes (I1) a N_{TRP}-bit bitmap indicator, and (I2) an indicator of ┌log₂ N_{L}┐-bit.

In one embodiment, a reference CSI-RS can be implicitly derived, hence there can be no reference CSI-RS indicator (i.e., (I3)) in CSI part 1 or/and CSI part 2. For example, a CSI-RS resource associated with SCI can be regarded as a reference CSI-RS resource.

In one embodiment/example, any embodiment/example described under embodiment as disclosed in the present disclosure excluding one example can be another embodiment/example.

In one embodiment/example, any embodiment/example described under embodiment as disclosed in the present disclosure excluding one example and including a reference CSI-RS resource=CSI-RS resource associated with SCI can be another embodiment/example.

Any of the above variation embodiments can be utilized independently or in combination with at least one other variation embodiment.

The present disclosure provides multi-TRP C-JT scenarios and provides method and apparatus for CSI reporting in multi-TRP scenarios.

The present disclosure provides electronic devices and methods on CSI codebook and reporting for MIMO operations, more particularly, to electronic devices and methods on CSI codebook and reporting for distributed MIMO or multi-TRP operations in wireless networks.

CSI enhancement described in Rel-18 MIMO considers Rel-16/17 Type-II CSI codebook refinements to support mTRP coherent joint transmission (C-JT) operations by considering performance-and-overhead trade-off. The Rel-16/17 Type-II CSI codebook has three components W₁, W₂, and W_{f}. CSI coefficients in W₂ across TRPs can have different reference amplitude values due to power imbalance across TRPs. Components for indicating the reference values across TRPs need to be supported in Rel-18.

In the present disclosure, components to indicate reference values/relative offsets and reporting for W1/W2/W_{f} are provided for multi-TRP C-JT scenarios.

In one embodiment, a UE is configured with an mTRP (or D-MIMO or C-JT) codebook, via e.g., higher layer parameter codebookType set to “typeII-r18-cjt,” which is designed based on Rel-16/17 Type-II codebook. For example, The mTRP codebook has a triple-stage structure which can be represented as W=W₁W₂W_{f}^{H}, where the component W₁ is used to report/indicate a spatial-domain (SD) basis matrix comprising SD basis vectors, the component W_{f} is used to report/indicate a frequency-domain (FD) basis matrix comprising FD basis vectors, and the component W₂ is used to report/indicate coefficients corresponding to SD and FD basis vectors.

In one embodiment, for the mTRP codebook, W_{f} basis vectors (or indices of FD basis vectors) and W₂ FD indices (columns of W₂) or FD indices of coefficients are shifted (or rotated or remapping) based on or with respect to the FD beam index f*, which can be reference FD beam index.

In Rel-16 Type-II codebook, the remapping procedure is illustrated in 3GPP standard specification: let fₗ*∈{0, 1, . . . , Mᵥ−1} be the index of i_{2,4,l} and iₗ*∈{0, 1, . . . , 2L−1} be the index of k_{l,f}_{ₗ}_{*}⁽²⁾ which identify the strongest coefficient of layer l, i.e., the element k_{l,i,}_{ₗ}_{*,f}_{ₗ}_{*}⁽²⁾ of i_{2,4,l}, for l=1, . . . , v. The codebook indices of n_{3,l} are remapped with respect to n_{3,l}^{(f}^{ₗ}^{*)} as n_{3,l}^{(f)}=(n_{3,l}^{(f)}−n_{3,l}^{(f*)}) mod N₃, such that n_{3,l}^{(f}^{ₗ}^{*)}, after remapping. The index f is remapped with respect to fₗ* as f=(f−fₗ*)mod Mᵥ, such that the index of the strongest coefficient is fₗ*=0 (l=1, . . . , v), after remapping. The indices of i_{2,4,l}, i_{2,5,l} and i_{1,7,l} indicate amplitude coefficients, phase coefficients and bitmap after remapping.

In one example, the strongest coefficient of layer l is identified by i_{1,8,l}∈{0, 1, . . . , 2L−1}, which is obtained as follows:

$${i}_{1 , 8 , l} = \{ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq 4\end{matrix} for l = 1 , … , υ .$$

In one example, the strongest coefficient of layer l is identified by i_{1,8,l}∈{0, 1, . . . , 2L−1}, which is obtained as follows i_{1,8,l}=iₗ* for all rank v∈{1, . . . , 4} and for l=1, . . . , v.

In example, the reference FD beam index f* is the FD beam index f of the SCI (of the strongest TRP). The SCI hence the index f* is layer-common, i.e., the same for all layers.

In one example, the reference FD beam index f* is the FD beam index f of the SCI of a reference TRP. The SCI hence the index f* is layer-common, i.e., the same for all layers.

In one example, a reference TRP can be configured via RRC, MAC-CE, or DCI. In one example, a reference TRP can be fixed or determined in a pre-defined rule. In one example, a reference TRP can be determined by UE and reported as a part of CSI. In one example, a strongest TRP can be a reference TRP.

In one example, the reference FD beam index f* is fixed (e.g., the lowest index among the FD basis vectors). The fixed index f* is layer-common, i.e., the same for all layers.

In one example, the reference FD beam index f* is a configured, via, DCI, MAC-CE, or RRC by NW (layer-common). The configured index can be one of indices of FD basis vectors. Or the configured index can be different from indices of FD basis vectors. The configured index f* is layer-common, i.e., the same for all layers.

In one example, W_{f} basis vectors and W₂ FD indices (columns of W₂) associated with the strongest TRP (or a reference TRP) are shifted (or rotate or remapping FD indices) based on the FD beam index f*, where f* is according to one of the examples disclosed in the present disclosure. For the rest of the TRPs, the shift or rotation or remapping may not be performed. The index f* is layer-common, i.e., the same for all layers.

In one example, W_{f} basis vectors and W₂ FD indices (columns of W₂) associated with all TRPs are shifted (or rotated or remapping FD indices) based on the FD beam index f*, where f* is according to one of the examples disclosed in the present disclosure.

In one example, the reference FD beam index fₗ* is the FD beam index fₗ of the SCI (of the strongest TRP, or a reference TRP) for each layer l. The SCI hence the index fₗ* is layer-specific, i.e., one SCI for each layer.

In one example, the reference FD beam index fₗ* is fixed (e.g., the lowest index among the FD basis vectors) for each layer l. The fixed index fₗ* is layer-specific, i.e., one SCI for each layer.

In one example, the reference FD beam index fₗ* is a configured, via, DCI, MAC-CE, or RRC by NW (layer-specific). The configured index can be one of indices of FD basis vectors. Or the configured index can be different from indices of FD basis vectors. The configured index fₗ* is layer-specific, i.e., one for each layer.

In one example, for each layer l=1, . . . , v, W_{f} basis vectors and W₂ FD indices (columns of W₂) associated with the strongest TRP (or a reference TRP) are shifted (or rotate or remapping FD indices) based on the FD beam index fₗ*, where fₗ* is according to one of the examples disclosed in the present disclosures. The index fₗ* is layer-specific, i.e., one for each layer.

In one example, for each layer l=1, . . . , v, W_{f} basis vectors and W₂ FD indices (columns of W₂) associated with all TRPs are shifted (or rotated or remapping FD indices) based on the FD beam index fₗ*, where fₗ* is according to one of the examples disclosed in the present disclosures.

In one embodiment, a UE is configured to report a (relative) offset in FD with respect to a reference FD index (f*), where the reference FD index is according to one of the examples disclosed in the present disclosures. In one example, the one (relative) offset in FD is defined as δ_{f}=f−f*.

For N_{TRP}>1 TRPs, the one (relative) offset in FD for a TRP r∈{0, 1 . . . , N_{TRP}−1} is defined as δ_{r,f}=fᵣ−fᵣ*, where fᵣ is the FD index (of FD basis vectors or W₂ coefficient matrix), and fᵣ is the reference FD index. When the reference FD index is the same for all TRPs (i.e., there is only one reference FD index), fᵣ=f*, and hence δ_{r,f}=fᵣ−f*.

In one example, the one (relative) offset is reported regardless of the value of N≤N_{TRP}. where N is the number of TRPs selected from N_{TRP} TRPs by the UE for CSI reporting. In one example, the one (relative) offset is reported only when N>1, and not reported when N=1.

In one example, the one (relative) offset is reported for each TRP (including the strongest TRP which includes the strongest coefficient with the reference FD index f*). So, the total number of (relative) offset reported is N.

In one example, the one (relative) offset is reported for each TRP except the strongest TRP (which includes the strongest coefficient with the reference FD index f*). So, the total number of (relative) offset reported is N−1. The (relative) offset for the strongest TRP is fixed to 0.

In one example, the one (relative) offset is reported for each TRP except a reference TRP (which can be configured, fixed, or determined by the UE and reported). So, the total number of (relative) offset reported is N−1. The (relative) offset for the strongest TRP is fixed to 0.

In one example, the one (relative) offset is reported only when N=2, and two (relative) offsets are reported when N∈{3, 4}, and no reported when N=1.

In one example, the one (relative) offset is reported only when N∈{2, 3}, and two (relative) offsets are reported when N=4, and no reported when N=1.

In one example, the (relative) offset is reported from a window of FD indices. In one example, the window is {0, 1, . . . , X−1}. In one example, the window is {Mᵢₙᵢₜ,Mᵢₙᵢₜ+1, . . . , Mᵢₙᵢₜ+X−1} mod N₃. The size (X) or/and the starting index (Mᵢₙᵢₜ) can be fixed or configured (e.g., via RRC) or reported by the UE.

For N≥1 or/and v≥1, the (relative) offset is reported according to at least one of the following examples.

In one example, the (relative) offset is reported in layer common manner, i.e., one (relative) offset is reported that is common across all layers l=1, . . . , v.

In one example, the (relative) offset is reported in layer specific manner, i.e., one (relative) offset is reported for each layer l=1, . . . , v.

In one example, the (relative) offset is reported in TRP common manner, i.e., one (relative) offset is reported that is common across all TRPs.

In one example, the (relative) offset is reported in TRP specific manner, i.e., one (relative) offset is reported for each TRP.

In one example, the (relative) offset is reported in TRP-group specific manner, i.e., one (relative) offset is reported for each TRP group, and the same offset is assumed for each TRP within a TRP group.

In one example, the (relative) offset is reported in layer common manner and TRP common manner, i.e., one (relative) offset is reported that is common across all layers and all TRPs.

In one example, the (relative) offset is reported in layer common manner and TRP specific manner, i.e., for each TRP, one (relative) offset is reported that is common across all layers.

In one example, the (relative) offset is reported in layer common manner and TRP-group specific manner, i.e., for each TRP-group, one (relative) offset is reported that is common across all layers.

In one example, the (relative) offset is reported in layer specific manner and TRP common manner, i.e., for each layer, one (relative) offset is reported that is common across all TRPs.

In one example, the (relative) offset is reported in layer specific manner and TRP specific manner, i.e., for each layer and for each TRP, one (relative) offset is reported.

In one embodiment, a UE is configured to report a (relative) delay offset δ_{τ} with respect to a reference delay τ*, where the reference delay is according to at least one of the following examples.

In one example, the reference delay τ* is 0, hence not reported.

In one example, the reference delay τ* is in an index set of {0, 1, 2, . . . , T_{ref}}, where T_{ref} is fixed or configured via RRC, MAC-CE, or DCI. In one example, T_{ref}=4, 8, 16, 32.

In one example, the reference delay τ* is in [0, τₘₐₓ], where τₘₐₓ is fixed or configured via RRC, MAC-CE, or DCI. In one example, τ* is selected/reported using an x-bit codebook including equidistance points in [0, τₘₐₓ].

In one example, the delay offset δ_{τ} is defined as δ_{τ}=τ−τ*. The delay offset δ_{τ} is according to at least one of the following examples.

In one example, the delay offset δ_{τ} is in an index set of {0, 1, 2, . . . , Tᵣₑₗ}, where Tᵣₑₗ is fixed or configured via RRC, MAC-CE, or DCI. In one example, T_{ref}=Tᵣₑₗ. In one example, Tᵣₑₗ=4, 8,16, 32.

In one example, the delay offset δ_{τ} is in [0, τ_{max,rel}], where τ_{max,rel} is fixed or configured via RRC, MAC-CE, or DCI. In one example, δ_{τ} is selected/reported using an y-bit codebook including equidistance points in [0, τ_{max,rel}]. In one example, τₘₐₓ=τ_{max,rel}.

In one example, delay offset δ_{τ} is represented in a phase form, e.g., [0,2π]. In this case, for example, instead of “delay offset,” it can be referred as “phase offset,” “phase ramp/slope,” “phase offset of delay difference between TRPs,” etc.

In one example, when delay offset δ_{τ} is represented in a phase form, 2ⁿ^{_{bit}}-PSK can be used to quantize [0, 2π] for reporting. For example, n_{bit}=2, 3, 4, . . . and so on.

In one example, n_{bit} can be fixed to 3 or4 or5 . . . .

In another example, n_{bit} can be configured by NW via DCI, MAC-CE, or RRC.

In one example, n_{bit} can be determined by a pre-defined rule. For example, n_{bit}=a+nₚ, where a is fixed (e.g., 0, 1 or2) and nₚ is the number of bits configured for phase component in W₂.

In one example, delay offset δ_{τ} can be reported using a DFT codebook. For example, the phase offset associated with the delay offset can be selected/reported from a DFT codebook with size N₅ and oversampling factor O₅, which can be expressed as

$${z}_{n} = [ 1 {e}^{j \frac{2 π n}{{O}_{5} {N}_{5}}} … {e}^{j \frac{2 π n ( {N}_{5} - 1 )}{{O}_{5} {N}_{5}}} ] ,$$

where n=0, 1, ⋅ ⋅ ⋅ , N₅−1, i.e., the index of n is reported for delay offset δ_{τ}. The payload size for this can be given by ┌log₂ O₅N₅┐ bits.

In one example, N₅ is determined in a pre-defined rule.

In one example, N₅ is fixed.

In one example, N₅ is configured by NW via DCI, MAC-CE, or RRC.

In one example, O₅ is determined in a pre-defined rule.

In one example, O₅ is fixed, e.g., O₅=1 or O₅=2.

In one example, O₅ is configured by NW via DCI, MAC-CE or RRC.

In one example, any combination of the above examples can be applied.

For examples, N₅ is the same number of N₃ (i.e., frequency-domain compression unit). In this case, additional configuration may not be needed.

In another example, N₅ is defined based on N₃ and the density of (associated) CSI-RS (DL RS) resources.

In another example, N₅ is defined based on the number of configured SBs n_{SB} for (associated) CSI-RS (DL RS) resource/reporting/measurement bandwidth.

In another example, N₅ is defined based on the number of configured SBs n_{SB} and CSI-RS density for (associated) CSI-RS (DL RS) resource/reporting/measurement bandwidth.

In another example, N₅ is defined based on the number of configured RBs n_{RB} for (associated) CSI-RS (DL RS) resource/reporting/measurement bandwidth.

In another example, N₅ is defined based on the number of configured RBs n_{RB} and CSI-RS density for (associated) CSI-RS (DL RS) resource/reporting/measurement bandwidth.

In one example, O₅ can be denoted by another notation such as O₃ or other.

In one example, O₅ is the same as O₃.

The delay offset can be called under another name such as FD basis selection offset, phase offset, and so on.

The quantization method (e.g., 2ⁿ^{_{bit}}-PSK or DFT codebook zₙ) described in each example above can be applied for δ_{r,τ} described in examples below.

For N_{TRP}>1 TRPs, the one (relative) delay offset for a TRP r∈{0, 1 . . . , N_{TRP}−1} is defined as or δ_{r,τ}=τᵣ−τᵣ*, where τᵣ is the delay value for TRP r, and τᵣ* it is the reference delay value. When the reference delay value is the same for all TRPs (i.e., there is only one reference delay), τᵣ*=τ* and hence δ_{r,τ}=τᵣ−τ*.

In one example, the one (relative) delay offset is reported regardless of the value of N≤N_{TRP}. where N is the number of TRPs selected from N_{TRP} TRPs by the UE for CSI reporting. In one example, the one (relative) delay offset is reported only when N>1, and not reported when N=1.

In one example, the one (relative) delay offset is reported for each TRP (including the strongest TRP which includes the strongest coefficient). So, the total number of (relative) delay offset reported is N.

In one example, the one (relative) delay offset is reported for each TRP except the strongest TRP (which includes the strongest coefficient). So, the total number of (relative) offset reported is N−1. The (relative) delay offset for the strongest TRP is fixed to 0.

In one example, the one (relative) delay offset is reported for each TRP except a reference TRP (which can be configured, fixed, or determined by the UE and reported). So, the total number of (relative) offset reported is N−1. The (relative) delay offset for the strongest TRP is fixed to 0.

In one example, the one (relative) delay offset is reported only when N=2, and two (relative) delay offsets are reported when N∈{3, 4}, and no reported when N=1.

In one example, the one (relative) delay offset is reported only when N∈{2, 3}, and two (relative) delay offsets are reported when N=4, and no reported when N=1.

For N≥1 or/and v≥1, the (relative) delay offset (above mentioned, e.g., δ_{τ} (δ_{r, τ})) is reported according to at least one of the following examples.

In one example, the (relative) delay offset is reported in layer common manner, i.e., one (relative) delay offset is reported that is common across all layers l=1, . . . , v.

In one example, the (relative) delay offset is reported in layer specific manner, i.e., one (relative) delay offset is reported for each layer l=1, . . . , v.

In one example, the (relative) delay offset is reported in TRP common manner, i.e., one (relative) delay offset is reported that is common across all TRPs.

In one example, the (relative) delay offset is reported in TRP specific manner, i.e., one (relative) delay offset is reported for each TRP.

In one example, the (relative) delay offset is reported in TRP-group specific manner, i.e., one (relative) delay offset is reported for each TRP group, and the same delay offset is assumed for each TRP within a TRP group.

In one example, the (relative) delay offset is reported in layer common manner and TRP common manner, i.e., one (relative) delay offset is reported that is common across all layers and all TRPs.

In one example, the (relative) delay offset is reported in layer common manner and TRP specific manner, i.e., for each TRP, one (relative) delay offset is reported that is common across all layers.

In one example, the (relative) delay offset is reported in layer common manner and TRP-group specific manner, i.e., for each TRP-group, one (relative) delay offset is reported that is common across all layers.

In one example, the (relative) delay offset is reported in layer specific manner and TRP common manner, i.e., for each layer, one (relative) delay offset is reported that is common across all TRPs.

In one example, the (relative) delay offset is reported in layer specific manner and TRP specific manner, i.e., for each layer and for each TRP, one (relative) delay offset is reported.

In one embodiment, a UE is configured to report a (relative) frequency offset δ_{g} with respect to a reference frequency g*, where the reference frequency is according to at least one of the following examples.

In one example, the reference frequency g* is 0, hence not reported.

In one example, the reference frequency g* is in an index set of {0, 1, 2, . . . , F_{ref}}, where F_{ref} is fixed or configured via RRC, MAC-CE, or DCI. In one example, F_{ref}=4, 8,16, 32.

In one example, the reference frequency g* is in [0, gₘₐₓ], where gₘₐₓ is fixed or configured via RRC, MAC-CE, or DCI. In one example, g* is selected/reported using an x-bit codebook including equidistance points in [0, gₘₐₓ].

In one example, the frequency offset δ_{g} is defined as δ_{g}=g−g*. The frequency offset δ_{g} is according to at least one of the following examples.

In one example, the frequency offset δ_{g} is in an index set of {0, 1, 2, . . . , Fᵣₑₗ}, where Fᵣₑₗ is fixed or configured via RRC, MAC-CE, or DCI. In one example, F_{ref}=Fᵣₑₗ. In one example, Fᵣₑₗ=4, 8, 16, 32.

In one example, the frequency offset δ_{g} is in [0, g_{max,rel}], where g_{max,rel} is fixed or configured via RRC, MAC-CE, or DCI. In one example, δ_{g} is selected/reported using an y-bit codebook including equidistance points in [0, g_{max,rel}]. In one example, gₘₐₓ=g_{max,rel}.

For N_{TRP}>1 TRPs, the one (relative) frequency offset for a TRP r∈{0, 1 . . . , N_{TRP}−1} is defined as or δ_{r,g}=gᵣ−g*, where gᵣ is the frequency value for TRP r, and τᵣ* is the reference frequency value. When the reference frequency value is the same for all TRPs (i.e., there is only one reference frequency), gᵣ*=g* and hence δ_{r,g}=gᵣ−g*.

In one example, the one (relative) frequency offset is reported regardless of the value of N≤N_{TRP}. where N is the number of TRPs selected from N_{TRP} TRPs by the UE for CSI reporting. In one example, the one (relative) frequency offset is reported only when N>1, and not reported when N=1.

In one example, the one (relative) frequency offset is reported for each TRP (including the strongest TRP which includes the strongest coefficient). So, the total number of (relative) frequency offset reported is N.

In one example, the one (relative) frequency offset is reported for each TRP except the strongest TRP (which includes the strongest coefficient). So, the total number of (relative) frequency reported is N−1. The (relative) frequency offset for the strongest TRP is fixed to 0.

In one example, the one (relative) frequency offset is reported for each TRP except a reference TRP (which can be configured, fixed, or determined by the UE and reported). So, the total number of (relative) offset reported is N−1. The (relative) delay offset for the strongest TRP is fixed to 0.

In one example, the one (relative) frequency offset is reported only when N=2, and two (relative) frequency offsets are reported when N∈{3, 4}, and no reported when N=1.

In one example, the one (relative) frequency offset is reported only when N∈{2, 3}, and two (relative) frequency offsets are reported when N=4, and no reported when N=1.

For N≥1 or/and v≥1, the (relative) frequency offset is reported according to at least one of the following examples.

In one example, the (relative) frequency offset is reported in layer common manner, i.e., one (relative) frequency offset is reported that is common across all layers l=1, . . . , v.

In one example, the (relative) frequency offset is reported in layer specific manner, i.e., one (relative) frequency offset is reported for each layer l=1, . . . , v.

In one example, the (relative) frequency offset is reported in TRP common manner, i.e., one (relative) frequency offset is reported that is common across all TRPs.

In one example, the (relative) frequency offset is reported in TRP specific manner, i.e., one (relative) frequency offset is reported for each TRP.

In one example, the (relative) frequency offset is reported in TRP-group specific manner, i.e., one (relative) frequency offset is reported for each TRP group, and the same frequency offset is assumed for each TRP within a TRP group.

In one example, the (relative) frequency offset is reported in layer common manner and TRP common manner, i.e., one (relative) frequency offset is reported that is common across all layers and all TRPs.

In one example, the (relative) frequency offset is reported in layer common manner and TRP specific manner, i.e., for each TRP, one (relative) frequency offset is reported that is common across all layers.

In one example, the (relative) frequency offset is reported in layer common manner and TRP-group specific manner, i.e., for each TRP-group, one (relative) frequency offset is reported that is common across all layers.

In one example, the (relative) frequency offset is reported in layer specific manner and TRP common manner, i.e., for each layer, one (relative) frequency offset is reported that is common across all TRPs.

In one example, the (relative) frequency offset is reported in layer specific manner and TRP specific manner, i.e., for each layer and for each TRP, one (relative) frequency offset is reported.

In one embodiment, the reporting of the relative offset, for each of the examples disclosed in the present disclosures, can be turned ON/OFF (or enabled). For instance, the UE can be configured with the information regarding whether the relative offset(s) is/are reported by the UE. If turned ON, the UE reported the relative offset(s); else it does not. The information can be provided via e.g., RRC, MAC-CE, or DCI.

In one embodiment, a UE is configured to report one of the relative offset types in embodiment disclosed in the present disclosures (e.g., offset in FD index, delay offset, and frequency offset).

In one example, the UE can be configured to report the relative offset(s) in FD index f*.

In one example, the UE can be configured to report the relative delay offset(s) with respect to τ*.

In one example, the UE can be configured to report the relative frequency offset(s) with respect to g*.

In one embodiment, a UE is configured to report two of the relative offset types in embodiment disclosed in the present disclosures (e.g., offset in FD index, delay offset, and frequency offset).

In one example, the UE can be configured to report the relative offset(s) in FD index f* and the relative delay offset(s) with respect to τ*.

In one example, the UE can be configured to report the relative offset(s) in FD index f* and the relative frequency offset(s) with respect to g*.

In one example, the UE can be configured to report the relative delay offset(s) with respect to τ* and the relative frequency offset(s) with respect to g*.

In one embodiment, a UE is configured to report all of the relative offset types in embodiment disclosed in the present disclosures (e.g., offset in FD index, delay offset, and frequency offset).

In one example, the UE can be configured to report the relative offset(s) in FD index f* and the relative delay offset(s) with respect to τ* and the relative frequency offset(s) with respect to g*.

In one embodiment, a UE is configured with a CSI reporting based on an mTRP (or D-MIMO or C-JT) codebook, via e.g., higher layer parameter codebookType set to “typeII-r18-cjt” or “typeII-PortSelection-r18-cjt,” where the codebook is one of the following two modes: In one example, one of the two modes is configured, e.g., via a higher layer (e.g., via parameter codebookMode).

In one example of Mode 1, per-TRP/TRP-group SD/FD basis selection and example formulation (N_{TRP}=number of TRPs or TRP groups), the UE reports (i) SD basis vectors for each TRP, (ii) FD basis vectors for each TRP, and (iii) either a joint W2 across all TRPs or one W2 for

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] .$$

In one embodiment of Mode 2, per-TRP/TRP group (port-group or resource) SD basis selection and joint (across N_{TRP} TRPs) FD basis selection, and example formulation (N_{TRP}-number of TRPs or TRP groups), the UE reports (i) SD basis vectors for each TRP, (ii) one common/joint FD basis vectors across all TRPs, and (iii) either a joint W2 across all TRPs or one W2 for each TRP:

$$[ \begin{matrix}{W}_{1 , 1} & 0 & 0 & 0 \\ 0 & ⋱ & 0 & 0 \\ 0 & 0 & {W}_{1 , N} & \\ 0 & 0 & & \end{matrix} ] {\tilde{W}}_{2} {W}_{f}^{H} or [ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ] .$$

In one example, Mode 1 and Mode 2 can be the codebook described in embodiments disclosed in the U.S. patent application Ser. No. 18/310,396.

In one example, the two modes can share similar detailed designs such as parameter combinations, basis selection, TRP (group) selection, reference amplitude, \tilde{W}₂ quantization schemes.

In one example, parameter combinations can be a tuple of parameters such as L, pᵥ, β for regular Type-II CJT codebook or a tuple of parameters such as M, α, β for portselection Type-II CJT codebook.

In one example, a TRP selection can be one component/example described in the U.S. patent application Ser. No. 18/295,219.

In one example, a reference amplitude scheme can be one component/example described in the U.S. patent application Ser. No. 18/305,241.

In one example, a \tilde{W}₂ quantization scheme can include strongest coefficient indicator, upper bound of non-zero coefficients, reference amplitudes, a scheme that each coefficient is decomposed into phase and amplitude, and they are selected respective codebooks, and a codebook subset restriction.

In one embodiment, a UE reports a (relative) offset in FD (e.g., δ_{f}) or/and a (relative) delay offset (e.g., δ_{τ}), and/or a (relative) frequency offset (e.g., δ_{g}) only when Mode 1 codebook is configured (i.e., relative FD offset is not reported when Mode 2 codebook is configured). In one example, a UE reports a (or more) relative offset in FD. In one example, a UE reports a (or more) relative delay offset. In one example, a UE reports a (or more) (relative) frequency offset. In one example, a UE reports any combination of the threes.

In one example, δ_{f} is according to at least one of the examples disclosed in the present disclosure.

In one example, δ_{τ} is according to at least one of the examples disclosed in the present disclosure.

In one example, δ_{g} is according to at least one of the examples disclosed in the present disclosure.

Alternatively, the UE is expected to report the relative FD offset when mode 1 codebook is configured, and the UE is not expected to report the relative FD offset when mode 2 codebook is configured.

In one embodiment, a UE reports a (relative) offset in FD (e.g., δ_{f}), a (relative) delay offset (e.g., δ_{τ}), and/or a (relative) frequency offset (e.g., δ_{g}) only when Mode 2 codebook is configured (i.e., relative FD offset is not reported when Mode 2 codebook is configured). In one example, a UE reports a (or more) relative offset in FD. In one example, a UE reports a (or more) relative delay offset. In one example, a UE reports a (or more) (relative) frequency offset. In one example, a UE reports any combination of the threes.

In one example, of is according to at least one of the examples disclosed in the present disclosure.

In one example, δ_{τ} is according to at least one of the examples disclosed in the present disclosure.

In one example, δ_{g} is according to at least one of the examples disclosed in the present disclosure.

Alternatively, the UE is expected to report the relative FD offset when mode 2 codebook is configured, and the UE is not expected to report the relative FD offset when mode 1 codebook is configured.

In one embodiment, a UE reports a (relative) offset in FD (e.g., δ_{f}), a (relative) delay offset (e.g., δ_{τ}), and/or a (relative) frequency offset (e.g., δ_{g}) both for Mode 1 and Mode 2. In one example, a UE reports a (or more) relative offset in FD. In one example, a UE reports a (or more) relative delay offset. In one example, a UE reports a (or more) (relative) frequency offset. In one example, a UE reports any combination of the threes.

In one example, δ_{f} is according to at least one of the examples disclosed in the present disclosure.

In one example, δ_{τ} is according to at least one of the examples disclosed in the present disclosure.

In one example, δ_{g} is according to at least one of the examples disclosed in the present disclosure.

Alternatively, the UE is expected to report the relative FD offset for both codebook modes.

In one embodiment, a UE is configured (e.g., via higher layer) to report a (relative) offset in FD (e.g., δ_{f}), a (relative) delay offset (e.g., δ_{τ}), and/or a (relative) frequency offset (e.g., δ_{g}) when mTRP codebook (with N>1 TRPs or NZP CSI-RS resources) is configured. In one example, a UE reports a (or more) relative offset in FD. In one example, a UE reports a (or more) relative delay offset. In one example, a UE reports a (or more) (relative) frequency offset. In one example, a UE is configured to report any combination of the threes.

In one example, δ_{f} is according to at least one of the examples disclosed in the present disclosure.

In one example, δ_{τ} is according to at least one of the examples disclosed in the present disclosure.

In one example, δ_{g} is according to at least one of the examples disclosed in the present disclosure.

In one embodiment, a UE is configured (e.g., via higher layer) to report a (relative) offset in FD (e.g., δ_{f}), a (relative) delay offset (e.g., δ_{τ}), and/or a (relative) frequency offset (e.g., δ_{g}) for Mode 1 only or for Mode 2 only or either Mode 1 or Mode 2, using a new higher-layer parameter. For example, a parameter relativeOffsetEnabledModelorMode2 is used to indicate which Mode is configured to report relative offset. In one example, relativeOffsetEnabledModelorMode2 can have two integer values, e.g., 1 and 2. In one example, a UE is configured to report a (or more) relative offset in FD. In one example, a UE is configured to report a (or more) relative delay offset. In one example, a UE is configured to report a (or more) (relative) frequency offset. In one example, a UE is configured to report any combination of the threes.

In one example, δ_{f} is according to at least one of the examples disclosed in the present disclosure.

In one example, δ_{τ} is according to at least one of the examples disclosed in the present disclosure.

In one example, δ_{g} is according to at least one of the examples disclosed in the present disclosure.

In one embodiment, a UE decides whether to report a (relative) offset in FD (e.g., δ_{f}), a (relative) delay offset (e.g., δ_{τ}), and/or a (relative) frequency offset (e.g., δ_{g}) or not via a parameter in UCI part 1. In one example, a UE decides whether to report a (or more) relative offset in FD or not. In one example, a UE decides whether to report a (or more) relative delay offset or not. In one example, a UE decides whether to report a (or more) (relative) frequency offset or not. In one example, a UE decides whether to report any combination of the threes or not.

In one example, δ_{f} is according to at least one of the examples disclosed in the present disclosure.

In one example, δ_{τ} is according to at least one of the examples disclosed in the present disclosure.

In one example, δ_{g} is according to at least one of the examples disclosed in the present disclosure.

In one embodiment, a UE reports UE capability on reporting a (relative) offset in FD (e.g., δ_{f}), a (relative) delay offset (e.g., δ_{τ}), and/or a (relative) frequency offset (e.g., δ_{g}).

In one example, a UE reports its capability on reporting a (relative) offset in FD as UE capability. If NW receives this UE capability, the NW needs to follow the UE capability and can configure based on the UE capability.

In one example, a UE reports its capability on reporting a (relative) delay offset as UE capability. If NW receives this UE capability, the NW needs to follow the UE capability and can configure based on the UE capability.

In one example, a UE reports its capability on reporting a (relative) frequency offset as UE capability. If NW receives this UE capability, the NW needs to follow the UE capability and can configure based on the UE capability.

In one example, a UE reports its capability on reporting any combination of the above three offset components as UE capability. If NW receives this UE capability, the NW needs to follow the UE capability and can configure based on the UE capability.

In one embodiment, a UE reports UE capability on possible mode operations among the two modes.

In one example, a UE reports Mode 1-only as UE capability. If NW receives this UE capability, the NW can configure Mode 1 only to the UE.

In one example, a UE reports Mode 2-only as UE capability. If NW receives this UE capability, the NW can configure Mode 2 only to the UE.

In one example, a UE reports Modes 1 and 2 as UE capability. If NW receives this UE capability, the NW can configure either Mode 1 or Mode 2 to the UE.

In one embodiment, the two modes support a same set of rank candidates [symbol] , i.e., any rank in [symbol] can be configured for either mode 1 or mode 2.

In one example, [symbol] ={1, 2}.

In one example, [symbol] ={1, 2, 3}.

In another example [symbol] =?{1, 2, 3, 4}.

In one embodiment, each mode i support a different set of rank candidates [symbol] ᵢ.

In one example, low ranks, e.g., [symbol] ₁={1, 2}, can be configured for Mode 1, and high ranks, e.g., [symbol] ₂={3, 4}, can be configured for Mode 2.

In one example, low ranks, e.g., [symbol] ₂={1, 2}, are for Mode 2, and high ranks, e.g., [symbol] ₁={3, 4}, are for Mode 1.

In one example, low ranks, e.g., [symbol] ₁={1, 2}, are for Mode 1, and any rank, e.g., [symbol] ₂={1, 2, 3, 4}, is for Mode 2.

In one example, low ranks, e.g., [symbol] ₂={1, 2}, are for Mode 2, and any rank, e.g., [symbol] ₁={1, 2, 3, 4}, is for Mode 2.

In one embodiment, there are common codebook parameters for Mode 1 and Mode 2, and mode-specific codebook parameters.

In one example, L (or Lₛᵤₘ or Lᵣ) value(s) is a common parameter for both Mode 1 and Mode 2, i.e., same value(s) can be configured for both Mode 1 and Mode 2.

In one example, L (or Lₛᵤₘ or Lᵣ) value(s) is a mode-specific parameter, i.e., independent L value(s) can be configured for each mode.

In one example Mᵥ (or M_{v,sum}=Σᵣ₌₁^{N}^{_{TRP}}M_{v,r} or M_{v,r}) value(s) is a common parameter for both Mode 1 and Mode 2, i.e., same value(s) of Mᵥ (or M_{v,sum}=Σᵣ₌₁^{N}^{_{TRP}}M_{v,r} or M_{v,r}) can be configured for both Mode 1 and Mode 2.

In one example, Mᵥ (or M_{v,sum} or M_{v,r}) value(s) is a mode-specific parameter, i.e., independent Mᵥ (or M_{v,sum} or M_{v,r}) value(s) can be configured for each mode.

In one embodiment, a UE is configured with a CSI report for N≥1 TRPs (where TRP corresponds to a NZP CSI-RS resource or a subset of CSI-RS antenna ports within a NZP CSI-RS resource) based on a mTRP CJT codebook, where the codebook is configured according to (at least) one of the examples disclosed in the present disclosure.

In one embodiment, FD basis vectors and relative offsets in FD for N≥1 TRPs are reported as part of CSI report according to (at least) one of the following examples.

In one example (Alt 1), a relative offset(s) in FD (e.g., δ_{f} or δ_{f,r}) for each of N TRPs (or each of N−1 TRPs, e.g., excluding a reference TRP) is reported and a common set of Mᵥ FD basis vectors for all TRP are reported, as part of CSI report. So, the UE reports {δ_{f,r}: r=1, . . . , N−1} (or {δ_{f,r}: r=1, . . . , N}) and a set of Mᵥ FD basis vectors via respective indicators.

In one example, a reference TRP can be configured by RRC, MAC-CE, or DCI.

In one example, a reference TRP can be determined by UE and reported. In one example, a reference TRP can be a strongest TRP.

In one example, a reference TRP can be fixed using a pre-defined rule. (e.g., the TRP that includes the SCI)

In one example (Alt 2), a relative offset(s) in FD (e.g., δ_{f} or δ_{f,r}) for each of N TRPs (or each of N−1 TRPs, e.g., excluding a reference TRP) is reported and Mᵥ (or M_{v,r}) FD basis vectors for each TRP r are reported, as part of CSI report. So, the UE reports {δ_{f,r}: r=1, . . . , N−1} (or {δ_{f,r}: r=1, . . . , N}) and N sets of M_{v,r} FD basis vectors via respective indicators.

In one example, a reference TRP can be configured by RRC, MAC-CE, or DCI.

In one example, a reference TRP can be determined by UE and reported. In one example, a reference TRP can be a strongest TRP.

In one example, a reference TRP can be fixed using a pre-defined rule. (e.g., the TRP that includes the SCI)

In one example (Alt 3), a common set of Mᵥ FD basis vectors for all TRPs (across TRPs) are reported, as part of CSI report, and there is no reporting of relative offsets.

In one example (Alt 4), Mᵥ (or M_{v,r}) FD basis vectors for each TRP r are reported, as part of CSI report, and there is no reporting of relative offsets.

In one example, Alt 1 and Alt 2 are associated with Mode 1 and Mode 2, respectively, where Mode 1 and Mode 2 are described in embodiment disclosed in the present disclosure, Alt1 is used for FD basis vector reporting when Mode 1 is configured and Alt2 is used for FD basis vector reporting when Mode 2 is configured.

Any example of relative offset(s) disclosed in the present disclosure can be an example for the relative offsets described in this embodiment.

In one example, Alt 1 and Alt 3 are associated with Mode 1 and Mode 2, respectively, where Mode 1 and Mode 2 are described in embodiments disclosed in the present disclosure, Alt1 is used for FD basis vector reporting when Mode 1 is configured and Alt3 is used for FD basis vector reporting when Mode 2 is configured.

In one example, Alt 1 and Alt 4 are associated with Mode 1 and Mode 2, respectively, where the Mode 1 and Mode 2 are described in embodiments disclosed in the present disclosure, Alt1 is used for FD basis vector reporting when Mode 1 is configured and Alt4 is used for FD basis vector reporting when Mode 2 is configured.

In one example, Alt 2 and Alt 3 are associated with Mode 1 and Mode 2, respectively, where the Mode 1 and Mode 2 are described in embodiment disclosed in the present disclosure, i.e., Alt2 is used for FD basis vector reporting when Mode 1 is configured and Alt3 is used for FD basis vector reporting when Mode 2 is configured.

In one example, Alt 2 and Alt 4 are associated with Mode 1 and Mode 2, respectively, where the Mode 1 and Mode 2 are described in embodiments disclosed in the present disclosure, i.e., Alt2 is used for FD basis vector reporting when Mode 1 is configured and Alt4 is used for FD basis vector reporting when Mode 2 is configured.

In one example, Alt 3 and Alt 4 are associated with Mode 1 and Mode 2, respectively, where the Mode 1 and Mode 2 are described in embodiments disclosed in the present disclosure, i.e., Alt3 is used for FD basis vector reporting when Mode 1 is configured and Alt4 is used for FD basis vector reporting when Mode 2 is configured.

In one example, Alt 1 and Alt 2 are associated with Mode 2 and Mode 1, respectively, where the Mode 1 and Mode 2 are described in embodiments disclosed in the present disclosure, Alt1 is used for FD basis vector reporting when Mode 2 is configured and Alt2 is used for FD basis vector reporting when Mode 1 is configured.

In one example, Alt 1 and Alt 3 are associated with Mode 2 and Mode 1, respectively, where the Mode 1 and Mode 2 are described in embodiments disclosed in the present disclosure, i.e., Alt1 is used for FD basis vector reporting when Mode 2 is configured and Alt3 is used for FD basis vector reporting when Mode 1 is configured.

In one example, Alt 1 and Alt 4 are associated with Mode 2 and Mode 1, respectively, where the Mode 1 and Mode 2 are described in embodiments disclosed in the present disclosure, i.e., Alt1 is used for FD basis vector reporting when Mode 2 is configured and Alt4 is used for FD basis vector reporting when Mode 1 is configured.

In one example, Alt 2 and Alt 3 are associated with Mode 2 and Mode 1, respectively, where the Mode 1 and Mode 2 are described in embodiments disclosed in the present disclosure, i.e., Alt2 is used for FD basis vector reporting when Mode 2 is configured and Alt3 is used for FD basis vector reporting when Mode 1 is configured.

In one example, Alt 2 and Alt 4 are associated with Mode 2 and Mode 1, respectively, where the Mode 1 and Mode 2 are described in embodiments disclosed in the present disclosure, i.e., Alt2 is used for FD basis vector reporting when Mode 2 is configured and Alt4 is used for FD basis vector reporting when Mode 1 is configured.

In one example, Alt 3 and Alt 4 are associated with Mode 2 and Mode 1, respectively, where the Mode 1 and Mode 2 are described in embodiments disclosed in the present disclosure, i.e., Alt3 is used for FD basis vector reporting when Mode 2 is configured and Alt4 is used for FD basis vector reporting when Mode 1 is configured.

In one embodiment, one of the examples (or some examples) in embodiments disclosed in the present disclosure can be configured by RRC, MAC-CE, or DCI signaling.

In one example, one of the examples disclosed in the present disclosure can be configured by RRC, MAC-CE or DCI signaling.

In one example, one of the examples disclosed in the present disclosure can be configured by RRC, MAC-CE or DCI signaling.

In one example, one of the examples disclosed in the present disclosure can be configured by RRC, MAC-CE or DCI signaling.

In one example, one of any combination of the examples disclosed in the present disclosure can be configured by RRC, MAC-CE or DCI signaling.

In one embodiment, Mode 1 can be associated with a fixed Alt x from Alt1-Alt4 in embodiments disclosed in the present disclosure, and one of the Alts in embodiments disclosed in the present disclosure can be configured for Mode 2 via RRC, MAC-CE or DCI signaling.

In one example, Mode 1 can be associated with fixed Alt 1 and one of the Alts (from Alt1-Alt4) can be configured for Mode 2 via RRC, MAC-CE or DCI signaling.

In one example, Mode 1 can be associated with fixed Alt 2 and one of the Alts (from Alt1-Alt4) can be configured for Mode 2 via RRC, MAC-CE or DCI signaling.

In one example, Mode 1 can be associated with fixed Alt 3 and one of the Alts (from Alt1-Alt4) can be configured for Mode 2 via RRC, MAC-CE or DCI signaling.

In one example, Mode 1 can be associated with fixed Alt 4 and one of the Alts (from Alt1-Alt4) can be configured for Mode 2 via RRC, MAC-CE or DCI signaling.

In one embodiment, Mode 2 can be associated with a fixed Alt x from Alt1-Alt4 in embodiments disclosed in the present disclosure and one of the Alts in embodiments disclosed in the present disclosure can be configured for Mode 1 via RRC, MAC-CE or DCI signaling.

In one example, Mode 2 can be associated with fixed Alt 1 and one of the Alts (from Alt1-Alt4) can be configured for Mode 1 via RRC, MAC-CE or DCI signaling.

In one example, Mode 2 can be associated with fixed Alt 2 and one of the Alts (from Alt1-Alt4) can be configured for Mode 1 via RRC, MAC-CE or DCI signaling.

In one example, Mode 2 can be associated with fixed Alt 3 and one of the Alts (from Alt1-Alt4) can be configured for Mode 1 via RRC, MAC-CE or DCI signaling.

In one example, Mode 2 can be associated with fixed Alt 4 and one of the Alts (from Alt1-Alt4) can be configured for Mode 1 via RRC, MAC-CE or DCI signaling.

In one embodiment, one of the Alts in embodiments disclosed in the present disclosure can be configured for either Mode 1 or Mode 2 via RRC, MAC-CE or DCI signaling.

In one example, one of the Alts (from Alt1-Alt4) can be configured for Mode 1 via RRC, MAC-CE, or DCI signaling.

In one example, one of the Alts (from Alt1-Alt4) can be configured for Mode 2 via RRC, MAC-CE, or DCI signaling.

In one embodiment, one of the Alts in embodiments disclosed in the present disclosure can be fixed for either Mode 1 or Mode 2.

In one example, one of the Alts (from Alt1-Alt4) can be fixed for Mode 1.

In one example, one of the Alts (from Alt1-Alt4) can be fixed for Mode 2.

In one embodiment, a UE is configured to report relative offsets for N_{TRP} (≥1) CSI-RS resources (or CSI-RS port groups, or TRPs, etc.), where the relative offsets are one of the relative offsets described in embodiments disclosed in the present disclosure. The CSI-RS resources and TRPs may be used interchangeably.

In one embodiment, a UE is configured to report relative offsets for a subset of N_{TRP} TRPs (or CSI-RS resources or CSI-RS port groups). In this case, the UE reports relative offsets only for the subset of N_{TRP} TRPs.

In one example, the subset of N_{TRP} TRPs (i.e., which TRPs for the relative offsets can be configured) can be configured via higher-layer signaling (e.g., RRC), or MAC-CE, or DCI. In one example, a bit-map indicator can be used to configure a subset of N_{TRP} TRPs.

In one example, a UE reports relative offsets for each of the subset of N_{TRP} TRPs.

In one example, a UE reports relative offsets for each of the subset of N_{TRP} TRPs, except a reference TRP. In one example, a reference TRP can be configured, fixed, determined by the UE and reported. In another example, the reference TRP can be a (the) strongest TRP.

In one embodiment, a UE (dynamically) decides which TRPs' relative offsets to be reported (being reported). The (dynamic) selection of TRPs for reporting corresponding relative offsets can be indicated via CSI Part 1.

In one example, the N_{TRP}-bit bitmap indicator for the TRP selection (the indicator for the dynamic TRP selection) can also be used for the TRP selection purpose of relative offsets, and the indicator is reported via CSI part 1.

In one example, a separate N_{TRP}-bit bitmap indicator for TRP selection for purpose of relative offsets can be used and this is reported via CSI part 1.

In one example, a separate combinatorial indicator for TRP selection for purpose of relative offsets can be used and this is reported via CSI part 1.

In another example, a N-bit bitmap indicator for TRP selection for purpose of relative offsets can be used and this is reported via CSI part 2, where N≤N_{TRP}. In one example, N is the selected number of TRPs in CSI part 1, inferred from the N_{TRP}-bit bitmap indicator.

In another example, a combinatorial indicator for TRP selection for purpose of relative offsets can be used and this is reported via CSI part 2.

In one embodiment, a UE identifies a need for UE-initiated/triggered reporting on relative offsets for a subset of N_{TRP} TRPs.

In one example, the UE requests to the NW to send reference signal resources (CSI-RS).

In one example, the UE initiates CSI reporting or relative offset reporting.

In one example, the UE performs UE-initiated/UE-triggered reporting or CSI reporting for relative offset reporting.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For TDD systems, the CSI can be acquired using the SRS transmission relying on the channel reciprocity. For FDD systems, on the other hand, it can be acquired using the CSI-RS transmission from eNB (or gNB), and CSI acquisition and feedback from UE. In legacy FDD systems, the CSI feedback framework is “implicit” in the form of CQI/PMI/RI (also CRI and LI) derived from a codebook assuming SU transmission from eNB (or gNB).

In 5G or NR systems, the above-mentioned “implicit” CSI reporting paradigm from LTE is also supported and referred to as Type I CSI reporting. In addition, a high-resolution CSI reporting, referred to as Type II CSI reporting, is also supported in Release 15 specification to provide more accurate CSI information to gNB for use cases such as high-order MU-MIMO. However, the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE.

However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of

$$\frac{{P}_{CSI - RS}}{2}$$

CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

In Rel. 17 NR, CSI reporting has been enhanced to support the following examples.

In one example of enhanced Type II port selection codebook, it has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD or/and M ports are selected in FD. The CSI-RS ports in this case are beamformed in SD (assuming UL-DL channel reciprocity in angular domain) or/and FD (assuming UL-DL channel reciprocity in delay/frequency domain), and the corresponding SD or/and FD beamforming information can be obtained at the gNB based on UL channel estimated using SRS measurements. In Rel. 17, such a codebook is supported (which is referred to as Rel. 17 further enhanced Type II port selection codebook in 3GPP standard specification).

In one example of NCJT CSI reporting, when the UE can communicate with multiple TRPs that are distributed at different locations in space (e.g., within a cell), the CSI reporting can correspond to a single TRP hypothesis (i.e., CSI reporting for one of the multiple TRPs), or multi-TRP hypothesis (i.e., CSI reporting for at least two of the multiple TRPs). The CSI reporting for both single TRP and multi-TRP hypotheses are supported in Rel. 17. However, the multi-TRP CSI reporting assume a non-coherent joint transmission (NCJT), i.e., a layer (and precoder) of the transmission is restricted to be transmitted from only one TRP.

In Rel. 18 MIMO WID includes the following objectives on CSI enhancements: (1) study, and if justified, specify enhancements of CSI acquisition for Coherent-JT targeting FR1 and up to 4 TRPs, assuming ideal backhaul and synchronization as well as the same number of antenna ports across TRPs, as follows: (i) Rel-16/17 Type-II codebook refinement for CJT mTRP targeting FDD and its associated CSI reporting, taking into account throughput-overhead trade-off; and (2) study, and if justified, specify CSI reporting enhancement for high/medium UE velocities by exploiting time-domain correlation/Doppler-domain information to assist DL precoding, targeting FR1, as follows: (i) Rel-16/17 Type-II codebook refinement, without modification to the spatial and frequency domain basis and (ii) a UE reporting of time-domain channel properties measured via CSI-RS for tracking.

The first objective extends the Rel.17 NCJT CSI to coherent JT (CJT), and the second extends FD compression in the Rel.16/17 codebook to include time (Doppler) domain compression. Both extensions are based on the same legacy codebook, i.e., Rel. 16/17 codebook. In the present disclosure, a unified codebook design considering both extensions has been provided.

The main use case or scenario of interest for CJT/DMIMO is as follows. Although NR supports up to 32 CSI-RS antenna ports, for a cellular system operating in a sub-1 GHz frequency range (e.g., less than 1 GHz), supporting large number of CSI-RS antenna ports (e.g., 32) at one site or remote radio head (RRH) or TRP is challenging due to larger antenna form factors at these frequencies (when compared with a system operating at a higher frequency such as 2 GHz or4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) cannot be achieved. One way to operate a sub-1 GHz system with large number of CSI-RS antenna ports is based on distributing antenna ports at multiple sites (or RRHs).

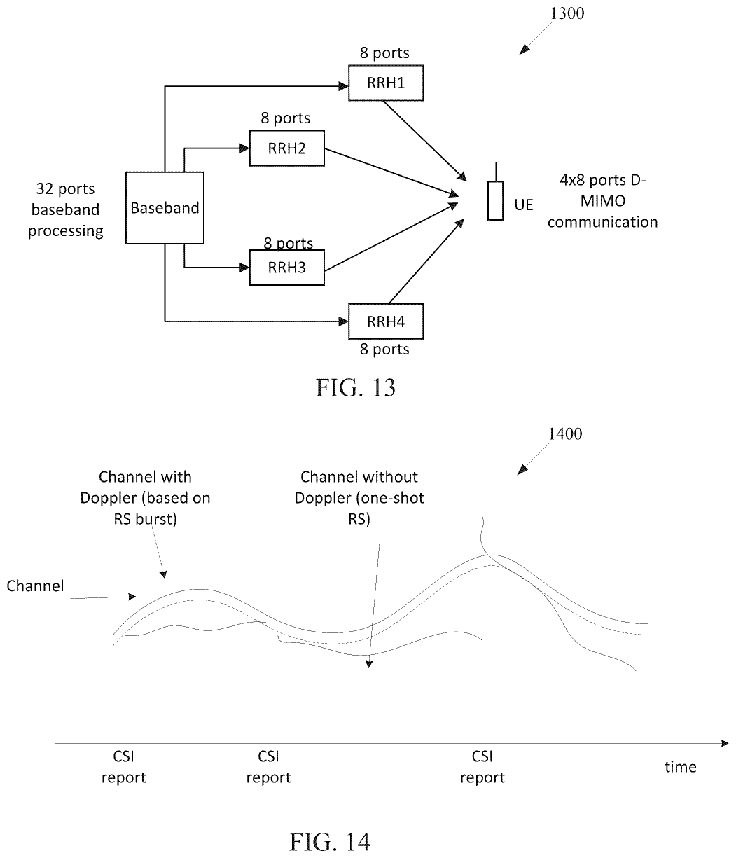

The multiple sites or RRHs can still be connected to a single (common) baseband unit, hence the signal transmitted/received via multiple distributed RRHs can still be processed at a centralized location. For example, 32 CSI-RS ports can be distributed across 4 RRHs, each with 8 antenna ports. Such a MIMO system can be referred to as a distributed MIMO (D-MIMO) or a CJT system. An example is illustrated in FIG. 13.

FIG. 13 illustrates an example of D-MIMO structure 1300 according to embodiments of the present disclosure. An embodiment of the D-MIMO structure 1300 shown in FIG. 13 are for illustration only.

The multiple RRHs in a D-MIMO setup can be utilized for spatial multiplexing gain (based on CSI reporting). Since RRHs are geographically separated, they (RRHs) tend to contribute differently in a CSI reporting. This motivates a dynamic RRH selection followed by CSI reporting condition on the RRH selection. This disclosure provides example embodiments on how channel and interference signal can be measure under different RRH selection hypotheses. Additionally, the signaling details of such a CSI reporting and CSI-RS measurement are also provided.

The main use case or scenario of interest for time-/Doppler-domain compression is moderate to high mobility scenarios. When the UE speed is in a moderate or high-speed regime, the performance of the Rel. 15/16/17 codebooks starts to deteriorate quickly due to fast channel variations (which in turn is due to UE mobility that contributes to the Doppler component of the channel), and a one-shot nature of CSI-RS measurement and CSI reporting in Rel. 15/16/17. This limits the usefulness of Rel. 15/16/17 codebooks to low mobility or static UEs only. For moderate or high mobility scenarios, an enhancement in CSI-RS measurement and CSI reporting is needed, which is based on the Doppler components of the channel. As described in 3GPP standard specification, the Doppler components of the channel remain almost constant over a large time duration, referred to as channel stationarity time, which is significantly larger than the channel coherence time. Note that the current (Rel. 15/16/17) CSI reporting is based on the channel coherence time, which is not suitable when the channel has significant Doppler components.

The Doppler components of the channel can be calculated based on measuring a reference signal (RS) burst, where the RS can be CSI-RS or SRS. When RS is CSI-RS, the UE measures a CSI-RS burst, and use it to obtain Doppler components of the DL channel, and when RS is SRS, the gNB measures an SRS burst, and use it to obtain Doppler components of the UL channel. The obtained Doppler components can be reported by the UE using a codebook (as part of a CS report). Or the gNB can use the obtained Doppler components of the UL channel to beamform CSI-RS for CSI reporting by the UE. An illustration of channel measurement with and without Doppler components is shown in FIG. 14. When the channel is measured with the Doppler components (e.g., based on an RS burst), the measured channel can remain close to the actual varying channel. On the other hand, when the channel is measured without the Doppler components (e.g., based on a one-shot RS), the measured channel can be far from the actual varying channel.

FIG. 14 illustrates an example of channel measurement 1400 according to embodiments of the present disclosure. An embodiment of the channel measurement 1400 shown in FIG. 14 are for illustration only.

The present disclosure relates to CSI acquisition at gNB. In particular, it relates to the CSI reporting based on a high-resolution (or Type II) codebook comprising spatial-, frequency- or/and time- (Doppler-) domain components for a distributed antenna structure (DMIMO). The 3 most novel aspects are as follows: (1) a joint or separate indicator of FD offset value and oversampled value for FD offset value per TRP or all TRPs, or per-layer, all layers; (2) details of window(s): initial index (Minit) and length W; (3) signaling: configured window, reported window; and (4) for multiple windows: a reference window+a relative offset per TRP with respect to the reference window.

The present disclosure is applicable to both space-frequency (equation 5) and space-time (equation 5A) frameworks.

In the present disclosure, the abovementioned framework for CSI reporting based on space-frequency compression (equation 5) or space-time compression (equation 5A) frameworks can be extended in two directions: (1) time or Doppler domain compression (e.g., for moderate to high mobility UEs) and (2) joint transmission across multiple RRHs/TRP (e.g., for a DMIMO or multiple TRP systems).

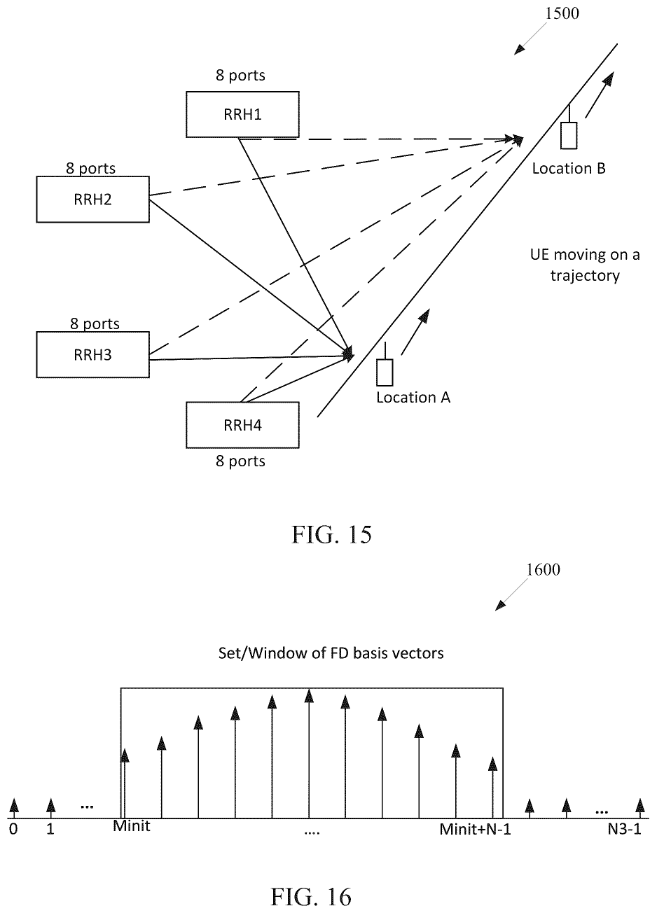

FIG. 15 illustrates an example of UE moving on a linear trajectory in a DMIMO system 1500 according to embodiments of the present disclosure. An embodiment of the UE moving on a linear trajectory in a DMIMO system 1500 shown in FIG. 15 are for illustration only.

An illustration of a UE moving on a trajectory located in a DMIMO system is shown in FIG. 15. While the UE moves from a location A to another location B at high speed (e.g., 60 kmph), the UE measures the channel and the interference (e.g., via NZP CSI-RS resources and CSI-IM resources, respectively), uses them to determine/report CSI considering CJT from multiple RRHs. The reported CSI can be based on a codebook, which includes components considering both multiple RRHs, and time-/Doppler-domain channel compression.

In one embodiment I, a UE is configured with a CSI report for Z≥1 TRPs (across or associated with Z NZP CSI-RS resources) based on a codebook that includes components, SD and FD bases (for compression), similar to Rel.16 enhanced Type II codebook (as shown in 3GPP standard specification 38.214) or rel. 17 further enhanced Type II port selection codebook (as shown in 3GPP standard specification 38.214). The value of Z can be equal to N_{TRP}, the number of TRPs or NZP CSI-RS resources configured for the CSI report. Or the value of Z≤N_{TRP}, where Z can be reported by the UE (e.g., via the CSI report) or signaled to the UE (e.g., via MACE CE or/and DCI). In one example, N_{TRP} ∈{1, 2, 3, 4}. At least one of the following embodiments is used/configured. In this disclosure, notation N can be used for notation Z, i.e., Z and N are used interchangeably.

In one embodiment, the UE is configured to report a CSI for N>1 TRPs/RRHs (where TRP corresponds to a NZP CSI-RS resource or a subset of CSI-RS antenna ports within a NZP CSI-RS resource), the CSI determined based on a codebook comprising components: (A) two separate basis matrices W₁, W_{f} for SD and FD compression, respectively, and (B) coefficients \tilde{W}₂. In one example, the codebook can be configured via one higher layer parameter codebookType set to “typeII-cjt-mode2-r18,” or via two higher layer parameters codebookType set to “typeII-cjt-r18” and codebookMode set to “Mode2.”

In particular, the precoder for layer l is given by:

$${W}_{l} = {A}_{l} {C}_{l} {B}_{l}^{H} = \frac{1}{γ} {W}_{1} {\tilde{W}}_{2} {W}_{f}^{H}$$

where: (1) Wₗ is a P_{CSIRS}×N₃ matrix whose columns are precoding vectors for N₃ FD units, (2) W₁ is a block diagonal matrix

$$[ \begin{matrix}{W}_{1 , 1} & 0 & 0 & 0 \\ 0 & ⋱ & 0 & 0 \\ 0 & 0 & {W}_{1 , 2 N} & \\ 0 & 0 & & \end{matrix} ]$$

comprising 2N blocks, where (2(r−1)+1,2r)-th blocks are associated with two antenna polarizations (two halves or groups of CSI-RS antenna ports) of TRP r and each of two blocks is a

$$\frac{{P}_{CSIRS , r}}{2} \times {L}_{r} SD$$

basis or port selection matrix (similar to Rel. 16 enhanced Type II codebook or Rel. 17 enhanced Type II codebook) or (3)\tilde{W}₂ is a 2L×Mᵥ coefficients matrix, where L=Σᵣ₌₁^{N}Lᵣ, and (4) W_{f} is a N₃×Mᵥ basis matrix for FD basis matrix (similar to Rel. 16 enhanced Type II codebook). The columns of W_{f} comprises vectors g_{f,l}=[y_{0,l}^{(f)}, y_{1,l}^{(f)} ⋅ ⋅ ⋅ y_{N}_{₃}_{-1,l}^{(f)}], and (5) γ is a normalization factor.

In one example, for each r=1, . . . , N,

$$[ \begin{matrix}{W}_{1 , 2 ( r - 1 ) + 1} & 0 \\ 0 & {W}_{1 , 2 r}\end{matrix} ] = [ \begin{matrix}{B}_{r} & 0 \\ 0 & {B}_{r}\end{matrix} ]$$

is a P_{CSIRS,r}×²Lᵣ SD basis matrix, where the Lᵣ SD basis vectors comprising columns of Bᵣ are determined the same way as in Rel. 15/16 Type II codebooks (as shown in 3GPP standard specification).

In one example, the Mᵥ FD basis vectors, g_{f,l}=[y_{0,l}^{(f)}, y_{1,l}^{(f)} ⋅ ⋅ ⋅ y_{N}_{₃}_{-1,l}^{(f)}]^{T}, f=0, 1, . . . , Mᵥ−1, are identified by n_{3,l} (l=1, . . . , v) where n_{3,l}=[n_{3,l}⁽⁰⁾, . . . , n_{3,l}^{(M}^{ᵥ}⁻¹⁾] and n_{3,l}^{(f)} ∈{0, 1, . . . , N₃−1}.

The vector y_{t,l}=[y_{t,l}⁽⁰⁾, y_{t,l}⁽¹⁾ . . . y_{t,l}^{(M}^{ᵥ}⁻¹⁾] comprises entries of FD basis vectors with FD index t={0, 1, . . . , N₃−1}, which is an (FD) index associated with the precoding matrix.

In one example, the FD basis vectors are orthogonal DFT vectors, and

$${y}_{t , l}^{( f )} = {e}^{j \frac{2 π {tn}_{3 , l}^{( f )}}{{N}_{3}}} .$$

In one example, the FD basis vectors are oversampled (or rotated) orthogonal DFT vectors with the oversampling (rotation) factor O₃, and

$${y}_{t , l}^{( f )} = {e}^{j \frac{2 π {tn}_{3 , l}^{( f )}}{{O}_{3} {N}_{3}}} ,$$

and the Mᵥ FD basis vectors are also identified by the rotation index q_{3,l}∈{0, 1, . . . , O₃−1}. In one example, O₃ is fixed (e.g., 1 or4), or configured (e.g., via RRC), or reported by the UE. In one example, the rotation factor is layer-common (one value for all layers), i.e., q_{3,l}=q₃.

In one example, each coefficient x_{l,r,i,f} corresponding to row i, column f of the W_{2,l,r} for layer l and TRP (or CSI-RS resource) r can be expressed as

$${x}_{l , r , i , f} = {p}_{l , r , ⌊ \frac{i}{L} ⌋}^{( 1 )} {p}_{l , r , i , f}^{( 2 )} {φ}_{l , r , i , f}$$

similar to Rel. 16 enhanced Type II codebook (as shown in 3GPP standard specification).

In one embodiment, the UE is configured to report a CSI for N>1 TRPs/RRHs (where TRP corresponds to a NZP CSI-RS resource or a subset of CSI-RS antenna ports within a NZP CSI-RS resource), the CSI determined based on a codebook comprising components: (A) two separate basis matrices W₁, W_{f} for SD and FD compression, respectively, and (B) coefficients \tilde{W}₂. In one example, the codebook can be configured via one higher layer parameter codebookType set to “typeII-cjt-model-r18,” or via two higher layer parameters codebookType set to “typeII-cjt-r18” and codebookMode set to “Model.”

In particular, the precoder for layer l is given by

$${W}_{l} = {A}_{l} {C}_{l} {B}_{l}^{H} = \frac{1}{γ} {W}_{1} {\tilde{W}}_{2} {W}_{f}^{H} = \frac{1}{γ} [ \begin{matrix}{W}_{1 , 1} & {\tilde{W}}_{2 , 1} & {W}_{f , 1}^{H} \\ & ⋮ & \\ {W}_{1 , N} & {\tilde{W}}_{2 , N} & {W}_{f , N}^{H}\end{matrix} ]$$

where: (1) Wₗ is a P_{CSIRS}×N₃ matrix whose columns are precoding vectors for N₃ FD units, (2) W_{l,r} is a block diagonal matrix

$$[ \begin{matrix}{B}_{r} & 0 \\ 0 & {B}_{r}\end{matrix} ]$$

comprising 2 blocks that are associated with two antenna polarizations (two halves or groups of CSI-RS antenna ports) of TRP r and each of two blocks is a

$$\frac{{P}_{CSIRS , r}}{2} \times {L}_{r} SD$$

basis or port selection matrix (similar to Rel. 16 enhanced Type II codebook or Rel. 17 enhanced Type II codebook), or (3) \tilde{W}_{2,r} is a 2Lᵣ×M_{v,r} coefficients matrix, and (4) W_{f,r} is a N₃×M_{v,r} basis matrix for FD basis matrix (similar to Rel. 16 enhanced Type II codebook). The columns of W_{f,r} comprises vectors g_{r,f,l}=[y_{0,l}^{(r,f)} y_{1,l}^{(r,f)} ⋅ ⋅ ⋅ y_{N}_{₃}_{-1,l}^{(rf)}] or g_{f}_{ᵣ}_{,l}=[y_{0,l}^{(fr)} y_{1,l}^{(fr)} ⋅ ⋅ ⋅ y_{N}_{₃}_{-1,l}^{(fr)}] and (5) γ is a normalization factor.

In one example, for each

$$r = 1 , … , N , {W}_{1 , r} = [ \begin{matrix}{B}_{r} & 0 \\ 0 & {B}_{r}\end{matrix} ]$$

is a P_{CSIRS,r}×2Lᵣ SD basis matrix, where the Lᵣ SD basis vectors comprising columns of Bᵣ are determined the same way as in Rel. 15/16 Type II codebooks (as shown in 3GPP standard specification)

In one example, the M_{v,r} FD basis vectors, g_{r,f,l}=[y_{0,l}^{(r,f)} y_{1,l}^{(rf)} ⋅ ⋅ ⋅ y_{N}_{₃}_{^{−1,l}}^{(r,f)}]^{T}, f=0, 1, . . . , M_{v,r}−1, are identified by n_{3,l,r} (l=1, . . . , v) where n_{3,l,r}=[n_{3,l,r}⁽⁰⁾, . . . , n_{3,l,r}^{(M}^{_{v,r}}⁻¹⁾] and n_{3,l,r}^{(f)}∈{0, 1, . . . , N₃−1}.

The vector y_{t,l,r}=[y_{t,l,r}⁽⁰⁾ y_{t,l,r}⁽¹⁾ ⋅ ⋅ ⋅ y_{t,l,r}^{(M}^{_{v,r}}⁻¹⁾] comprises entries of FD basis vectors with FD index t={0, 1, . . . , N₃−1}, which is an (FD) index associated with the precoding matrix.

In one example, the FD basis vectors are orthogonal DFT vectors, and

$${y}_{t , l , r}^{( f )} = {e}^{j \frac{2 π {tn}_{3 , l , r}^{( f )}}{{N}_{3}}} .$$

In one example, the FD basis vectors are oversampled (or rotated) orthogonal DFT vectors with the oversampling (rotation) factor O₃, and

$${y}_{t , l , r}^{( f )} = {e}^{j \frac{2 π {tn}_{3 , l , r}^{( f )}}{{O}_{3} {N}_{3}}} ,$$

and the M_{v,r} FD basis vectors are also identified by the rotation index q_{3,l,r}∈{0, 1, . . . , O₃−1}. In one example, O₃ is fixed (e.g., 1 or4), or configured (e.g., via RRC), or reported by the UE. In one example, the rotation factor is layer-common (one value for all layers), i.e., q_{3,l,r}=q_{3,r}.

In one example, corresponding to row i, column f of the W_{2,l,r} for layer l and TRP (or CSI-RS resource)

$$r {x}_{l , r , i , f} = {p}_{l , r , ⌊ \frac{i}{L} ⌋}^{( 1 )} {p}_{l , r , i , f}^{( 2 )} {φ}_{l , r , i , f}$$

similar to Rel. 16 enhanced Type II codebook (as shown in 3GPP standard specification).

In one embodiment, a UE is configured with a CSI reporting based on a codebook which is one of the two codebooks described in embodiments of the present disclosure. In one example, this configuration can be via a higher layer parameter CodebookMode.

In one embodiment, where in the SD basis selection matrix is replaced with a SD port selection matrix. In one example, the codebook in this case can be configured via one higher layer parameter codebookType set to “typeII-PortSelection-cjt-mode2-r18,” or via two higher layer parameters codebookType set to “typeII-PortSelection-cjt-r18” and codebookMode set to “Mode2.”

In one example,

$${v}_{{m}_{1}^{( r , i )} , {m}_{2}^{( r , i )}}$$

is replaced with vᵢ_{_{1,1r}}_{d+i} (cf. Rel.16 Type II codebook). For TRP r, the antenna ports per polarization are selected by the index i_{1,1}=[i_{1,1,1} . . . i_{1,1,N}], where

$${i}_{1 , 1 , r} ∈ \{ 0 , 1 , … , ⌈ \frac{{P}_{CSI - RS , r}}{2 d} ⌉ \} .$$

In one example, vₘ_{₁}_{^{(r,i)}}_{,m}_{₂}_{^{(r,i)}} is replaced with vᵢ_{_{1,1,r}}_{d+i} (cf. Rel.17 Type II codebook). For TRP r, K_{1,r}=2Lᵣ ports are selected from P_{CSI-RS}, r ports based on Lᵣ vectors, vₘ_{^{(r,i)}}, i=0, 1, . . . , Lᵣ−1, which are identified by m=[m⁽¹⁾ . . . m^{(N)}] m^{(r)}=[m^{(r,0)} . . . m^{(r,L-1)}] and

$${m}^{( r , i )} ∈ \{ 0 , 1 , … , \frac{{P}_{CSI - RS}}{2} - 1 \}$$

which are indicated by the index i_{1,2}=[i_{1,2,l} . . . i_{1,2,N}], where

$${i}_{1 , 2 , r} ∈ \{ 0 , 1 , … , ( \begin{matrix}\frac{{P}_{CSI - RS , r}}{2} \\ {L}_{r}\end{matrix} ) - 1 \} .$$

In one embodiment, where in the SD basis selection matrix is replaced with a SD port selection matrix. In one example, the codebook in this case can be configured via one higher layer parameter codebookType set to “typeII-PortSelection-cjt-model-r18,” or via two higher layer parameters codebookType set to “typeII-PortSelection-cjt-r18” and codebookMode set to “Mode1.”

In one example,

$${v}_{{m}_{1}^{( r , i )} , {m}_{2}^{( r , i )}}$$

is replaced with vᵢ_{_{1,1,r}}_{d+i} (cf. Rel.16 Type II codebook). For TRP r, the antenna ports per polarization are selected by the index i_{1,1}=[i_{1,1,1} . . . i_{1,1,N}], where

$${i}_{1 , 1 , r} ∈ \{ 0 , 1 , … , ⌈ \frac{{P}_{CSI - RS , r}}{2 d} ⌉ \} .$$

In one example

$${v}_{{m}_{1}^{( r , i )} , {m}_{2}^{( r , i )}}$$

is replaced with vₘ_{^{(r,i)}} (cf. Rel.17 Type II codebook). For TRP r, K_{1,r}=2Lᵣ ports are selected from P_{CSI-RS}, r ports based on Lᵣ vectors, vₘ_{^{(r,i)}}, i=0, 1, . . . , Lᵣ−1, which are identified by: m=[m⁽¹⁾ ⋅ ⋅⋅ m^{(N)}] m^{(r)}=[m^{(r,0)} ⋅ ⋅ ⋅ m^{(r,L-1)}] and

$${m}^{( r , i )} ∈ \{ 0 , 1 , … , \frac{{P}_{CSI - RS}}{2} - 1 \}$$

which are indicated by the index i_{1,2}=[i_{1,2,l} . . . i_{1,2,N}], where

$${i}_{1 , 2 , r} ∈ \{ 0 , 1 , … , ( \begin{matrix}\frac{{P}_{CSI - RS , r}}{2} \\ {L}_{r}\end{matrix} ) - 1 \} .$$

In one embodiment, where in the SD basis selection matrix is replaced with a SD port selection matrix.

In one example,

$${v}_{{m}_{1}^{( r , i )} , {m}_{2}^{( r , i )}}$$

is replaced with vᵢ_{_{1,1,r}}_{d+i} (cf. Rel.16 Type II codebook). For TRP r the antenna ports per polarization are selected by the index i_{1,1}=[i_{1,1,1} . . . i_{1,1,N}], where

$${i}_{1 , 1 , r} ∈ \{ 0 , 1 , … , ⌈ \frac{{P}_{CSI - RS , r}}{2 d} ⌉ \} .$$

In one example,

$${v}_{{m}_{1}^{( r , i )} , {m}_{2}^{( r , i )}}$$

is replaced with vₘ_{^{(r,i)}} (cf. Rel.17 Type II codebook). For TRP r, K_{1,r}=2Lᵣ ports are selected from P_{CSI-RS}, r ports based on Lᵣ vectors, vₘ_{^{(r,i)}}, i=0, 1, . . . , Lᵣ−1, which are identified by: m=[m⁽¹⁾ . . . m^{(N)}], [m^{(r)}=m^{(r,0)} . . . m^{(r,L-1)}] and

$${m}^{( r , i )} ∈ \{ 0 , 1 , … , \frac{{P}_{CSI - RS}}{2} - 1 \}$$

which are indicated by the index i_{1,2}=[i_{1,2,l} . . . i_{1,2,N}], where

$${i}_{1 , 2 , r} ∈ \{ 0 , 1 , … , ( \begin{matrix}\frac{{P}_{CSI - RS , r}}{2} \\ {L}_{r}\end{matrix} ) - 1 \} .$$

In one embodiment, a UE is configured with a CSI report for Z≥1 TRPs or CSI-RS resources (from a total of N_{TRP} NZP CSI-RS resources) based on a codebook, where the codebook is configured according to embodiments of the present disclosure. In addition, the FD basis vectors comprising columns of W_{f} can be configured (e.g., via higher layer parameter) to be determined/reported according to at least one of the following embodiments/examples.

In one example, the FD basis vectors comprising columns of W_{f,r} for CSI-RS resource r are determined/derived from TRP-common (CSI-RS resource common) Mᵥ FD basis vectors and TRP-specific (CSI-RS resource specific) FD offset values φᵣ. In other words, the UE determines/reports Mᵥ FD basis vectors common for all CSI-RS resources and FD offset value(s) φᵣ for each CSI-RS resource r, where φᵣ∈{0, 1, . . . , N₃−1} (or φᵣ∈{1, . . . , N₃}). For example, W_{f,r} can be derived from W_{f} including the TRP-common Mᵥ FD basis vectors and TRP-specific FD offset value φᵣ, e.g.,

$${W}_{f , r} = diag ( [ 1 {e}^{j \frac{2 π}{{N}_{3}} {φ}_{r}} … \cdot {e}^{j \frac{2 π}{{N}_{3}} ( {N}_{3} - 1 ) {φ}_{r}} ] ) {W}_{f} ,$$

where diag([x₁, . . . , xₙ]) is an n×n diagonal matrix including x₁, . . . , xₙ as diagonal entries.

In one example, in addition to FD offset value(s) or index φᵣ, an oversampled (rotated) value or index q_{3,r} for FD offset value can be used to determine/derive W_{f,r}, where q_{3,r}∈{0, 1, . . . , O₃−1} (or q_{3,r}∈{1, . . . , O₃}). For example, W_{f,r} can be expressed as

$${W}_{f , r} = {e}^{j \frac{2 π {q}_{3 , r}}{{N}_{3} {O}_{3}}} \cdot diag ( [ 1 {e}^{j \frac{2 π}{{N}_{3}} {φ}_{r}} … \cdot {e}^{j \frac{2 π}{{N}_{3}} ( {N}_{3} - 1 ) {φ}_{r}} ] ) {W}_{f} = diag ( [ {e}^{j \frac{2 π {q}_{3 , r}}{{N}_{3} {O}_{3}}} {e}^{j \frac{2 π ( {q}_{3 , r} + {O}_{3} {φ}_{r} )}{{N}_{3} {O}_{3}}} … \cdot {e}^{j \frac{2 π ( {q}_{3 , r} + ( {N}_{3} - 1 ) {O}_{3} {φ}_{r} )}{{N}_{3} {O}_{3}}} ] ) {W}_{f} .$$

In one example, O₃ is fixed (e.g., 4 or8). In one example, O₃ is configured (e.g., via higher layer from {1, 4}.

In one example, FD offset value φᵣ and oversampled (rotated) value q_{3,r} for the FD offset value can be combined into one value, denoted by φᵣ, where φᵣ∈{0, 1, ⋅ ⋅ ⋅ , N₃O₃−1} or φᵣ∈{1, ⋅ ⋅ ⋅ , N₃O₃}. In this case, for example, φᵣ is determined/reported by the UE, and the reported φᵣ can be decomposed into two values q_{3,r} and φᵣ using mod operation or operation to find remainder/quotient. For example, based on the two decomposed values, NW can identify W_{f,r} using the above expression. In one example, φᵣ=q_{3,r}+O₃φᵣ when φᵣ∈{0, 1, . . . , N₃−1}, q_{3,r}=φᵣ mod O₃ and

$${φ}_{r} = \frac{{φ}_{r} - {q}_{3 , r}}{{O}_{3}} .$$

In one example, φᵣ=q_{3,r}+φᵣ when φᵣ∈{0, 1, . . . , O₃N₃−1}, q_{3,r}=φᵣ mod N₃O₃ and φᵣ=φᵣ−q_{3,r}.

In another example, a combined value φᵣ of FD offset value(s) or index φᵣ and an oversampled (rotated) value or index q_{3,r} for FD offset value can be used to determine/derive W_{f,r}, where

$${ϕ}_{r} ∈ \{ 0 , \frac{1}{{O}_{3}} , … , \frac{{O}_{3} - 1}{{O}_{3}} , 1 , … , {N}_{3} - \frac{1}{{O}_{3}} \} .$$

In one example, when

$${O}_{3} = 4 , {ϕ}_{r} ∈ \{ 0 , \frac{1}{4} , \frac{1}{2} , \frac{3}{4} , 1 , \frac{5}{4} , … , {N}_{3} - \frac{1}{4} \} .$$

For example, W_{f,r} can be expressed as

$${W}_{f , r} = diag ( [ 1 {e}^{j \frac{2 {πϕ}_{r}}{{N}_{3}}} … \cdot {e}^{j \frac{2 π ( {N}_{3} - 1 ) {ϕ}_{r}}{{N}_{3}}} ] ) {W}_{f} .$$

In another example, a combined value φᵣ of FD offset value(s) or index φᵣ and an oversampled (rotated) value or index q_{3,r} for FD offset value can be used to determine/derive W_{f,r}, where φᵣ∈{0, 1, . . . , N₃O₃−1}. In one example, when O₃=4, φᵣ∈{0, 1, . . . , 4₃−1}. For example, W_{f,r} can be expressed as

$${W}_{f , r} = diag ( [ 1 {e}^{j \frac{2 π {ϕ}_{r}}{{N}_{3} {O}_{3}}} … \cdot {e}^{j \frac{2 π ( {N}_{3} - 1 ) {ϕ}_{r}}{{N}_{3} {O}_{3}}} ] ) {W}_{f} .$$

In one example, FD offset value φᵣ is layer-common, i.e., one value is associated with all layers l=1, ⋅ ⋅ ⋅ , v.

In one example, FD offset value φᵣ is layer-specific, i.e., one value is associated with each layer l=1, ⋅ ⋅ ⋅ , v, and in this case, the notation for the FD offset value for example can be given by φ_{r,l}. The Z values are reported by the UE. Or Z−1 values are reported by the UE when one of the Z TRPs is reported by the UE as a reference (whose φᵣ can be fixed to 0).

In one example, an oversampled (rotated) value q_{3,r} for FD offset value is layer-common, i.e., one value is associated with all layers l=1, ⋅ ⋅ ⋅ , v.

In one example, an oversampled (rotated) value q_{3,r} for FD offset value is layer-specific, i.e., one value is associated with each layer l=1, ⋅ ⋅ ⋅ , v, and in this case, for example, the notation for the oversampled value can be given by q_{3,r,l}. The Z values are reported by the UE. Or Z−1 values are reported by the UE when one of the Z TRPs is reported by the UE as a reference (whose q_{3,r} can be fixed to 0).

In one example, a combined value of q_{3,r} and φᵣ, i.e., Or is layer-common, i.e., one values is associated with all layers l=1, ⋅ ⋅ ⋅ , v.

In one example, a combined value of q_{3,r} and φᵣ, i.e., φᵣ is layer-specific, i.e., one value is associated with each layer l=1, ⋅ ⋅ ⋅ , v. The Z values are reported by the UE. Or Z−1 values are reported by the UE when one of the Z TRPs is reported by the UE as a reference (whose φᵣ can be fixed to 0).

In one example, FD offset value φ_{r,l} is layer-specific, and an oversampled (rotated) value q_{3,r} is layer-common.

In one example, FD offset value φᵣ is layer-common, and an oversampled (rotated) value q_{3,r,l} is layer-common.

In one example, the oversampling factor O₃ is configured by NW via higher-layer signaling, i.e., RRC.

In one example, the oversampling factor O₃ is fixed e.g., O₃=2, or O₃=4, or O₃=8.

In one example, the oversampling factor O₃ is determined/reported by the UE.

In one example, a reference CSI-RS resource r* is layer-common, i.e., one reference is associated with all layers.

In one example, a reference CSI-RS resource r* is configured by NW. For example, r*=0 or the CSI resource with the lowest resource ID or a first of the N_{TRP} CSI-RS resources. In another example, the NW explicitly configures the reference CSI-RS resource r*.

In one example, a reference CSI-RS resource r* is implicitly determined. For example, r* is determined by strongest coefficient indicator (SCI) for layer l=1, i.e., r* is the CSI-RS resource index associated with the SCI of layer l=1.

In one example, a reference CSI-RS resource r* is determined and reported by the UE via CSI part 1.

In one example, a reference CSI-RS resource rₗ* is layer-specific, i.e., one reference is associated with each layer.

In one example, a reference CSI-RS resource rₗ* is configured by NW. For example, rₗ*=0 for all layers or the CSI resource with the lowest resource ID or a first of the N_{TRP} CSI-RS resources for all layers. In another example, the NW explicitly configures the reference CSI-RS resource rₗ* for each layer l.

In one example, a reference CSI-RS resource rₗ* is implicitly determined. For example, rₗ* is determined by strongest coefficient indicator (SCI) for each layer l, i.e., rₗ* is the CSI-RS resource index associated with the SCI of each layer l.

In one example, a reference CSI-RS resource rₗ* is determined for each layer l and reported by the UE via CSI part 1.

In this embodiment, φᵣ and \tilde{φ}ᵣ can be used interchangeably.

In one embodiment, a UE can be configured to report Mᵥ FD basis vectors from a total of N₃ basis vectors separately (independently) for each layer l∈{1, . . . , v} of a rank v CSI reporting. The Mᵥ FD basis vectors for each layer are common across CSI-RS resources (TRPs).

In one example, the Mᵥ FD basis vectors, g_{f,l}=[y_{0,l}^{(f)} y_{1,l}^{(f)} ⋅ ⋅ ⋅ y_{N}_{₃}_{-1,l}^{(f)}]^{T}, f=0, 1, . . . , Mᵥ−1, are identified by n_{3,l} (l=1, . . . , v) where n_{3,l}=[n_{3,l}⁽⁰⁾, . . . , n_{3,l}^{(M}^{ᵥ}⁻¹⁾] and n_{3,l}^{(f)}∈{0, 1, . . . , N₃−1} which are indicated by means of the indices i_{1,6,l} (for Mᵥ>1), where i_{1,6,l}∈ {0, 1, . . . , X−1}. The UE reports i_{1,6,l} (l=1, . . . , v) via the PMI included in the CSI report. In one example,

$$X = ( \begin{matrix}{N}_{3} - 1 \\ {M}_{υ} - 1\end{matrix} )$$

when one of the FD basis vectors is fixed, e.g., n_{3,l}⁽⁰⁾=0. In one example,

$$X = ( \begin{matrix}{N}_{3} \\ {M}_{υ}\end{matrix} ) .$$

The payload for i_{1,6,l} reporting is ┌log₂ X┐ bits.

In one example, the UE can be further configured to report FD offset value ϕ_{r,l} separately (independently) for each layer l∈{1, . . . , v}.

In one example, ϕ_{r,l} is indicated using an indicator, e.g., i_{offset,r,l}, where i_{offset,r,l}∈{0, 1, ⋅ ⋅ ⋅ , N₃−1}, hence the payload of i_{offset,r,l} is ┌log₂ N₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}]^{T}, f=0, 1, . . . , Mᵥ−1, are identified by n_{3,l} (l=1, . . . , v) and φ_{r,l} (l=1, . . . , v) where n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, and ϕ_{r,l}∈{0, 1, . . . , N₃−1} which are indicated by means of the indices i_{1,6,l} (for Mᵥ>1) and i_{offset,r,l}, where i_{1,6,l}∈ {0, 1, . . . , X−1} and i_{offset,r,l}∈{0, 1, ⋅ ⋅ ⋅ , N₃−1}. The UE reports i_{1,6,l} (l=1, . . . , v) and i_{offset,r,l} (l=1, . . . , v) via the PMI included in the CSI report. In one example,

$$X = ( \begin{matrix}{N}_{3} - 1 \\ {M}_{υ} - 1\end{matrix} )$$

when one of the FD basis vectors is fixed, e.g., n_{3,l}⁽⁰⁾=0. In one example,

$$X = ( \begin{matrix}{N}_{3} \\ {M}_{υ}\end{matrix} ) .$$

The payload for i_{1,6,l} reporting is ┌log₂ X┐ bits. In one example,

$${y}_{t , l , r}^{( f )} = {e}^{j \frac{2 π {tn}_{3 , l}^{( f )}}{{N}_{3}}} {e}^{j \frac{2 π {φ}_{r , l}}{{N}_{3}}} .$$

In one example, ϕ_{r*,l}=0 for reference CSI-RS resource r* for all layers l (hence no report is needed).

In one example, ϕᵣ_{ₗ}_{*,l}=0 for reference CSI-RS resource rₗ* for each layer l (hence no report is needed).

In one example, ϕ_{r,l} is indicated using an existing indicator, for example, i_{1,5,r,l}, i.e., i_{offset,r,l}=i_{1,5,r,l} ∈{0, 1, ⋅ ⋅ ⋅ , N₃−1}, hence the payload of i_{1,5,r,l} is ┌log₂ N₃┐ bits.

In one example, the UE can be further configured to report FD offset value ϕ_{r,l} separately (independently) for each layer l∈{1, . . . , v} and to report an oversampled (rotated) value q_{3,r,l} separately (independently) for each layer l∈{1, . . . , v}.

In one example, ϕ_{r,l} is indicated using an indicator, e.g., i_{offset,r,l}, where i_{offset,r,l}∈{0, 1, ⋅ ⋅ ⋅ , N₃−1}, hence the payload of i_{offset,r,l} is ┌log₂ N₃┐ bits.

In one example, q_{3,r,l} is indicated using an indicator, e.g., i_{OS,r,l}, where i_{OS,r,l} ∈{0, 1, ⋅ ⋅ ⋅ , O₃−1}, hence the payload of i_{OS,r,l} is ┌log₂ O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l} (l=1, . . . , v), φ_{r,l} (l=1, . . . , v), and q_{3,r,l} (l=1, . . . , v), where n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, ϕ_{r,l}∈{0, 1, . . . , N₃−1}, and q_{3,r,l} ∈{0, 1, . . . , O₃−1} which are indicated by means of the indices i_{1,6,l} (for Mᵥ>1), i_{offset,r,l}, and i_{OS,r,l} where i_{1,6,l} ∈{0, 1, . . . , X−1} and i_{offset,r,l}∈{0, 1, ⋅ ⋅ ⋅ , N₃−1} and i_{OS,r,l} {0, 1, . . . , O₃−1}. The UE reports i_{1,6,l} (l=1, . . . , v) and i_{offset,r,l} (=1, . . . , v) and i_{OS,r,l} (l=1, . . . , v) via the PMI included in the CSI report. In one example,

$$X = ( \begin{matrix}{N}_{3} - 1 \\ {M}_{υ} - 1\end{matrix} )$$

when one of the FD basis vectors is fixed, e.g., n_{3,l}⁽⁰⁾=0. In one example,

$$X = ( \begin{matrix}{N}_{3} \\ {M}_{υ}\end{matrix} ) .$$

The payload for i_{1,6,l} reporting is ┌log₂ X┐ bits. In one example,

$${y}_{t , l , r}^{( f )} = {e}^{j \frac{2 π t {n}_{3 , l}^{( f )}}{{N}_{3}}} {e}^{j \frac{2 π ( {φ}_{r , l} {O}_{3} + {q}_{3 , r , l} )}{{N}_{3} {O}_{3}}} .$$

In one example, ϕ_{r*,l}=0 for reference CSI-RS resource r* for all layers l (hence no report is needed).

In one example, ϕᵣ_{ₗ}_{*,l}=0 for reference CSI-RS resource rₗ* for each layer l (hence no report is needed).

In one example, q_{3,r*,l}=0 for reference CSI-RS resource r* for all layers l (hence no report is needed).

In one example, q_{3,r}_{ₗ}_{*,l}=0 for reference CSI-RS resource rₗ* for each layer l (hence no report is needed).

In one example, a combined value \tilde{φ}_{r,l} of φ_{r,l} and q_{3,r,l} is indicated using an indicator, e.g., i_{offset,r,l}, where i_{offset,r,l} ∈{0, 1, ⋅ ⋅ ⋅ , N₃O₃−1}, hence the payload of i_{offset,r,l} is ┌log₂ N₃O₃┐ bits.

In one example, a combined value \tilde{φ}_{r,l} of φ_{r,l} and q_{3,r,l} is indicated using an indicator, e.g., i_{offset,r,l}, where

$${i}_{offset , r , l} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

hence the payload of i_{offset,r,l} is ┌log₂ N₃O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}]^{T}, f=0, 1, . . . , Mᵥ−1, are identified by n_{3,l} (l=1, . . . , v) and \tilde{φ}_{r,l} (l=1, . . . , v), where n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, and \tilde{φ}_{r,l} ∈{0, 1, . . . , N₃O₃−1} which are indicated by means of the indices i_{1,6,l} (for Mᵥ>1), and i_{offset,r,l} where i_{1,6,l}∈{0, 1, . . . , X−1} and i_{offset,r,l} ∈{0, 1, ⋅ ⋅ ⋅ , N₃O₃−1}. The UE reports i_{1,6,l} (l=1, . . . , v) and i_{offset,r,l} (l=1, . . . , v) via the PMI included in the CSI report. In one example,

$$X = ( \begin{matrix}{N}_{3} - 1 \\ {M}_{υ} - 1\end{matrix} )$$

when one of the FD basis vectors is fixed, e.g., n_{3,l}⁽⁰⁾=0. In one example,

$$X = ( \begin{matrix}{N}_{3} \\ {M}_{υ}\end{matrix} ) .$$

The payload for i_{1,6,l} reporting is ┌log₂ X┐ bits. In one example,

$${y}_{t , l , r}^{( f )} = {e}^{j \frac{2 π t {n}_{3 , l}^{( f )}}{{N}_{3}}} {e}^{j \frac{2 π {\tilde{φ}}_{r , l}}{{N}_{3} {O}_{3}}} .$$

In one example, \tilde{φ}_{r*,l}=0 for reference CSI-RS resource r* for all layers l (hence no report is needed).

In one example, \tilde{φ}ᵣ_{ₗ}_{*,l}=0 for reference CSI-RS resource rₗ* for each layer l (hence no report is needed).

In one example, \tilde{φ}_{r,l} is indicated using an existing indicator, for example, i_{1,5,r,l}, i.e., i_{offset,r,l}=i_{1,5,r,l} ∈{0, 1, ⋅ ⋅ ⋅ , N₃O₃−1}, hence the payload of i_{1,5,r,l} is ┌log₂ N₃O₃┐ bits.

In one example, \tilde{φ}_{r,l} is indicated using an existing indicator, for example, i_{1,5,r,l}, i.e.,

$${i}_{offset , r , l} = {i}_{1 , 5 , r , l} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

hence the payload of i_{1,5,r,l} is ┌log₂ N₃O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l,r} (l=1, . . . , v and r=1, . . . , Z) and \tilde{φ}_{r,l} (l=1, . . . , v), where

$${n}_{3 , l , r} = [ {n}_{3 , l , r}^{( 0 )} , … , {n}_{3 , l , r}^{( {M}_{υ} - 1 )} ] , {n}_{3 , l , r}^{( f )} ∈ \{ 0 , 1 , … , {N}_{3} {O}_{3} - 1 \} ,$$

and n_{3,l,r}^{(f)}=n_{3,l}O₃+\tilde{φ}_{r,l} or (n_{3,l}O₃+\tilde{φ}_{r,l})mod N₃O₃ which are indicated by means of the indices i_{1,6,l} (for Mᵥ>1), and i_{offset,r,l} where i_{1,6,l}∈{0, 1, . . . , X−1} and i_{offset,r,l}∈{0, 1, ⋅ ⋅ ⋅ , N₃O₃−1}. The UE reports i_{1,6,l} (l=1, . . . , v) and i_{offset,r,l} (l=1, . . . , v) via the PMI included in the CSI report. In one example,

$$X = ( \begin{matrix}{N}_{3} - 1 \\ {M}_{υ} - 1\end{matrix} )$$

when one of the FD basis vectors is fixed, e.g., n_{3,l}⁽⁰⁾=0. In one example,

$$X = ( \begin{matrix}{N}_{3} \\ {M}_{υ}\end{matrix} ) .$$

The payload for i_{1,6,l} reporting is ┌log₂ X┐ bits.

In one example,

$${y}_{t , l , r}^{( f )} = {e}^{j \frac{2 π t {n}_{3 , l , r}^{( f )}}{{N}_{3} {O}_{3}}} .$$

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l,r} (l=1, . . . , v and r=1, . . . , Z) and \tilde{φ}_{r,l} (l=1, . . . , v), where

$${n}_{3 , l , r} = [ {n}_{3 , l , r}^{( 0 )} , … , {n}_{3 , l , r}^{( {M}_{v} - 1 )} ] , {n}_{3 , l , r}^{( f )} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

and n_{3,l,r}^{(f)}=n_{3,l}+\tilde{φ}_{r,l} or (n_{3,l}+\tilde{φ}_{r,l})mod N₃ which are indicated by means of the indices i_{1,6,l} (for Mᵥ>1), and i_{offset,r,l} where i_{1,6,l}∈{0, 1, . . . , X−1} and

$${i}_{offset , r , l} ∈ \{ 0 , \frac{1}{{O}_{3}} , … , \frac{{O}_{3} - 1}{{O}_{3}} , 1 , … , {N}_{3} - \frac{1}{{O}_{3}} \} .$$

The UE reports i_{1,6,l} (l=1, . . . , v) and i_{offset,r,l} (l=1, . . . , v) via the PMI included in the CSI report. In one example,

$$X = ( \begin{matrix}{N}_{3} - 1 \\ {M}_{v} - 1\end{matrix} )$$

when one of the FD basis vectors is fixed, e.g., n_{3,l}=0. In one example,

$$X = ( \begin{matrix}{N}_{3} \\ {M}_{v}\end{matrix} ) .$$

The payload for i_{1,6,l} reporting is ┌log₂ X┐ bits. In one example,

$${y}_{t , l , r}^{( f )} = {e}^{j \frac{2 π t {n}_{3 , l , r}^{( f )}}{{N}_{3}}} .$$

In one example, the UE can be further configured to report FD offset value φ_{r,l} separately (independently) for each layer l∈{1, . . . , v} and to report an oversampled value q_{3,r} common for all layers l∈{1, . . . , v}.

In one example, φ_{r,l} is indicated using an indicator, e.g., i_{offset,r,l}, where i_{offset,r,l}∈{0, 1, ⋅ ⋅ ⋅ , N₃−1}, hence the payload of i_{offset,r,l} is ┌log₂ N₃┐ bits.

In one example, q_{3,r} is indicated using an indicator, e.g., i_{OS,r,l}, where i_{OS,r,l}∈{0, 1, ⋅ ⋅ ⋅ , O₃−1}, hence the payload of i_{OS,r,l} is ┌log₂ O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l} (l=1, . . . , v), φ_{r,l} (l=1, . . . , v), and q_{3,r}, where n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, φ_{r,l} ∈{0, 1, . . . , N₃−1}, and q_{3,r}∈{0, 1, . . . , O₃−1} which are indicated by means of the indices i_{1,6,l} (for Mᵥ>1), i_{offset,r,l}, and i_{OS,r} where i_{1,6,l}∈{0, 1, . . . , X−1} and i_{offset,r,l}∈{0, 1, ⋅ ⋅ ⋅ , N₃−1} and i_{OS,r,l}∈{0, 1, . . . , O₃−1}. The UE reports i_{1,6,l} (l=1, . . . , v) and i_{offset,r,l} (=1, . . . , v) via the PMI included in the CSI report. In one example,

$$X = ( \begin{matrix}{N}_{3} - 1 \\ {M}_{v} - 1\end{matrix} )$$

when one of the FD basis vectors is fixed, e.g., n_{3,l}⁽⁰⁾=0. In one example,

$$X = ( \begin{matrix}{N}_{3} \\ {M}_{v}\end{matrix} ) .$$

The payload for i_{1,6,l} reporting is ┌log₂ X┐ bits.

In one example,

$${y}_{t , l , r}^{( f )} = {e}^{j \frac{2 π {tn}_{3 , l}^{( f )}}{{N}_{3}}} {e}^{j \frac{2 π ( {φ}_{r , l} {O}_{3} + {q}_{3 , r} )}{{N}_{3} {O}_{3}}} .$$

In one example, φ_{r*,l}=0 for reference CSI-RS resource r* for all layers l (hence no report is needed).

In one example, φᵣ_{ₗ}_{*,l}=0 for reference CSI-RS resource rₗ* for each layer l (hence no report is needed).

In one example, q_{3,r*}=0 for reference CSI-RS resource r* (hence no report is needed).

In one example, the UE can be further configured to report FD offset value φᵣ common for all layers l∈{1, . . . , v}.

In one example, φᵣ is indicated using an indicator, e.g., i_{offset,r}, where i_{offset,r}∈{0, 1, ⋅ ⋅ ⋅ , N₃−1}, hence the payload of i_{offset,r} is ┌log₂ N₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l} (l=1, . . . , v) and φᵣ (l=1, . . . , v) where n_{3,l}=[n_{3,l}⁽⁰⁾, . . . , n_{3,l}^{(M}^{ᵥ}⁻¹⁾], n_{3,l}^{(f)}∈{, 1, . . . , N₃−1}, and φᵣ∈{0, 1, . . . , N₃−1} which are indicated by means of the indices i_{1,6,l} (for Mᵥ>1) and i_{offset,r}, where i_{1,6,l} ∈{0, 1, . . . , X−1} and i_{offset,r}∈{0, 1, . . . , N₃−1}. The UE reports i_{1,6,l} (l=1, . . . , v) and i_{offset,r} via the PMI included in the CSI report. In one example,

$$X = ( \begin{matrix}{N}_{3} - 1 \\ {M}_{v} - 1\end{matrix} )$$

when one of the FD basis vectors is fixed, e.g., n_{3,l}⁽⁰⁾=0. In one example,

$$X = ( \begin{matrix}{N}_{3} \\ {M}_{v}\end{matrix} ) .$$

The payload for i_{1,6,l} reporting is ┌log₂ X┐ bits.

In one example,

$${y}_{t , l , r}^{( f )} = {e}^{j \frac{2 π {tn}_{3 , l}^{( f )}}{{N}_{3}}} {e}^{j \frac{2 {πφ}_{r}}{{N}_{3}}} .$$

In one example, φ_{r*}=0 for reference CSI-RS resource r* (hence no report is needed).

In one example, φᵣ is indicated using an existing indicator, for example, i_{1,5,r}, i.e., i_{offset,r}=i_{1,5,r}∈{0, 1, ⋅ ⋅ ⋅ , N₃−1}, hence the payload of i_{1,5,r} is ┌log₂ N₃┐ bits.

In one example, the UE can be further configured to report FD offset value φᵣ common for all layers l∈{1, . . . , v} and to report an oversampled (rotated) value q_{3,r,l} separately (independently) for each layer l∈{1, . . . , v}.

In one example, φᵣ is indicated using an indicator, e.g., i_{offset,r}, where i_{offset,r}∈{0, 1, ⋅ ⋅ ⋅ , N₃−1}, hence the payload of i_{offset,r} is ┌log₂ N₃┐ bits.

In one example, q_{3,r,l} is indicated using an indicator, e.g., i_{OS,r,l}, where i_{OS,r,l}∈{0, 1, ⋅ ⋅ ⋅ , O₃−1}, hence the payload of i_{OS,r,l} is ┌log₂ O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l} (l=1, . . . , v), φᵣ, and q_{3,r,l} (l=1, . . . , v), where n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, φᵣ∈{0, 1, . . . , N₃−1} and q_{3,r,l}∈{0, 1, . . . , O₃−1} which are indicated by means of the indices i_{1,6,l} (for Mᵥ>1), i_{offset,r}, and i_{OS,r,l} where i_{1,6,l}∈{0, 1, . . . , X−1} and i_{offset,r}∈{0, 1, ⋅ ⋅ ⋅ , N₃−1} and i_{OS,r,l}∈{0, 1, . . . , O₃−1}. The UE reports i_{1,6,l} (l=1, . . . , v) and i_{offset,r} (l=1, . . . , v) and i_{OS,r,l} (l=1, . . . , v) via the PMI included in the CSI report. In one example,

$$X = ( \begin{matrix}{N}_{3} - 1 \\ {M}_{v} - 1\end{matrix} )$$

when one of the FD basis vectors is fixed, e.g., n_{3,l}⁽⁰⁾=0. In one example,

$$X = ( \begin{matrix}{N}_{3} \\ {M}_{v}\end{matrix} ) .$$

The payload for i_{1,6,l} reporting is ┌log₂ X┐ bits.

In one example,

$${y}_{t , l , r}^{( f )} = {e}^{j \frac{2 π {tn}_{3 , l}^{( f )}}{{N}_{3}}} {e}^{j \frac{2 π ( {φ}_{r} {O}_{3} + {q}_{3 , r , l} )}{{N}_{3} {O}_{3}}} .$$

In one example, φ_{r*}=0 for reference CSI-RS resource r* (hence no report is needed).

In one example, q_{3,r*,l}=0 for reference CSI-RS resource r* for all layers l (hence no report is needed).

In one example, q_{3,r}_{ₗ}_{*,l}=0 for reference CSI-RS resource rₗ* for each layer l (hence no report is needed).

In one example, the UE can be further configured to report FD offset value φᵣ common for all layers l∈{1, . . . , v} and to report an oversampled value q_{3,r} common for all layers l∈{1, . . . , v}.

In one example, φᵣ is indicated using an indicator, e.g., i_{offset,r}, where i_{offset,r}∈{0, 1, ⋅ ⋅ ⋅ , N₃−1}, hence the payload of i_{offset,r} is ┌log₂ N₃┐ bits.

In one example, q_{3,r} is indicated using an indicator, e.g., i_{OS,r}, where i_{OS,r}∈{0, 1, ⋅ ⋅ ⋅ , O₃−1}, hence the payload of i_{OS,r} is ┌log₂ O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l} (l=1, . . . , v), φᵣ, and q_{3,r}, where n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, φᵣ∈{0, 1, . . . , N₃−1}, and q_{3,r}∈{0, 1, . . . , O₃−1} which are indicated by means of the indices i_{1,6,l} (for Mᵥ>1), i_{offset,r}, and i_{OS,r} where i_{1,6,l}∈{0, 1, . . . , X−1} and i_{offset,r}∈{0, 1, ⋅ ⋅ ⋅ , N₃−1} and i_{OS,r}∈{0, 1, . . . , O₃−1}. The UE reports i_{1,6,l} (l=1, . . . , v) and i_{offset,r} and i_{OS,r} via the PMI included in the CSI report. In one example,

$$X = ( \begin{matrix}{N}_{3} - 1 \\ {M}_{v} - 1\end{matrix} )$$

when one of the FD basis vectors is fixed, e.g., n=0. In one example,

$$X = ( \begin{matrix}{N}_{3} \\ {M}_{v}\end{matrix} ) .$$

The payload for i_{1,6,l} reporting is ┌log₂ X┐ bits. In one example,

$${y}_{t , l , r}^{( f )} = {e}^{j \frac{2 π {tn}_{3 , l}^{( f )}}{{N}_{3}}} {e}^{j \frac{2 π ( {φ}_{r} {O}_{3} + {q}_{3 , r} )}{{N}_{3} {O}_{3}}} .$$

In one example, φ_{r*}=0 for reference CSI-RS resource r* (hence no report is needed).

In one example, q_{3,r*}=0 for reference CSI-RS resource r* (hence no report is needed).

In one example, a combined value \tilde{φ}ᵣ of φᵣ and q_{3,r} is indicated using an indicator, e.g., i_{offset,r}, where i_{offset,r}∈{0, 1, ⋅ ⋅ ⋅ , N₃O₃−1}, hence the payload of i_{offset,r} is ┌log₂ N₃O₃┐ bits.

In one example, a combined value Or of φᵣ and q_{3,r} is indicated using an indicator, e.g., i_{offset,r}, where

$${i}_{offset , r} ∈ \{ 0 , \frac{1}{{O}_{3}} , ... , \frac{{O}_{3} - 1}{{O}_{3}} , 1 , ... , {N}_{3} - \frac{1}{{O}_{3}} \} ,$$

hence the payload of i_{offset,r} is ┌log₂ N₃O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l} (l=1, . . . , v) and <p, where n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, and \tilde{φ}ᵣ∈{0, 1, . . . , N₃O₃−1} which are indicated by means of the indices i_{1,6,l} (for Mᵥ>1), and i_{offset,r} where i_{1,6,l}∈{0, 1, . . . , X−1} and i_{offset,r}∈{0, 1, ⋅ ⋅ ⋅ , N₃O₃−1}. The UE reports i_{1,6,l} (l=1, . . . , v) and i_{offset,r} via the PMI included in the CSI report. In one example,

$$X = ( \begin{matrix}{N}_{3} - 1 \\ {M}_{v} - 1\end{matrix} )$$

when one of the FD basis vectors is fixed, e.g., n=0. In one example,

$$X = ( \begin{matrix}{N}_{3} \\ {M}_{v}\end{matrix} ) .$$

The payload for i_{1,6,l} reporting is ┌log₂ X┐ bits. In one example,

$${y}_{t , l , r}^{( f )} = {e}^{j \frac{2 π t {n}_{3 , l}^{( f )}}{{N}_{3}}} {e}^{j \frac{2 π t {\tilde{φ}}_{r}}{{N}_{3} {O}_{3}}} .$$

In one example, \tilde{φ}_{r*}=0 for reference CSI-RS resource r* (hence no report is needed). Hence, i_{offset} [i_{offset,2}, . . . , i_{offset,N}], where N≤N_{TRP} is the number of selected CSI-RS resources (reported by UE and inferred from N_{TRP}-bit bitmap in CSI part 1). In this case, the payload of i_{offset} is (N−1)┌log₂ O₃N₃┐.

For example, codebook for precoder equation can be written as follows:

$${W}_{{q}_{1} , {q}_{2} , {n}_{1} , {n}_{2} , {n}_{3 , l ,} {p}_{l}^{( 1 )} , {p}_{l}^{( 2 )} , {φ}_{l , t}}^{l} = \frac{1}{\sqrt{{N}_{1} {N}_{2} {γ}_{t , l}}}$$

$$[ \begin{matrix}{\sum }_{i = 0}^{{L}_{{σ}_{1} - 1}} {v}_{{m}_{1 , 1}^{( i )} , {m}_{2 , 1}^{( i )}} {p}_{l , 0}^{( 1 )} & {\sum }_{f = 0}^{{M}_{υ} - 1} {y}_{t , l , 1}^{( f )} {p}_{l , i , f , 1}^{( 2 )} {φ}_{l , i , f , 1} \\ {\sum }_{i = 0}^{{L}_{{σ}_{1} - 1}} {v}_{{m}_{1 , 1}^{( i )} , {m}_{2 , 1}^{( i )}} {p}_{l , 1}^{( 1 )} & {\sum }_{f = 0}^{{M}_{υ} - 1} {y}_{t , l , 1}^{( f )} {p}_{l , i , + {L}_{{σ}_{1}} f , 1}^{( 2 )} {φ}_{l , i + {L}_{{σ}_{1}} , f , 1} \\ {\sum }_{i = 0}^{{L}_{{σ}_{2} - 1}} {v}_{{m}_{1 , 2}^{( i )} , {m}_{2 , 2}^{( i )}} {p}_{l , 0}^{( 1 )} & {\sum }_{f = 0}^{{M}_{υ} - 1} {y}_{t , l , 2}^{( f )} {p}_{l , i , f , 2}^{( 2 )} {φ}_{l , i , f , 2} \\ {\sum }_{i = 0}^{{L}_{{σ}_{2} - 1}} {v}_{{m}_{1 , 2}^{( i )} , {m}_{2 , 2}^{( i )}} {p}_{l , 1}^{( 1 )} & {\sum }_{f = 0}^{{M}_{υ} - 1} {y}_{t , l , 2}^{( f )} {p}_{l , i + {L}_{{σ}_{2}} , f , 2}^{( 2 )} {φ}_{l , i + {L}_{{σ}_{2}} , f , 2} \\ & ⋮ \\ {\sum }_{i = 0}^{{L}_{{σ}_{N} - 1}} {v}_{{m}_{1 , N}^{( i )} , {m}_{2 , N}^{( i )}} {p}_{l , 0}^{( 1 )} & {\sum }_{f = 0}^{{M}_{υ} - 1} {y}_{t , l , N}^{( f )} {p}_{l , i , f , N}^{( 2 )} {φ}_{l , i + , f , N} \\ {\sum }_{i = 0}^{{L}_{{σ}_{N} - 1}} {v}_{{m}_{1 , N}^{( i )} , {m}_{2 , N}^{( i )}} {p}_{l , 1}^{( 1 )} & {\sum }_{f = 0}^{{M}_{υ} - 1} {y}_{t , l , N}^{( f )} {p}_{l , i + {L}_{{σ}_{N}} , f , N}^{( 2 )} {φ}_{l , i + {L}_{{σ}_{N}} , f , N}\end{matrix} ]$$

In one example, \tilde{φ}ᵣ is indicated using an existing indicator, for example, i_{1,5,r}, i.e., i_{offset,r}=i_{1,5,r}∈{0, 1, ⋅ ⋅ ⋅ , N₃O₃−1}, hence the payload of i_{1,5,r} is ┌log₂ N₃O₃┐ bits.

In one example, \tilde{φ}ᵣ is indicated using an existing indicator, for example, i_{1,5,r}, i.e.,

$${i}_{offset , r} = {i}_{1 , 5 , r} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

hence the payload of i_{1,5,r} is ┌log₂ N₃O₃┐ bits.

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l,r} (l=1, . . . , v and r=1, . . . , Z) and \tilde{φ}ᵣ, where n_{3,l}=[n_{3,l}⁽⁰⁾, . . . , n_{3,l}^{(M}^{ᵥ}⁻¹⁾], n_{3,l}^{(f)}∈{0, 1, . . . , N₃O₃−1}, and n_{3,l,r}^{(f)}=n_{3,l}O₃+\tilde{φ}ᵣ or (n_{3,l}O₃+\tilde{φ}ᵣ)mod N₃O₃ which are indicated by means of the indices i_{1,6,l} (for Mᵥ>1), and i_{offset,r} where i_{1,6,l}∈{0, 1, . . . , X−1} and i_{offset,r}∈{0, 1, ⋅ ⋅ ⋅ , N₃O₃−1}. The UE reports i_{1,6,l} (l=1, . . . , v) and i_{offset,r} (l=1, . . . , v) via the PMI included in the CSI report. In one example,

$$X = ( \begin{matrix}{N}_{3} - 1 \\ {M}_{υ} - 1\end{matrix} )$$

when one of the FD basis vectors is fixed, e.g., n_{3,l}⁽⁰⁾=0. In one example,

$$X = ( \begin{matrix}{N}_{3} \\ {M}_{υ}\end{matrix} ) .$$

The payload for i_{1,6,l} reporting is ┌log₂ X┐ bits. In one example,

$${y}_{t , l , r}^{( f )} = {e}^{j \frac{2 π {tn}_{3 , l , r}^{( f )}}{{N}_{3} {O}_{3}}} .$$

In one example, the Mᵥ FD basis vectors for CSI-RS resource r, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by n_{3,l,r} (l=1, . . . , v and r=1, . . . , Z) and \tilde{φ}ᵣ, where

$${n}_{3 , l , r} = [ {n}_{3 , l}^{( 0 )} , … , {n}_{3 , l}^{( {M}_{υ} - 1 )} ] , {n}_{3 , l , r}^{( f )} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

and n_{3,l,r}^{(f)}=n_{3,l}+\tilde{φ}ᵣ or (n_{3,l}+\tilde{φ}ᵣ)mod N₃ which are indicated by means of the indices i_{1,6,l} (for Mᵥ>1), and i_{offset,r} where i_{1,6,l}∈{0, 1, . . . , X−1} and

$${i}_{offset , r} ∈ \{ 0 , \frac{1}{{O}_{3}} , … , \frac{{O}_{3} - 1}{{O}_{3}} , 1 , … , {N}_{3} - \frac{1}{{O}_{3}} \} .$$

The UE reports i_{1,6,l} (l=1, . . . , v) and i_{offset,r} (l=1, . . . , v) via the PMI included in the CSI report. In one example,

$$X = ( \begin{matrix}{N}_{3} - 1 \\ {M}_{υ} - 1\end{matrix} )$$

when one of the FD basis vectors is fixed, e.g., n_{3,l}=0.

In one example,

$$X = ( \begin{matrix}{N}_{3} \\ {M}_{υ}\end{matrix} ) .$$

The payload for i_{1,6,l} reporting is ┌log₂ X┐ bits. In one example,

$${y}_{t , l , r}^{( f )} = {e}^{j \frac{2 π {tn}_{3 , l , r}^{( f )}}{{N}_{3}}} .$$

FIG. 16 illustrates an example of window-based FD basis vector selection 1600 according to embodiments of the present disclosure. An embodiment of the window-based FD basis vector selection 1600 shown in FIG. 16 are for illustration only.

In one embodiment, a UE can be configured to report Mᵥ FD basis vectors from a set/window of N FD basis vectors, where the Mᵥ FD basis vectors are selected freely (independently) for each layer l∈{1, . . . , v} of a rank v CSI reporting, and the set/window is a subset of a total of N₃ basis vectors. In one example, N≤N₃. In one example, N≤N₃. The Mᵥ FD basis vectors for each layer are common across CSI-RS resources (TRPs).

The indices of the FD basis vectors in the set/window are given by mod(Mᵢₙᵢₜ+n, N₃), n=0, 1, . . . , N−1, which comprises N adjacent FD basis indices with modulo-shift by N₃, where Mᵢₙᵢₜ is the starting index of the window. An example is shown in FIG. 11. Note that the window-based basis set/matrix W_{f} is completely parameterized by Mᵢₙᵢₜ and N. At least one of the following examples can be used/configured to determine W_{f}.

In one example, both Mᵢₙᵢₜ and N are fixed.

In one example, both Mᵢₙᵢₜ and N are configured to the UE (via RRC or/and MAC CE or/and DCI).

In one example, both Mᵢₙᵢₜ and N are reported by the UE.

In one example, Mᵢₙᵢₜ is fixed and N is configured to the UE (via RRC or/and MAC CE or/and DCI).

In one example, Mᵢₙᵢₜ is fixed and N is reported by the UE.

In one example, Mᵢₙᵢₜ is configured to the UE (via RRC or/and MAC CE or/and DCI) and N is fixed.

In one example, Mᵢₙᵢₜ is configured to the UE (via RRC or/and MAC CE or/and DCI) and N is reported by the UE.

In one example, Mᵢₙᵢₜ is reported by the UE and N is fixed.

In one example, Mᵢₙᵢₜ is reported by the UE and N is configured to the UE (via RRC or/and MAC CE or/and DCI).

For Z>1 TRPs (CSI-RS resources), Mᵢₙᵢₜ can be fixed to (or configured with or reported) as the same/common value for all TRPs, or Mᵢₙᵢₜ can be fixed to (or configured with or reported) same or different values across TRPs. Likewise, for Z>1 TRPs (CSI-RS resources), N can be fixed to (or configured with or reported) the same/common value for all TRPs, or N can be fixed to (or configured with or reported) same or different values across TRPs.

In one example, the window for FD basis vector reporting is independent/separate across TRPs (CSI-RS resources), i.e., one window for each TRP, and Mᵢₙᵢₜ is reported. When M_{init,r} is reported per TRP r, it can be reported via an indicator i_{init,r} or i_{1,5,r}, which can be given

$$by {i}_{1 , 5 , r} = \{ \begin{matrix}{M}_{init , r} & {M}_{init , r} = 0 \\ {M}_{init , r} + {W}_{r} & {M}_{init , r} < 0\end{matrix} .$$

In one example, Wᵣ=Nᵣ=aMᵥ where a can be fixed, e.g., a=2. In one example, Nᵣ is configured. In one example, Wᵣ=min(Nᵣ, N₃). In one example, Wᵣ*=aMᵥ for one (a reference) CSI-RS resource r*, and Wᵣ=bN₃ for r≠r*, e.g., a=2, b=1. The Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by M_{init,r} and n_{3,l} (l=1, . . . v) where M_{init,r} ∈{−Wᵣ+1, −Wᵣ+2, . . . , 0}, n_{3,l}=[n_{3,l}⁽⁰⁾, . . . , n_{3,l}^{(M}^{ᵥ}⁻¹⁾], and n_{3,l}^{(f)}∈{0, 1, . . . , N₃−1} which are indicated by means of the indices i_{1,5,r} and i_{1,6,l} (for Mᵥ>1), where i_{1,5,r}∈{0, 1, . . . , Wᵣ−1} and i_{1,6,l}∈{0, 1, . . . , X−1}. The UE reports i_{1,5,r} and i_{1,6,l} (l=1, . . . , v) via the PMI included in the CSI report. In one example,

$$X = ( \begin{matrix}{W}_{r} - 1 \\ {M}_{υ} - 1\end{matrix} )$$

when one of the FD basis vectors is fixed, e.g., n_{3,l}⁽⁰⁾=0. In one example,

$$X = ( \begin{matrix}{W}_{r} \\ {M}_{υ}\end{matrix} ) .$$

The payload for i_{1,6,l} reporting is ┌log₂ X┐ bits. The payload for i_{1,5,r} reporting is ┌log₂ Wᵣ ┐ bits.

In one example, M_{init,r}=Mᵢₙᵢₜ when the same (one) value for Mᵢₙᵢₜ is reported for all TRPs, and in this case, it can be reported via an indicator iᵢₙᵢₜ or i_{1,5}. Note Wᵣ can be the same or different for r=1, . . . , Z.

In one example, M_{init,r} can be the same or different across TRPs, and in this case, Wᵣ can be the same or different for r=1, . . . , Z.

In one example, the window for FD basis vector reporting is independent/separate across TRPs (CSI-RS resources), i.e., one window for one TRP (e.g., a reference TRP r*), and Mᵢₙᵢₜ is reported. When Mᵢₙᵢₜ is reported for the TRP, it can be reported via an indicator iᵢₙᵢₜ or i_{1,5}, which can be given by

$${i}_{1 , 5} = \{ \begin{matrix}{M}_{init} & {M}_{init} = 0 \\ {M}_{init} + W & {M}_{init} < 0\end{matrix} .$$

In one example, W=N=aMᵥ where a can be fixed, e.g., a=2. In one example, N is configured. In one example, W=min(N, N₃). The Mᵥ FD basis vectors, g_{f,l}=[y_{0,l}^{(f)} y_{1,l}^{(f)} ⋅ ⋅ ⋅ y_{N}_{₃}_{-1,l}^{(f)}]^{T}, f=0, 1, . . . , Mᵥ−1 are identified by Mᵢₙᵢₜ and n_{3,l} (l=1, . . . , v) where Mᵢₙᵢₜ {−W+1, −W+2, . . . , 0}, n_{3,l}=[n_{3,l}⁽⁰⁾, . . . , n_{3,l}^{(M}^{ᵥ}⁻¹⁾], and n_{3,l}^{(f)}∈ {0, 1, . . . , N₃−1} which are indicated by means of the indices i_{1,5} and i_{1,6,l} (for Mᵥ>1), where i_{1,5} ∈{0, 1, . . . , W−1} and i_{1,6,l}∈{0, 1, . . . , X−1}. The UE reports i_{1,5} and i_{1,6,l} (l=1, . . . , v) via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits.

In one example, the UE can be further configured to report FD offset value φ_{r,l} separately (independently) for each layer l∈{1, . . . , v}.

In one example, φ_{r,l} is indicated using an indicator, e.g., i_{offset,r,l}, where i_{offset,r,l}∈{0, 1, ⋅ ⋅ ⋅ , N₃−1}, hence the payload of i_{offset,r,l} is ┌log₂ N₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l} (l=1, . . . , v) and φ_{r,l} (l=1, . . . , v) where Mᵢₙᵢₜ ∈{−W+1, −W+2, . . . , 0}, n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, and φ_{r,l}∈{0, 1, . . . , N₃−1} which are indicated by means of the indices i_{1,5} and i_{1,6,l} (for Mᵥ>1) and i_{offset,r,l}, where i_{1,5} ∈{0, 1, . . . , W−1} and i_{1,6,l}∈{0, 1, . . . , X−1} and i_{offset,r,l} ∈{0, 1, ⋅ ⋅ ⋅ , N₃−1}. The UE reports i_{1,5} and i_{1,6,l} (l=1, . . . , v) and i_{offset,r,l} (l=1, . . . , v) via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l}^{( f )}}{{N}_{3}}} {e}^{j \frac{2 π {φ}_{r , l}}{{N}_{3}}} .$$

In one example, φ_{r*,l}=0 for reference CSI-RS resource r* for all layers l (hence no report is needed).

In one example, φᵣ_{ₗ}_{*,l}=0 for reference CSI-RS resource rₗ* for each layer l (hence no report is needed).

In one example, φᵣ, is indicated using an existing indicator, for example, i_{1,5,r,l}, i.e., i_{offset,r,l}=i_{1,5,r,l}∈{0, 1, ⋅ ⋅ ⋅ , N₃−1}, hence the payload of i_{1,5,r,l} is ┌log₂ N₃┐ bits.

In one example, the UE can be further configured to report FD offset value φ_{r,l} separately (independently) for each layer l∈{1, . . . , v} and to report an oversampled (rotated) value q_{3,r,l} separately (independently) for each layer l∈{1, . . . , v}.

In one example, φᵣ, is indicated using an indicator, e.g., i_{offset,r,l}, where i_{offset,r,l}∈{0, 1, ⋅ ⋅ ⋅ , N₃−1}, hence the payload of i_{offset,r,l} is ┌log₂ N₃┐ bits.

In one example, q_{3,r,l} is indicated using an indicator, e.g., i_{OS,r,l}, where i_{OS,r,l}∈{0, 1, ⋅ ⋅ ⋅ , O₃−1}, hence the payload of i_{OS,r,l} is ┌log₂ O₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l} (l=1, . . . , v) and φ_{r,l} (l=1, . . . , v), and q_{3,r,l} (l=1, . . . , v) where Mᵢₙᵢₜ ∈{−W+1, −W+2, . . . , 0}, [n_{3,l}⁽⁰⁾, . . . , n_{3,l}^{(M}^{ᵥ}⁻¹⁾], n_{3,l}^{(f)}∈{0, 1, . . . , N₃−1}, φ_{r,l}∈{0, 1, . . . , N₃−1}, and q_{3,r,l}∈{0, 1, . . . , O₃−1} which are indicated by means of the indices i_{1,5} and i_{1,6,l} (for Mᵥ>1) and i_{offset,r,l}, and i_{OS,r,l} where i_{1,5}∈{0, 1, . . . , W−1} and i_{1,6,l}∈{0, 1, . . . , X−1} and i_{offset,r,l}∈{0, 1, ⋅ ⋅ ⋅ , N₃−1} and i_{OS,r,l} ∈ {0, 1, . . . , O₃−1}. The UE reports i_{1,5} and i_{1,6,l} (l=1, . . . , v) and i_{offset,r,l} (=1, . . . , v) and i_{OS,r,l} (l=1, . . . , v) via the PMI included in the CSI report. In one example,

$$X = ( \begin{matrix}W - 1 \\ {M}_{υ} - 1\end{matrix} )$$

when one of the FD basis vectors is fixed, e.g., n=0. In one example,

$$X = ( \begin{matrix}W \\ {M}_{v}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l}^{( f )}}{{N}_{3}}} {e}^{j \frac{2 π ( {φ}_{r , l} {O}_{3} + {q}_{3 , r , l} )}{{N}_{3} {O}_{3}}} .$$

In one example, φ_{r*,l}=0 for reference CSI-RS resource r* for all layers l (hence no report is needed).

In one example, φᵣ_{ₗ}_{*,l}=0 for reference CSI-RS resource rₗ* for each layer l (hence no report is needed).

In one example, q_{3,r*,l}=0 for reference CSI-RS resource r* for all layers l (hence no report is needed).

In one example, q_{3,r}_{ₗ}_{*,l}=0 for reference CSI-RS resource rₗ* for each layer l (hence no report is needed).

In one example, a combined value \tilde{φ}_{r,l} of φ_{r,l} and q_{3,r,l} is indicated using an indicator, e.g., i_{offset,r,l}, where i_{offset,r,l}∈{0, 1, ⋅ ⋅ ⋅ , N₃O₃−1}, hence the payload of i_{offset,r,l} is ┌log₂ N₃O₃┐ bits.

In one example, a combined value φ_{r,l} of φ_{r,l} and q_{3,r,l} is indicated using an indicator, e.g., i_{offset,r,l}, where

$${i}_{offset , r , l} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

hence the payload of i_{offset,r,l} is ┌log₂ N₃O₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l} (l=1, . . . , v) and \tilde{φ}_{r,l} (l=1, . . . , v) where Mᵢₙᵢₜ ∈{−W+1, −W+2, . . . , 0}, n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, and \tilde{φ}_{r,l}∈{0, 1, . . . , N₃O₃−1} which are indicated by means of the indices i_{1,5} and i_{1,6,l} (for Mᵥ>1) and i_{offset,r,l}, where i_{1,5} ∈{0, 1, . . . , W−1} and i_{1,6,l}∈{0, 1, . . . , X−1} and i_{offset,r,l}∈{0, 1, ⋅ ⋅ ⋅ , N₃O₃−1}. The UE reports i_{1,5} and i_{1,6,l} (l=1, . . . , v) and i_{offset,r,l}(l=1, . . . , v) via the PMI included in the CSI report. In one example,

$$X = ( \begin{matrix}W - 1 \\ {M}_{v} - 1\end{matrix} )$$

when one of the FD basis vectors is fixed, e.g., n_{3,l}⁽⁰⁾=0. In one example,

$$X = ( \begin{matrix}W \\ {M}_{v}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l}^{( f )}}{{N}_{3}}} {e}^{\frac{2 ω {\tilde{φ}}_{r , l}}{{N}_{3} {O}_{3}}} .$$

In one example, \tilde{φ}_{r*,l}=0 for reference CSI-RS resource r* for all layers l (hence no report is needed).

In one example, \tilde{φ}ᵣ_{ₗ}_{*,l}=0 for reference CSI-RS resource rₗ* for each layer l (hence no report is needed).

In one example, \tilde{φ}_{r,l} is indicated using an existing indicator, for example, i_{1,5,r,l}, i.e., i_{offset,r,l}=i_{1,5,r,l}∈{0, 1, ⋅ ⋅ ⋅ , N₃O₃−1}, hence the payload of i_{1,5,r,l} is ┌log₂ N₃O₃┐ bits.

In one example, \tilde{φ}_{r,l} is indicated using an existing indicator, for example, i_{1,5,r,l}, i.e.,

$${i}_{offset , r , l} = {i}_{1 , 5 , r , l} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

hence the payload of i_{1,5,r,l} is ┌log₂ N₃O₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l,r} (l=1, . . . , v and r=1, . . . , Z) and \tilde{φ}_{r,l} (l=1, . . . , v) where Mᵢₙᵢₜ ∈{−W+1, −W+2, . . . , 0}, n_{3,l,r}^{(f)}=[n_{3,l}⁽⁰⁾, . . . , n_{3,l}^{(M}^{ᵥ}⁻¹⁾], n_{3,l}^{(f)}∈{0, 1, . . . , N₃O₃−1}, and n_{3,l,r}^{(f)}=n_{3,l}O₃+\tilde{φ}_{r,l} or (n_{3,l}O₃+\tilde{φ}_{r,l})mod N₃O₃ which are indicated by means of the indices i_{1,5} and i_{1,6,l} (for Mᵥ>1) and i_{offset,r,l}, where i_{1,5} ∈{0, 1, . . . , W−1} and i_{1,6,l}∈{0, 1, . . . , X−1} and i_{offset,r,l}∈{0, 1, ⋅ ⋅ ⋅ , N₃O₃−1}. The UE reports i_{1,5} and i_{1,6,l} (l=1, . . . , v) and i_{offset,r,l} (l=1, . . . , v) via the PMI included in the CSI report. In one example,

$$X = ( \begin{matrix}W - 1 \\ {M}_{v} - 1\end{matrix} )$$

when one of the FD basis vectors is fixed, e.g., n_{3,l}⁽⁰⁾=0. In one example,

$$X = ( \begin{matrix}W \\ {M}_{v}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l , r}^{( f )}}{{N}_{3} {O}_{3}}} .$$

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l,r} (l=1, . . . , v and r=1, . . . , Z) and or, (l=1, . . . , v) where

$${M}_{init} ∈ \{ - W + 1 , - W + 2 , … , 0 \} , {n}_{3 , l , r} = [ {n}_{3 , l , r}^{( 0 )} , … , {n}_{3 , l , r}^{( {M}_{υ} - 1 )} ] , \\ {n}_{3 , l , r}^{( f )} ∈ \{ 0 , \frac{1}{{o}_{3}} , … , \frac{{o}_{3} - 1}{{o}_{3}} , 1 , … , {N}_{3} - \frac{1}{{o}_{3}} \} ,$$

and n_{3,l,r}=n_{3,l}+\tilde{φ}_{r,l} or (n_{3,l}+\tilde{φ}_{r,l})mod N₃ which are indicated by means of the indices i_{1,5} and i_{1,6,l} (for Mᵥ>1) and i_{offset,r,l}, where i_{1,5} ∈{0, 1, . . . , W−1} and i_{1,6,l}∈{0, 1, . . . , X−1} and

$${i}_{offset , r , l} ∈ \{ 0 , \frac{1}{{O}_{3}} , … , \frac{{O}_{3} - 1}{{O}_{3}} , 1 , … , {N}_{3} - \frac{1}{{O}_{3}} \} .$$

The UE reports i_{1,5} and i_{1,6,l} (l=1, . . . , v) and i_{offset,r,l} (l=1, . . . , v) via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0.

In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l , r}^{( f )}}{{N}_{3}}} .$$

In one example, the UE can be further configured to report FD offset value φ_{r,l} separately (independently) for each layer l∈{1, . . . , v} and to report an oversampled value q_{3,r} common for all layers l∈{1, . . . , v}.

In one example, φ_{r,l} is indicated using an indicator, e.g., i_{offset,r,l}, where i_{offset,r,l}∈{0, 1, ⋅ ⋅ ⋅ , N₃−1}, hence the payload of i_{offset,r,l} is ┌log₂ N₃┐ bits.

In one example, q_{3,r} is indicated using an indicator, e.g., i_{OS,r,l}, where i_{OS,r,l}∈{0, 1, ⋅ ⋅ ⋅ , O₃−1}, hence the payload of i_{OS,r,l} is ┌log₂ O₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l} (l=1, . . . , v) and φ_{r,l} (l=1, . . . , v), and q_{3,r} where Mᵢₙᵢₜ ∈{−W+1, −W+2, . . . , 0}, n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, φ_{r,l}∈{0, 1, . . . , N₃−1}, and q_{3,r}∈{0, 1, . . . , O₃−1} which are indicated by means of the indices i_{1,5} and i_{1,6,l} (for Mᵥ>1) and i_{offset,r,l}, and i_{OS,r} where i_{1,5} ∈{0, 1, . . . , W−1} and i_{1,6,l} ∈{0, 1, . . . , X−1} and i_{offset,r,l}∈{0, 1, ⋅ ⋅ ⋅ , N₃−1} and i_{OS,r}∈{0, 1, . . . , O₃−1}. The UE reports i_{1,5} and i_{1,6,l} (l=1, . . . , v) and i_{offset,r}, (l=1, . . . , v) and i_{OS,r} via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l}^{( f )}}{{N}_{3}}} {e}^{j \frac{2 π ( {φ}_{r , l} {O}_{3} + {q}_{3 , r} )}{{N}_{3} {O}_{3}}} .$$

In one example, φ_{r*,l}=0 for reference CSI-RS resource r* for all layers l (hence no report is needed).

In one example, φᵣ_{ₗ}_{*,l}=0 for reference CSI-RS resource rₗ* for each layer l (hence no report is needed).

In one example, q_{3,r}*=0 for reference CSI-RS resource r* (hence no report is needed).

In one example, the UE can be further configured to report FD offset value φᵣ common for all layers l∈{1, . . . , v}.

In one example, φᵣ is indicated using an indicator, e.g., i_{offset,r}, where i_{offset,r}∈{0, 1, ⋅ ⋅ ⋅ , N₃−1}, hence the payload of i_{offset,r} is ┌log₂ N₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l} (l=1, . . . , v) and φᵣ where Mᵢₙₜ ∈{−W+1, −W+2, . . . , 0}, n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, and φᵣ{0, 1, . . . , N₃−1} which are indicated by means of the indices i_{1,5} and i_{1,6,l} (for Mᵥ>1) and i_{offset,r}, where i_{1,5} ∈{0, 1, . . . , W−1} and i_{1,6,l}∈{0, 1, . . . , X−1} and i_{offset,r}∈{0, 1, ⋅ ⋅ ⋅ , N₃−1}. The UE reports i_{1,5} and i_{1,6,l} (l=1, . . . , v) and i_{offset,r} via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 {π tn}_{3 , l}^{( f )}}{{N}_{3}}} {e}^{j \frac{2 {πφ}_{r}}{{N}_{3}}} .$$

In one example, φ_{r*}=0 for reference CSI-RS resource r* (hence no report is needed).

In one example, φᵣ is indicated using an existing indicator, for example, i_{1,5,r}, i.e., i_{offset,r}=i_{1,5,r}∈{0, 1, ⋅ ⋅ ⋅ , N₃−1}, hence the payload of i_{1,5,r} is ┌log₂ N₃┐ bits (e.g., for r≠r*).

In one example, the UE can be further configured to report FD offset value φᵣ common for all layers l∈{1, . . . , v} and to report an oversampled (rotated) value q_{3,r,l} separately (independently) for each layer l∈{1, . . . , v}.

In one example, φᵣ is indicated using an indicator, e.g., i_{offset,r}, where i_{offset,r}∈{0, 1, ⋅ ⋅ ⋅ , N₃−1}, hence the payload of i_{offset,r} is ┌log₂ N₃┐ bits.

In one example, q_{3,r,l} is indicated using an indicator, e.g., i_{OS,r,l}, where i_{OS,r,l}∈{0, 1, ⋅ ⋅ ⋅ , O₃−1}, hence the payload of i_{OS,r,l} is ┌log₂ O₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n₃, (l=1, . . . , v) and φᵣ and q_{3,r,l} (l=1, . . . , v), where Mᵢₙᵢₜ ∈{−W+1, −W+2, . . . , 0}, n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, φᵣ∈{0, 1, . . . , N₃−1}, and q_{3,r,l}∈{0, 1, . . . , O₃−1} which are indicated by means of the indices i_{1,5} and i_{1,6,l} (for Mᵥ>1) and i_{offset,r}, and i_{OS,r,l} where i_{1,5} ∈{0, 1, . . . , W−1} and i_{1,6,l} ∈ {0, 1, . . . , X−1} and i_{offset,r}∈{0, 1, ⋅ ⋅ ⋅ , N₃−1} and i_{OS,r,l} ∈{0, 1, . . . , O₃−1}. The UE reports i_{1,5} and i_{1,6,l} (l=1, . . . , v) and i_{offset,r} and i_{OS,r,l} (l=1, . . . , v) via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l}^{( f )}}{{N}_{3}}} {e}^{j \frac{2 π ( {φ}_{r} {O}_{3} + {q}_{3 , r , l} )}{{N}_{3} {O}_{3}}} .$$

In one example, φ_{r*}=0 for reference CSI-RS resource r* (hence no report is needed).

In one example, q_{3,r*,l}=0 for reference CSI-RS resource r* for all layers l (hence no report is needed).

In one example, q_{3,r}_{ₗ}_{*,l}=0 for reference CSI-RS resource rₗ* for each layer l (hence no report is needed).

In one example, the UE can be further configured to report FD offset value φᵣ common for all layers l∈{1, . . . , v} and to report an oversampled value q_{3,r} common for all layers l∈{1, . . . , v}.

In one example, φᵣ is indicated using an indicator, e.g., i_{offset,r}, where i_{offset,r}∈{0, 1, ⋅ ⋅ ⋅ , N₃−1}, hence the payload of i_{offset,r} is ┌log₂ N₃┐ bits.

In one example, q_{3,r} is indicated using an indicator, e.g., i_{OS,r}, where i_{OS,r}∈{0, 1, ⋅ ⋅ ⋅ , O₃−1}, hence the payload of i_{OS,r} is ┌log₂ O₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l} (l=1, . . . , v) and φᵣ and q_{3,r}, where Mᵢₙᵢₜ ∈{−W+1, −W+2, . . . , 0}, n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, <φᵣ F {0, 1, . . . , N₃−1}, and q_{3,r}∈{0, 1, . . . , O₃−1} which are indicated by means of the indices i_{1,5} and i_{1,6,l} (for Mᵥ>1) and i_{offset,r}, and i_{OS,r} where i_{1,5} ∈{0, 1, . . . , W−1} and i_{1,6,l}∈{0, 1, . . . , X−1} and i_{offset,r}∈{0, 1, ⋅ ⋅ ⋅ , N₃−1} and i_{OS,r}∈{0, 1, . . . , O₃−1}. The UE reports i_{1,5} and i_{1,6,l} (l=1, . . . , v) and i_{offset,r} and i_{OS,r} via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l}^{( f )}}{{N}_{3}}} {e}^{j \frac{2 π ( {φ}_{r} {O}_{3} + {q}_{3 , r} )}{{N}_{3} {O}_{3}}} .$$

In one example, φ_{r*}=0 for reference CSI-RS resource r* (hence no report is needed).

In one example, q_{3,r*}=0 for reference CSI-RS resource r* (hence no report is needed).

In one example, a combined value \tilde{φ}ᵣ of φᵣ and q_{3,r} is indicated using an indicator, e.g., i_{offset,r}, where i_{offset,r}∈{0, 1, ⋅ ⋅ ⋅ , N₃O₃−1}, hence the payload of i_{offset,r} is ┌log₂ N₃O₃┐ bits.

In one example, a combined value Or of φᵣ and q_{3,r} is indicated using an indicator, e.g., i_{offset,r}, where

$${i}_{offset , r} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

hence the payload of i_{offset,r} is ┌log₂ N₃O₃┐ bits.

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n₃₁ (l=1, . . . , v) and Or, where Mᵢₙᵢₜ ∈{−W+1, −W+2, . . . , 0}, n_{3,l}=[n_{3,l}⁽⁰⁾, . . . , n_{3,l}^{(M}^{ᵥ}⁻¹⁾], n_{3,l}^{(f)}∈{0, 1, . . . , N₃−1}, and φᵣ∈{0, 1, . . . , N₃O₃−1} which are indicated by means of the indices i_{1,5} and i_{1,6,l} (for Mᵥ>1) and i_{offset,r}, where i_{1,5}∈{0, 1, . . . , W−1} and i_{1,6,l}∈{0, 1, . . . , X−1} and i_{offset,r}∈{0, 1, ⋅ ⋅ ⋅ ,N₃O₃−1}. The UE reports i_{1,5} and i_{1,6,l} (l=1, . . . , v) and i_{offset,r} via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l}^{( f )}}{{N}_{3}}} {e}^{j \frac{2 π {\tilde{φ}}_{r}}{{N}_{3} {O}_{3}}} .$$

In one example, \tilde{φ}_{r*}=0 for reference CSI-RS resource r* (hence no report is needed).

In one example, \tilde{φ}ᵣ is indicated using an existing indicator, for example, i_{1,5,r}, i.e., i_{offset,r}=i_{1,5,r}∈{0, 1, ⋅ ⋅ ⋅ , N₃O₃−1}, hence the payload of i_{1,5,r} is ┌log₂ N₃O₃┐ bits (e.g., for r≠r*).

In one example, \tilde{φ}ᵣ is indicated using an existing indicator, for example, i_{1,5,r}, i.e.,

$${i}_{offset , r} = {i}_{1 , 5 , r} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

hence the payload of i_{1,5,r} is ┌log₂ N₃O₃┐ bits (e.g., for r≠r*).

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l,r} (l=1, . . . , v and r=1, . . . , Z) and Or where Mᵢₙᵢₜ ∈{−W+1, −W+2, . . . , 0}, n_{3,l,r} [n_{3,l}⁽⁰⁾, . . . , n_{3,l}^{(M}^{ᵥ}⁻¹⁾], n_{3,l}^{(f)}∈{0, 1, . . . , N₃O₃−1}, and n_{3,l,r}^{(f)}=n_{3,l}O₃+φᵣ or (n_{3,l}O₃+\tilde{φ}ᵣ)mod N₃O₃ which are indicated by means of the indices i_{1,5} and i_{1,6,l} (for Mᵥ>1) and i_{offset,r}, where i_{1,5} ∈{0, 1, . . . , W−1} and i_{1,6,l}∈{0, 1, . . . , X−1} and i_{offset,r}∈{0, 1, ⋅ ⋅ ⋅ , N₃O₃−1}. The UE reports i_{1,5} and i_{1,6,l} (l=1, . . . , v) and i_{offset,r} via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l , r}^{( f )}}{{N}_{3} {O}_{3}}} .$$

In one example, the Mᵥ FD basis vectors, g_{f,l,r}=[y_{0,l,r}^{(f)} y_{1,l,r}^{(f)} ⋅ ⋅ ⋅ y_{N}_{₃}_{-1,l,r}^{(f)}]^{T}, f=0, 1, . . . , Mᵥ−1, are identified by Mᵢₙᵢₜ and n_{3,l,r} (l=1, . . . , v and r=1, . . . , Z) and \tilde{φ}ᵣ where

$${M}_{init} ∈ \{ - W + 1 , - W + 2 , … , 0 \} , {n}_{3 , l , r} = [ {n}_{3 , l , r}^{( 0 )} , … , {n}_{3 , l , r}^{( {M}_{υ} - 1 )} ] , \\ {n}_{3 , l , r}^{( f )} ∈ \{ 0 , \frac{1}{{o}_{3}} , … , \frac{{o}_{3} - 1}{{o}_{3}} , 1 , … , {N}_{3} - \frac{1}{{o}_{3}} \} ,$$

and n_{3,l,r}^{(f)}=n_{3,l}+\tilde{φ}ᵣ or (n_{3,l}O₃+\tilde{φ}ᵣ)mod N₃ which are indicated by means of the indices i_{1,5} and i_{1,6,l} (for Mᵥ>1) and i_{offset,r}, where i_{1,5} ∈{0, 1, . . . , W−1} and i_{1,6,l} ∈{0, 1, . . . , X−1} and

$${i}_{offset , r} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

The UE reports i_{1,5} and i_{1,6,l} (l=1, . . . , v) and i_{offset,r} via the PMI included in the CSI report. In one example,

$$X = ( \begin{matrix}W - 1 \\ {M}_{υ} - 1\end{matrix} )$$

when one of the FD basis vectors is fixed, e.g., n_{3,l}⁽⁰⁾=0. In one example,

$$X = ( \begin{matrix}W \\ {M}_{υ}\end{matrix} ) .$$

The payload for i_{1,6,l} reporting is ┌log₂ X┐ bits. The payload for i_{1,5} reporting is ┌log₂ W┐ bits. In one example,

$${y}_{t , l , r}^{( f )} = {e}^{j \frac{2 π {tn}_{3 , l , r}^{( f )}}{{N}_{3}}} .$$

In one embodiment, for each example in each embodiment, the Mᵥ FD basis vectors are layer-common, i.e., one set of Mᵥ FD basis vectors is associated with all layers. In this case, Mᵥ=M, and n_{3,l}=n₃. The other details can be directly extended from each example in each embodiment.

For example, (e.g., joint indicator disclosed in the present disclosure) the M FD basis vectors, g_{f,r}=[y_{0,r}^{(f)} y_{1,r}^{(f)} ⋅ ⋅ ⋅ y_{N}_{₃}_{-1,r}^{(f)}]^{T}, f=0, 1, . . . , M−1, are identified by Mᵢₙᵢₜ and n₃ where Mᵢₙᵢₜ ∈{−W+1, −W+2, . . . , 0}, n₃=[n₃⁽⁰⁾, . . . , n₃^{(M-1)}], n₃^{(f)} ∈{0, 1, . . . , W−1}, and \tilde{φ}ᵣ∈{0, 1, . . . , N₃O₃−1} which are indicated by means of the indices i_{1,5} and i_{1,6} (for M>1) and i_{offset,r}, where i_{1,5} ∈{0, 1, . . . , W−1} and i_{1,6} ∈{0, 1, . . . , X−1} and i_{offset,r}∈{0, 1, ⋅ ⋅ ⋅ , N₃O₃−1}. The UE reports i_{1,5} and i_{1,6} and i_{offset,r} via the PMI included in the CSI report. In one example,

$$X = ( \begin{matrix}W - 1 \\ M - 1\end{matrix} )$$

when one of the FD basis vectors is fixed, e.g., n₃⁽⁰⁾=0. In one example,

$$X = ( \begin{matrix}W \\ M\end{matrix} ) .$$

The payload for i_{1,6} reporting is ┌log₂ X┐ bits. The payload for i_{1,5} reporting is ┌log₂ W┐ bits. In one example

$${y}_{t , r}^{( f )} = {e}^{j \frac{2 π {tn}_{3}^{( f )}}{{N}_{3}}} {e}^{\frac{2 π {\tilde{φ}}_{r}}{{N}_{3} {O}_{3}}} .$$

In one example, Mᵢₙᵢₜ is fixed.

In one example, the Mᵥ FD basis vectors, g_{f,r}=[y_{0,r}^{(f)} y_{1,r}^{(f)} ⋅ ⋅ ⋅ y_{N}_{₃}_{-1,r}^{(f)}]^{T}, f=0, 1, . . . , M−1, are identified by Mᵢₙᵢₜ and n_{3,r} (r=1, . . . , Z) and \tilde{φ}ᵣ where Mᵢₙᵢₜ {−W+1, −W+2, . . . , 0}, n_{3,r}=[n_{3,r}⁽⁰⁾, . . . , n_{3,r}^{(M-1)}], n_{3,r}^{(f)}∈{0, 1, . . . , N₃O₃−1}, and n_{3,r}^{(f)}=n₃O₃+\tilde{φ}ᵣ or (n₃O₃+\tilde{φ}ᵣ)mod N₃O₃ which are indicated by means of the indices i_{1,5} and i_{1,6} (for M>1) and i_{offset,r}, where i_{1,5} ∈{0, 1, . . . , W−1} and i_{1,6,l}∈{0, 1, . . . , X−1} and i_{offset,r}∈{0, 1, ⋅ ⋅ ⋅ , N₃O₃−1}. The UE reports i_{1,5} and i_{1,6} and i_{offset,r} via the PMI included in the CSI report. In one example,

$$X = ( \begin{matrix}W - 1 \\ M - 1\end{matrix} )$$

when one of the FD basis vectors is fixed, e.g., n₃⁽⁰⁾=0. In one example

$$X = ( \begin{matrix}W \\ M\end{matrix} ) .$$

The payload for i_{1,6} reporting is ┌log₂ X┐ bits. The payload for i_{1,5} reporting is ┌log₂ W┐ bits. In one example,

$${y}_{t , r}^{( f )} = {e}^{j \frac{2 π {tn}_{3 , r}^{( f )}}{{N}_{3} {O}_{3}}} .$$

In one example, the Mᵥ FD basis vectors, g_{f,r}=[y_{0,r}^{(f)} y_{1,r}^{(f)} ⋅ ⋅ ⋅ y_{N}_{₃}_{-1,r}^{(f)}]^{T}, f=0, 1, . . . , M−1, are identified by Mᵢₙᵢₜ and n_{3,r} (r=1, . . . , Z) and \tilde{φ}ᵣ where

$${M}_{init} ∈ \{ - W + 1 , - W + 2 , … , 0 \} , {n}_{3 , r} = [ {n}_{3 , r}^{( 0 )} , … , {n}_{3 , r}^{( M - 1 )} ] , {n}_{3 , r}^{( f )} ∈ \{ 0 , \frac{1}{{O}_{3}} , … , \frac{{O}_{3} - 1}{{O}_{3}} , 1 , … , {N}_{3} - \frac{1}{{O}_{3}} \} ,$$

and n_{3,r}^{(f)}=n₃+\tilde{φ}ᵣ or (n₃+\tilde{φ}ᵣ)mod N₃ which are indicated by means of the indices i_{1,5} and i_{1,6} (for M>1) and i_{offset,r}, where i_{1,5} ∈{0, 1, . . . , W−1} and i_{1,6,l}∈{0, 1, . . . , X−1} and i_{offset,r}∈

$$\{ 0 , \frac{1}{{O}_{3}} , … , \frac{{O}_{3} - 1}{{O}_{3}} , 1 , … , {N}_{3} - \frac{1}{{O}_{3}} \} .$$

The UE reports i_{1,5} and i_{1,6} and i_{offset,r} via the PMI included in the CSI report. In one example,

$$X = ( \begin{matrix}W - 1 \\ M - 1\end{matrix} )$$

when one of the FD basis vectors is fixed, e.g., n₃⁽⁰⁾=0. In one example

$$X = ( \begin{matrix}W \\ M\end{matrix} ) .$$

The payload for i_{1,6} reporting is ┌log₂ X┐ bits. The payload for i_{1,5} reporting is ┌log₂ W┐ bits. In one example,

$${y}_{t , r}^{( f )} = {e}^{j \frac{2 π {tn}_{3 , r}^{( f )}}{{N}_{3}}} .$$

In one example, when M∈A, N=2, e.g., A={1}. In one example, this embodiment is applied for N=4 when M=2.

In one example, this embodiment is applied for N=2 and M=2.

In one embodiment, the UE is configured to report (M or) Mᵥ FD basis vectors according to embodiments (window-based) or embodiment (free selection) based on a condition, as disclosed in the present disclosure. The condition is according to at least one of the following examples.

In one example, the reporting is according to embodiment, as disclosed in the present disclosure, (window-based) when N₃>t and is according to embodiment (free selection) when N₃≤t, as disclosed in the present disclosure.

In one example, the reporting is according to embodiment (window-based) when N₃≥t and is according to embodiment (free selection) when N₃<t, as disclosed in the present disclosure.

In one example, the reporting is according to embodiment (window-based) when N₃<t and is according to embodiment (free selection) when N₃≥t, as disclosed in the present disclosure.

In one example, the reporting is according to embodiment (window-based) when N₃≤t and is according to embodiment (free selection) when N₃>t, as disclosed in the present disclosure.

In one example, the reporting is according to embodiment (window-based) when N_{TRP}or Z>k and is according to embodiment (free selection) when N_{TRP} or Z≤k, as disclosed in the present disclosure.

In one example, the reporting is according to embodiment (window-based) when N_{TRP} or Z₃≥k and is according to embodiment (free selection) when N_{TRP} or Z<k, as disclosed in the present disclosure.

In one example, the reporting is according to embodiment (window-based) when N_{TRP}or Z<k and is according to embodiment (free selection) when N_{TRP} or Z≥k, as disclosed in the present disclosure.

In one example, the reporting is according to embodiment (window-based) when N_{TRP}or Z≤k and is according to embodiment (free selection) when N_{TRP} or Z>k, as disclosed in the present disclosure.

In one example, the reporting is according to embodiment (window-based) when corresponding both conditions in examples, as disclosed in the present disclosure, respectively, are satisfied, and is according to embodiment (free selection) when corresponding both conditions in examples, as disclosed in the present disclosure, respectively, are satisfied. Here, (A, B) belong to {(1, 5), (1, 6), (1, 7), (1, 8), (2, 5), (2, 6), (2, 7), (2, 8), (3, 5), (3, 6), (3, 7), (3, 8), (4, 5), (4, 6), (4, 7), (4, 8)}.

Here, t is a threshold that can be fixed (e.g., t=19) or configured or reported by the UE. Here, k is a threshold that can be fixed (e.g., k=2) or configured or reported by the UE.

In one embodiment, the UE can be configured to report M, FD basis vectors (free selection and/or window-based selection) for a first group of CSI-RS resources and further report FD offset value(s) φᵣ and/or oversampled value(s) q_{3,l} for FD offset value(s) for a second group of CSI-RS resources.

In on example, each example in embodiments, as disclosed in the present disclosure, can be an example of embodiment as disclosed in the present disclosure when a first group of CSI-RS resources corresponds to (or includes) a reference CSI-RS resource r* and a second group of CSI-RS resources corresponds to (or includes) CSI-RS resources r≠r*.

In on example, FD offset value(s) φᵣ is TRP-common for the second group of CSI-RS resources, i.e., one value is associated for the CSI-RS resources of the second group.

In on example, FD offset value(s) φᵣ is TRP-specific for the second group of CSI-RS resources, i.e., one value is associated for each CSI-RS resource in the second group.

In on example, oversampled value(s) q_{3,r} is TRP-common for the second group of CSI-RS resources, i.e., one value is associated for the CSI-RS resources of the second group.

In on example, oversampled value(s) q_{3,r} is TRP-specific for the second group of CSI-RS resources, i.e., one value is associated for each CSI-RS resource in the second group.

In one example, any combination of at least two examples above can be this example.

In on example, a combined value of φᵣ and q_{3,r}, e.g., \tilde{φ}ᵣ is TRP-common for the second group of CSI-RS resources, i.e., one value is associated for the CSI-RS resources of the second group.

In on example, a combined value of φᵣ and q_{3,r}, e.g., \tilde{φ}ᵣ is TRP-specific for the second group of CSI-RS resources, i.e., one value is associated for each CSI-RS resource in the second group.

Similar to each example under embodiment as disclosed in the present disclosure, the above example can be extended using separate indicator or joint indicator.

In one embodiment, at least one of the examples in/under embodiments, as disclosed in the present disclosure, is/are an optional feature, i.e., UE-optional, wherein the UE reports its capability whether to support the UE optional feature or not. The NW can configure the UE-optional feature only when the UE reports that it is supported.

In one example, examples as disclosed in the present disclosure are a UE-optional.

In one example, examples as disclosed in the present disclosure are a basic feature and examples as disclosed in the present disclosure are UE-optional.

In one example, examples as disclosed in the present disclosure are basic features and UE-optional.

In one example, examples as disclosed in the present disclosure are UE-optional, where X and Y are in {1, 2, 3, 4, 5, 6}.

Each of the examples in this embodiment is also directly extended to the case of embodiments as disclosed in the present disclosure.

In one example, reporting q_{3,r} (q_{3,r,l}) is a UE-optional feature where q_{3,r} is described in (any relevant) one of the examples as disclosed in the present disclosure.

In one example, reporting i_{offset,r} (i_{offset,r,l}) is a UE-optional feature where i_{offset,r} is described in (any relevant) one of the examples as disclosed in the present disclosure.

In one example, reporting i_{offset,r} (i_{offset,r,l}) for

$${i}_{offset , r} ∈ \{ 0 , \frac{1}{{O}_{3}} , … , \frac{{O}_{3} - 1}{{O}_{3}} , 1 , … , {N}_{3} - \frac{1}{{O}_{3}} \}$$

is a UE-optional feature where i_{offset,r} is described in (any relevant) one of the examples in embodiment as disclosed in the present disclosure.

In one example, reporting i_{offset,r} (i_{offset,r,l}) for i_{offset,r}∈{0, 1, . . . , N₃O₃−1} is a UE-optional feature where i_{offset,r} is described in (any relevant) one of the examples in embodiment as disclosed in the present disclosure.

In one example, reporting i_{1,5,r} (i_{1,5,r,l}) for

$${i}_{1 , 5 , r} ∈ \{ 0 , \frac{1}{{O}_{3}} , … , \frac{{O}_{3} - 1}{{O}_{3}} , 1 , … , {N}_{3} - \frac{1}{{O}_{3}} \}$$

is a UE-optional feature where i_{offset,r} is described in (any relevant) one of the examples as disclosed in the present disclosure.

In one example, reporting i_{1,5,r} (i_{1,5,r,l}) for i_{1,5,r}∈{0, 1, . . . , N₃O₃−1} is a UE-optional feature where i_{offset,r} is described in (any relevant) one of the examples in embodiments as disclosed in the present disclosure.

In one example, reporting i_{OS,r} (i_{OS,r,l}) is a UE-optional feature where i_{OS,r} is described in (any relevant) one of the examples in embodiment as disclosed in the present disclosure.

In one example, reporting \tilde{φ}ᵣ (\tilde{φ}_{r,l}) (a combined value of φᵣ and q_{3,r}) is a UE-optional feature where \tilde{φ}ᵣ is described in (any relevant) one of the examples in embodiment as disclosed in the present disclosure.

In one example, reporting \tilde{φ}ᵣ (\tilde{φ}_{r,l}) (a combined value of φᵣ and q_{3,r}) for

$${\tilde{φ}}_{r} ∈ \{ 0 , \frac{1}{{O}_{3}} , … , \frac{{O}_{3} - 1}{{O}_{3}} , 1 , … , {N}_{3} - \frac{1}{{O}_{3}} \}$$

is a UE-optional feature where \tilde{φ}ᵣ is described in (any relevant) one of the examples in embodiment as disclosed in the present disclosure.

In one example, reporting \tilde{φ}ᵣ (\tilde{φ}_{r,l}) (a combined value of φᵣ and q_{3,r}) for \tilde{φ}ᵣ∈{0, 1, . . . , N₃O₃−1} is a UE-optional feature where \tilde{φ}ᵣ is described in (any relevant) one of the examples in embodiment as disclosed in the present disclosure.

In one embodiment, at least one of the examples in/under embodiments, as disclosed in the present disclosure, is/are an optional feature based on the number of CSI-RS resources Z.

In one example, examples as disclosed in the present disclosure are UE-optional only when Z≥t.

In one example, examples as disclosed in the present disclosure are UE-optional only when Z>t.

In one example, example as disclosed in the present disclosure are not UE-optional only when Z<t.

In one example, examples as disclosed in the present disclosure are not UE-optional only when Z≤t.

In one example, t=1. In one example, t=2. In one example, t=3. In one example, t=4.

In one embodiment, a UE can be configured to select/determine FD basis offset values φᵣ from a set/window W_{φ}, of an index set Φ described in embodiments as disclosed in the present disclosure. In one example, Φ={0, 1, ⋅ ⋅ ⋅ , N₃O₃−1} for O₃>1. In one example,

$$Φ = \{ 0 , \frac{1}{{O}_{3}} , … , \frac{{O}_{3} - 1}{{O}_{3}} , 1 , … , {N}_{3} - \frac{1}{{O}_{3}} \}$$

for O₃>1. In one example, Φ={0, 1, ⋅ ⋅ ⋅ , N₃−1}.

In one example, a set/window of an index set (for φᵣ) can be given by W_{φ}={0, 1, ⋅ ⋅ ⋅ , N O₃−1}, where N, <N₃.

In one example, a set/window of an index set (for φᵣ) can be given by

$${W}_{φ} = \{ 0 , \frac{1}{{O}_{3}} , … , \frac{{O}_{3} - 1}{{O}_{3}} , 1 , … , {N}_{φ} - \frac{1}{{O}_{3}} \} ,$$

where N≤N₃.

In one example, a set/window of an index set (for φᵣ) can be given by W_{φ}={0, 1, ⋅ ⋅ ⋅ , N_{φ}−1}, where N_{φ}<N₃.

In one example, the indices of the FD offsets φᵣ in a set/window of an index set can be given by mod(M_{init,φ}+n, N₃), n=0, 1, . . . , N_{φ}−1, where M_{init,φ}, is the starting index of the window.

In one example, the indices of the FD offsets φᵣ in a set/window of an index set can be given by mod(M_{init,φ}+n, N₃O₃), n=0, 1, . . . , N_{φ}O₃−1, where M_{init,φ}, is the starting index of the window.

In one example, the indices of the FD offsets φᵣ in a set/window of an index set can be given by mod(M_{init,φ}+n, N₃O₃), n=0, 1, . . . , N_{φ}−1, where M_{init,φ}, is the starting index of the window.

In one example, the indices of the FD offsets φᵣ in a set/window of an index set can be given by mod

$$( {M}_{init , φ} + n , {N}_{3} ) , n = 0 , \frac{1}{{O}_{3}} , ... , \frac{{O}_{3} - 1}{{O}_{3}} , 1 , ... , {N}_{φ} - \frac{1}{{O}_{3}} ,$$

where M_{init,φ}, is the starting index of the window.

In one example, at least one of the following examples can be used/configured to determine FD offset values.

In one example, both M_{init,φ} and N_{φ} are fixed.

In one example, both M_{init,φ} and N_{φ} are configured to the UE (via RRC or/and MAC CE or/and DCI).

In one example, both M_{init,φ} and N_{φ} are reported by the UE.

In one example, M_{init,φ} is fixed and N_{φ} is configured to the UE (via RRC or/and MAC CE or/and DCI).

In one example, M_{init,φ} is fixed and N_{φ} is reported by the UE.

In one example, M_{init,φ} is configured to the UE (via RRC or/and MAC CE or/and DCI) and N_{φ} is fixed.

In one example, M_{init,φ} is configured to the UE (via RRC or/and MAC CE or/and DCI) and N_{φ} is reported by the UE.

In one example, M_{init,φ} is reported by the UE and N_{φ} is fixed.

In one example, M_{init,φ} is reported by the UE and N_{φ} is configured to the UE (via RRC or/and MAC CE or/and DCI).

For Z>1 TRPs (CSI-RS resources), M_{init,φ} can be fixed to (or configured with or reported) as the same/common value for all TRPs, or M_{init,φ} can be fixed to (or configured with or reported) same or different values across TRPs. Likewise, for Z>1 TRPs (CSI-RS resources), N, can be fixed to (or configured with or reported) the same/common value for all TRPs, or N can be fixed to (or configured with or reported) same or different values across TRPs.

In one example, any example for the window set for φᵣ described in embodiment as disclosed in the present disclosure can be applied for the index set of φᵣ (φᵣ and/or q₃) in example as disclosed in the present disclosure.

In one example, the window set for φᵣ is based on the window set (or the whole range set) for W_{f} (i.e., FD basis vector selection).

In one example, Mᵢₙᵢₜ=M_{init,φ} and N=N, for O₃=1.

In one example, O₃Mᵢₙᵢₜ=M_{init,φ} and O₃N=N, for O₃>1.

In one example, Mᵢₙᵢₜ=M_{init,φ} and N=N, for O₃>1.

In one example, N_{φ} can be according to at least one of the following examples.

In one example, N_{φ} is fixed to 4.

In one example, N_{φ} is fixed to 5.

In one example, N_{φ} is fixed to 6.

In one example, N_{φ} is fixed to 7.

In one example, N_{φ} is fixed to 8.

In one example, N_{φ} can be given by min(N_{φ}, N₃).

In one example, N_{φ} can be given by min(N_{φ}, N₃O₃) for O₃>1 (e.g., O₃=4).

In one example, N_{φ}, tᵤₚₚₑᵣ, e.g., tᵤₚₚₑᵣ=5, 6, 7, 8. In one example, tᵤₚₚₑᵣ=cN₃, where c<1.

In one example, Nq, O₃tᵤₚₚₑᵣ, e.g., tᵤₚₚₑᵣ=5, 6, 7, 8 for O₃>1 (e.g., O₃=4). In one example, tᵤₚₚₑᵣ=cN₃, where c<1.

In one example, N_{φ}<tᵤₚₚₑᵣ, e.g., tᵤₚₚₑᵣ=5, 6, 7, 8, 9. In one example, tᵤₚₚₑᵣ=cN₃, where c<1.

In one example, N_{φ}<O₃tᵤₚₚₑᵣ, e.g., tᵤₚₚₑᵣ=5, 6, 7, 8, 9 for O₃>1 (e.g., O₃=4).

In one example, tᵤₚₚₑᵣ=cN₃, where c<1.

In one example, N_{φ}≥t_{lower}, e.g., t_{lower}=1, 2, 3, 4.

In one example, N_{φ}≥O₃t_{lower}, e.g., t_{lower}=1, 2, 3, 4.

In one example, N_{φ}>t_{lower}, e.g., t_{lower}=1, 2, 3, 4.

In one example, N_{φ>O}₃t_{lower}, e.g., t_{lower}=1, 2, 3, 4.

In one example, t_{lower}<N, <tᵤₚₚₑᵣ, e.g., tᵤₚₚₑᵣ=5, 6, 7, 8, e.g., t_{lower}=1, 2, 3, 4. In one example, tᵤₚₚₑᵣ=cN₃, where c<1.

In one example, t_{lower}<N, <tᵤₚₚₑᵣ, e.g., tᵤₚₚₑᵣ=5, 6, 7, 8, e.g., t_{lower}=1, 2, 3, 4. In one example, tᵤₚₚₑᵣ=cN₃, where c<1.

In one example, t_{lower}<Nq, <tᵤₚₚₑᵣ, e.g., tᵤₚₚₑᵣ=5, 6, 7, 8, e.g., t_{lower}=1, 2, 3, 4. In one example, tᵤₚₚₑᵣ=cN₃, where c<1.

In one example, t_{lower}<N, <tᵤₚₚₑᵣ, e.g., tᵤₚₚₑᵣ=5, 6, 7, 8, e.g., t_{lower}=1, 2, 3, 4. In one example, tᵤₚₚₑᵣ=cN₃, where c<1.

In one example, t_{lower}<Nq, <O₃tᵤₚₚₑᵣ, e.g., tᵤₚₚₑᵣ=5, 6, 7, 8, e.g., t_{lower}=1, 2, 3, 4 for O₃>1 (e.g., O₃=4). In one example, tᵤₚₚₑᵣ=cN₃, where c<1.

In one example, t_{lower}<Nq, <O₃tᵤₚₚₑᵣ, e.g., tᵤₚₚₑᵣ=5, 6, 7, 8, e.g., t_{lower}=1, 2, 3, 4 for O₃>1 (e.g., O₃=4). In one example, tᵤₚₚₑᵣ=cN₃, where c<1.

In one example, t_{lower}<Nq, <O₃tᵤₚₚₑᵣ, e.g., tᵤₚₚₑᵣ=5, 6, 7, 8, e.g., t_{lower}=1, 2, 3, 4 for O₃>1 (e.g., O₃=4). In one example, tᵤₚₚₑᵣ=cN₃, where c<1.

In one example, t_{lower}<N, <O₃tᵤₚₚₑᵣ, e.g., tᵤₚₚₑᵣ=5, 6, 7, 8, e.g., t_{lower}=1, 2, 3, 4 for O₃>1 (e.g., O₃=4). In one example, tᵤₚₚₑᵣ=cN₃, where c<1.

In one example, M_{init,φ} can be according to at least one of the following examples.

In one example,

$${M}_{init , φ} = - \frac{{N}_{φ}}{2} + 1.$$

In one example,

$${M}_{init , φ} = - ⌈ \frac{{N}_{φ}}{2} ⌉ + 1.$$

In one example,

$${M}_{init , φ} = - ⌊ \frac{{N}_{φ}}{2} ⌋ + 1.$$

In one example,

$${M}_{init , φ} = - \frac{{N}_{φ} {O}_{3}}{2} + 1.$$

In one example,

$${M}_{init , φ} = - ⌈ \frac{{N}_{φ} {O}_{3}}{2} ⌉ + 1.$$

In one example,

$${M}_{init , φ} = - ⌊ \frac{{N}_{φ} {O}_{3}}{2} ⌋ + 1.$$

In one example,

$${M}_{init , φ} = - \frac{{N}_{φ}}{2} .$$

In one example,

$${M}_{init , φ} = - ⌈ \frac{{N}_{φ}}{2} ⌉ .$$

In one example,

$${M}_{init , φ} = - ⌊ \frac{{N}_{φ}}{2} ⌋ .$$

In one example,

$${M}_{init , φ} = - \frac{{N}_{φ} {O}_{3}}{2} .$$

In one example,

$${M}_{init , φ} = - ⌈ \frac{{N}_{φ} {O}_{3}}{2} ⌉ .$$

In one example,

$${M}_{init , φ} = - ⌊ \frac{{N}_{φ} {O}_{3}}{2} ⌋ .$$

In one example, M_{init,φ}=−N_{φ}+1.

In one example, M_{init,φ}=−N_{φ}O₃+1.

In one example, M_{init,φ}=−N_{φ}.

In one example, M_{init,φ}=−N_{φ}O₃.

In one example, M_{init,φ}=−2N_{φ}+1.

In one example, M_{init,φ}=−2N_{φ}O₃+1.

In one example, M_{init,φ}=c₁, where c₁ is a fixed value, e.g., c₁=0.

In one example,

$${M}_{init , φ} ∈ \{ - \frac{{N}_{φ}}{2} + 1 , - \frac{{N}_{φ}}{2} + 2 , … , \frac{{N}_{φ}}{2} \} .$$

(In another example, similar variants using

$$- ⌈ \frac{{N}_{φ}}{2} ⌉ + 1 or - ⌊ \frac{{N}_{φ}}{2} ⌋ + 1 ) .$$

In one example,

$${M}_{init , φ} ∈ \{ - \frac{{N}_{φ}}{2} + 1 , - \frac{{N}_{φ}}{2} + 2 , … , 0 \} .$$

(In another example, similar variants using

$$- ⌈ \frac{{N}_{φ}}{2} ⌉ + 1 or - ⌊ \frac{{N}_{φ}}{2} ⌋ + 1 ) .$$

In one example,

$${M}_{init , φ} ∈ \{ - \frac{{N}_{φ} {O}_{3}}{2} + 1 , - \frac{{N}_{φ} {O}_{3}}{2} + 2 , … , \frac{{N}_{φ} {O}_{3}}{2} \} .$$

(In another example, similar variants using

$$- ⌈ \frac{{N}_{φ} {O}_{3}}{2} ⌉ + 1 or - ⌊ \frac{{N}_{φ} {O}_{3}}{2} ⌋ + 1 ) .$$

In one example,

$${M}_{init , φ} ∈ \{ - \frac{{N}_{φ} {O}_{3}}{2} + 1 , - \frac{{N}_{φ} {O}_{3}}{2} + 2 , … , 0 \} .$$

(In another example, similar variants using

$$- ⌈ \frac{{N}_{φ} {O}_{3}}{2} ⌉ + 1 or - ⌊ \frac{{N}_{φ} {O}_{3}}{2} ⌋ + 1 ) .$$

In one example, M_{init,φ}∈{−N_{φ}+1, −N_{φ}+2, ⋅ ⋅ ⋅ , N_{φ}}.

In one example, M_{init,φ}∈{−N_{φ}+1, −N_{φ}+2, ⋅ ⋅ ⋅ , 0}.

In one example, M_{init,φ}∈{−N_{φ}O₃+1, −N_{φ}O₃+2, ⋅ ⋅ ⋅ , 0}.

In one example, M_{init,φ}∈{−N_{φ}O₃+1, −N_{φ}O₃+2⋅ ⋅ ⋅ , N_{φ}O₃}.

In one example, M_{init,φ}∈{−N_{φ}+1, −N_{φ}+2, ⋅ ⋅ ⋅ , 2N_{φ}}.

In one example, M_{init,φ}∈{−N_{φ}+1, −N_{φ}+2, ⋅ ⋅ ⋅ , 0}.

In one example, M_{init,φ}∈{−N_{φ}O₃+1, −N_{φ}O₃+2, ⋅ ⋅ ⋅ , 0}.

In one example, M_{init,φ}∈{−N_{φ}O₃+1, −−N_{φ}O₃+2, ⋅ ⋅ ⋅ , 0}.

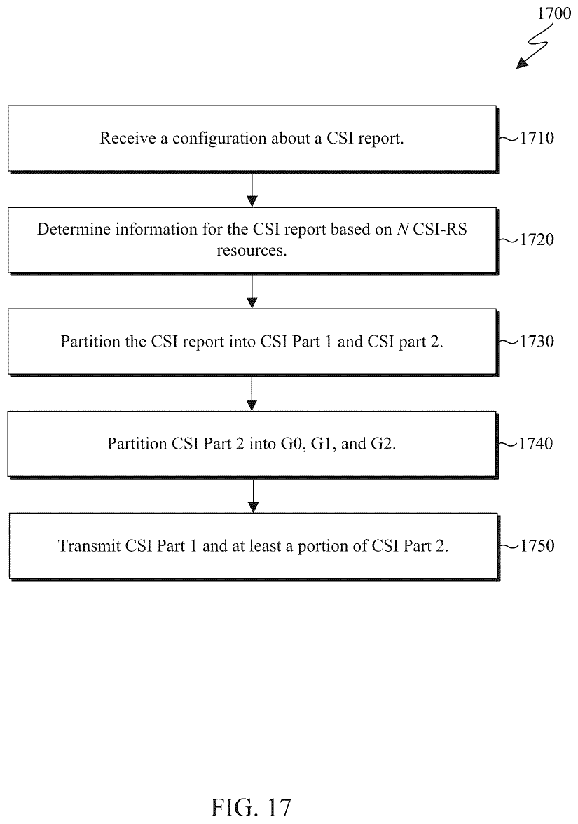

FIG. 17 illustrates an example method 1700 performed by a UE in a wireless communication system according to embodiments of the present disclosure. The method 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving a configuration about a CSI report (1710). For example, in 1710, the configuration includes information about (i) N_{TRP} CSI-RS resources, where N_{TRP}>1, (ii) a parameter codebookType set to type-II-CJT-r18 or type-II-PortSelection-CJT-r18, and (iii) a parameter codebookMode set to model.

The UE then determines information for the CSI report based on N CSI-RS resources (1720). For example, in 1720, the information for the CSI report is determined based on the configuration and N≤N_{TRP}. The UE then partitions the CSI report CSI Part 1 and CSI part 2 (1730).

The UE then partitions the CSI Part 2 G0, G1, and G2 (1740). For example, in 1740, the group G1 includes an indicator indicating, for each of N−1 CSI-RS resources of the N CSI-RS resources, a frequency-domain (FD) offset dᵣ∈{0, 1, . . . , N₃O₃−1} relative to a reference CSI-RS resource. Here, r∈{1, . . . , N_{TRP}}, r≠r*, and r* is an index of the reference CSI-RS resource such that dᵣ*=0; N₃ is a length of each of FD basis vectors; and O₃ is an oversampling value.

In various embodiments, the FD offset dᵣ is common for all of v layers and a value of O₃ is configured by a RRC parameter. Here, O₃ ∈{1, 4} and a payload of the indicator is (N−1)┌log₂(N₃O₃)┐ bits.

In various embodiments, the index r* of the reference CSI-RS resource is fixed to be a smallest index among indices of the N CSI-RS resources.

In various embodiments, the UE determines a value of N from among N∈{1,2, . . . , N_{TRP}} and the group G1 includes the indicator when the value of N≥2. For example if N<2 G1 may not include the indicator.

In various embodiments, when codebookMode=type-II-CJT-r18, the UE determines an indicator i_{1,6,l} indicating Mᵥ FD basis vectors for each layer l=1, . . . , v, where the indicator i_{1,6,l} is included in the group G1. Here, elements of the Mᵥ FD basis vectors shifted by the FD offset dᵣ are given by

$${y}_{t , l , r}^{( f )} = {e}^{j \frac{2 π {tn}_{3 , l}^{( f )}}{{N}_{3}}} {e}^{j \frac{2 π {td}_{r}}{{N}_{3} {O}_{3}}}$$

for t=0, 1, . . . , N₃−1, f=0, 1, . . . , Mᵥ−1, and l=1, ⋅ ⋅ ⋅ , v, where n₃ ∈{0, 1, . . . , N₃−1} is identified based on i_{1,6,l}.

In various embodiments, when codebookMode=type-II-PortSelection-CJT-r18, the UE determines an indicator i_{1,6} indicating M FD basis vectors common for all layers l=1, . . . , v, where the indicator i_{1,6} is included in the group G0. Here, elements of the M FD basis vectors shifted by the FD offset dᵣ are given by

$${y}_{t , r}^{( f )} = {e}^{j \frac{2 π {tn}_{3}^{( f )}}{{N}_{3}}} {e}^{j \frac{2 π {td}_{r}}{{N}_{3} {O}_{3}}}$$

for t=0, 1, . . . , N₃−1, and f=0, 1, . . . , M−1, where

$${n}_{3}^{( f )} ∈ \{ \begin{matrix}\{ 0 \} & M = 1 \\ \{ 0 , 1 , … , min ( {N}_{M} , {N}_{3} ) - 1 \} & M = 2\end{matrix}$$

is identified by i_{1,6} and N_{M} is a value in {2,4}.

The UE then transmits the CSI Part 1 and at least a portion of the CSI Part 2 (1750). In various embodiments, the portion of the CSI Part 2 is G0, (G0, G1), or (G0, G1, G2).

In various embodiments, the UE may also transmit UE capability information indicating that the UE is capable of supporting codebookMode=model.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive a configuration about a channel state information (CSI) report, the configuration including information about (i) N_{TRP} CSI reference signal (CSI-RS) resources, where N_{TRP}>1, (ii) a parameter codebookType set to type-II-CJT-r18 or type-II-PortSelection-CJT-r18, and (iii) a parameter codebookMode set to model;
a processor operably coupled to the transceiver, the processor, based on the configuration, configured to:
determine information for the CSI report based on N CSI-RS resources, where N≤N_{TRP},
partition the CSI report into two parts, a CSI Part 1 and a CSI part 2, and
partition the CSI Part 2 into three groups, G0, G1, and G2,
wherein the transceiver is further configured to transmit the CSI Part 1 and at least a portion of the CSI Part 2,
wherein the group G1 includes an indicator indicating, for each of N−1 CSI-RS resources of the N CSI-RS resources, a frequency-domain (FD) offset dᵣ∈{0, 1, . . . , N₃O₃−1} relative to a reference CSI-RS resource, where:
r∈{1, . . . , N_{TRP}}, r≠r*, and r* is an index of the reference CSI-RS resource such that dᵣ*=0;
N₃ is a length of each of FD basis vectors; and
O₃ is an oversampling value.

2. The UE of claim 1, wherein:
N∈{1, 2, . . . , N_{TRP}},
the processor is further configured to determine a value of N, and
the group G1 includes the indicator when the value of N≥2.

3. The UE of claim 1, wherein:
the FD offset dᵣ is common for all of v layers, and
a value of O₃ is configured by a radio resource control (RRC) parameter, where O₃ ∈{1, 4}, and a payload of the indicator is (N−1)┌log₂(N₃O₃)┐ bits.

4. The UE of claim 1, wherein the portion of the CSI Part 2 is G0, (G0, G1), or (G0, G1, G2).

5. The UE of claim 1, wherein the transceiver is further configured to transmit UE capability information indicating that the UE is capable of supporting codebookMode=model.

6. The UE of claim 1, wherein the index of the reference CSI-RS resource r* is fixed to be a smallest index among indices of the N CSI-RS resources.

7. The UE of claim 1, wherein:
when codebookMode=type-II-CJT-r18, the processor is further configured to determine an indicator i_{1,6,l} indicating M, FD basis vectors for each layer l=1, . . . , v, where the indicator i_{1,6,l} is included in the group G1, and
elements of the M, FD basis vectors shifted by the FD offset dᵣ are given by
$${y}_{t , l , r}^{( f )} = {e}^{j \frac{2 π {tn}_{3 , l}^{( f )}}{{N}_{3}}} {e}^{j \frac{2 π {td}_{r}}{{N}_{3} {O}_{3}}}$$
for t=0, 1, . . . , N₃−1, f=0, 1 . . . , Mᵥ−1, and l=1, ⋅ ⋅ ⋅ , v, where n_{3,l}^{(f)}∈{0, 1, . . . , N₃−1} is identified based on i_{1,6,l}.

8. The UE of claim 1, wherein:
when codebookMode=type-II-PortSelection-CJT-r18, the processor is further configured to determine an indicator i_{1,6} indicating M FD basis vectors common for all layers l=1, . . . , v, where the indicator i_{1,6} is included in the group G0, and
elements of the M FD basis vectors shifted by the FD offset dᵣ are given by
$${y}_{t , r}^{( f )} = {e}^{j \frac{2 π {tn}_{3}^{( f )}}{{N}_{3}}} {e}^{j \frac{2 π {td}_{r}}{{N}_{3} {O}_{3}}}$$
for t=0, 1, . . . , N₃−1, and f=0, 1, . . . , M−1,
where
$${n}_{3}^{( f )} ∈ \{ \begin{matrix}\{ 0 \} & M = 1 \\ \{ 0 , 1 , … , min ( {N}_{M} , {N}_{3} ) - 1 \} & M = 2\end{matrix}$$
is identified by i_{1,6} and N_{M} is a value in {2,4}.

9. A base station (BS) comprising:
a processor; and
a transceiver operably coupled to the processor, the transceiver configured to:
transmit a configuration about a channel state information (CSI) report, wherein:
the configuration includes information about (i) N_{TRP} CSI reference signal (CSI-RS) resources, where N_{TRP}>1, (ii) a parameter codebookType set to type-II-CJT-r18 or type-II-PortSelection-CJT-r18, and (iii) a parameter codebookMode set to model,
the CSI report is based on N CSI-RS resources, where N≤N_{TRP},
the CSI report includes two parts, a CSI Part 1 and a CSI part 2, and
the CSI Part 2 includes three groups, G0, G1, and G2; and
receive the CSI Part 1 and at least a portion of the CSI Part 2,
wherein the group G1 includes an indicator indicating, for each of N−1 CSI-RS resources of the N CSI-RS resources, a frequency-domain (FD) offset dᵣ∈{0, 1, . . . , N₃O₃−1} relative to a reference CSI-RS resource, where:
r∈{1, . . . , N_{TRP}}, r≠r*, and r* is an index of the reference CSI-RS resource such that dᵣ*=0;
N₃ is a length of each of FD basis vectors; and
O₃ is an oversampling value.

10. The BS of claim 9, wherein:
N∈{1,2, . . . , N_{TRP}}, and
the group G1 includes the indicator when a value of N≥2.

11. The BS of claim 9, wherein:
the FD offset dᵣ is common for all of v layers, and
a value of O₃ is configured by a radio resource control (RRC) parameter, where O₃ ∈{1, 4}, and a payload of the indicator is (N−1)┌log₂(N₃O₃)┐ bits.

12. The BS of claim 9, wherein the portion of the CSI Part 2 is G0, (G0, G1), or (G0, G1, G2).

13. The BS of claim 9, wherein the transceiver is further configured to receive user equipment (UE) capability information indicating that a UE is capable of supporting codebookMode=model.

14. The BS of claim 9, wherein the index of the reference CSI-RS resource r* is fixed to be a smallest index among indices of the N CSI-RS resources.

15. The BS of claim 9, wherein:
when codebookMode=type-II-CJT-r18, an indicator i_{1,6,l} indicating M, FD basis vectors for each layer l=1, . . . , v is included in the group G1, and
elements of the M, FD basis vectors shifted by the FD offset dᵣ are given by
$${y}_{t , l , r}^{( f )} = {e}^{j \frac{2 π {tn}_{3 , l}^{( f )}}{{N}_{3}}} {e}^{j \frac{2 π {td}_{r}}{{N}_{3} {O}_{3}}}$$
for t=0, 1, . . . , N₃−1, f=0, 1, . . . , Mᵥ−1, and l=1, ⋅ ⋅ ⋅ , v,
where n₃ ∈{0, 1, . . . , N₃−1} is identified based on i_{1,6,l}.

16. The BS of claim 9, wherein:
when codebookMode=type-II-PortSelection-CJT-r18, an indicator i_{1,6} indicating M FD basis vectors common for all layers l=1, . . . , v is included in the group G0, and
elements of the M FD basis vectors shifted by the FD offset dᵣ are given by
$${y}_{t , r}^{( f )} = {e}^{j \frac{2 π {tn}_{3}^{( f )}}{{N}_{3}}} {e}^{j \frac{2 π {td}_{r}}{{N}_{3} {O}_{3}}}$$
for t=0, 1, . . . , N₃−1, and f=0, 1, . . . , M−1,
where
$${n}_{3}^{( f )} ∈ \{ \begin{matrix}\{ 0 \} & M = 1 \\ \{ 0 , 1 , … , min ( {N}_{M} , {N}_{3} ) - 1 \} & M = 2\end{matrix}$$
is identified by i_{1,6} and N_{M} is a value in {2,4}.

17. A method performed by a user equipment (UE), the method comprising:
receiving a configuration about a channel state information (CSI) report, the configuration including information about (i) N_{TRP} CSI reference signal (CSI-RS) resources, where N_{TRP}>1, (ii) a parameter codebookType set to type-II-CJT-r18 or type-II-PortSelection-CJT-r18, and (iii) a parameter codebookMode set to model;
based on the configuration:
determining information for the CSI report based on N CSI-RS resources, where N≤N_{TRP},
partitioning the CSI report into two parts, a CSI Part 1 and a CSI part 2, and
partitioning the CSI Part 2 into three groups, G0, G1, and G2; and
transmitting the CSI Part 1 and at least a portion of the CSI Part 2,
wherein the group G1 includes an indicator indicating, for each of N−1 CSI-RS resources of the N CSI-RS resources, a frequency-domain (FD) offset dᵣ∈{0, 1, . . . , N₃O₃−1} relative to a reference CSI-RS resource, where:
r∈{1, . . . , N_{TRP}}, r≠r*, and r* is an index of the reference CSI-RS resource such that dᵣ*=0;
N₃ is a length of each of FD basis vectors; and
O₃ is an oversampling value.

18. The method of claim 17, further comprising:
determining a value of N,
wherein N∈{1,2, . . . , N_{TRP}}, and
wherein the group G1 includes the indicator when the value of N>2.

19. The method of claim 17, wherein:
the FD offset dᵣ is common for all of v layers, and
a value of O₃ is configured by a radio resource control (RRC) parameter, where O₃ ∈{1, 4}, and a payload of the indicator is (N−1)┌log₂(N₃O₃)┐ bits.

20. The method of claim 17, wherein the portion of the CSI Part 2 is G0, (G0, G1), or (G0, G1, G2).
